(19) United States
(12) Patent Application Publication
(10) Pub. No.: US 2007/0185909 A1
(43) Pub. Date: Aug. 9, 2007

(54) Tool for authoring media content for use in computer applications or the likes and method therefore

(75) Inventors: Martin H. Klein, Iles des Soeurs (CA); Simon Ashby, Montreal (CA); Nicolas Michaud, Candiac (CA); Eric Begin, Montreal (CA); Guy Pelletier, Montreal (CA); Jocelyn Caron, Longueuil (CA)

Correspondence Address: VENABLE LLP, P.O. BOX 34385, WASHINGTON, DC, 20043-9998, US

(73) Assignee: AUDIOKINETIC, INC., Quebec (CA)

(21) Appl. No.: 11/637,198

(22) Filed: Dec. 12, 2006

Related U.S. Application Data
(60) Provisional application No. 60/749,027, filed on Dec. 12, 2005.
(60) Provisional application No. 60/771,440, filed on Feb. 9, 2006.

(51) Int. Cl. G06F 17/00; A63F 9/24; G06F 3/00

(52) U.S. Cl. 707/104.1; 463/35; 715/716

(57) ABSTRACT

A method in a computer system for authoring media content for a computer application is provided. The authoring is accomplished by making use of a hierarchical structure including media objects, containers to group objects, and meta-containers to group containers and objects, where the media objects are working copies of provided media files. The hierarchical structure is such that when a property or behaviour is assigned to a container, this property is automatically shared to the objects and container therein. Similarly, the containers and objects included in a meta-container share the properties and behaviours assigned to their parent meta-container. Such a method and system can be implemented as an audio authoring tool for video game where a higher-level additional hierarchical structure is provided on top of a lower-level hierarchical structure to route sound assets organized and characterized through the lower-level hierarchy. The result of the authoring process is store in media banks which contains optimized information to be used by the computer application.

### FIELD

The present relates to authoring systems and methods for applications such as games to be used on computers, game consoles, wireless phones, rides, or the likes. More specifically, the present is concerned with an authoring tool for authoring media content such as audio content and with a method therefor.

### BACKGROUND

Video games have become more and more popular as the processing capabilities of the console increase to provide an increased feeling of immersion for the player. On the other hand, the production of video games has less and less to do with programming and more with large scale production. Indeed, similarly to what can be seen in movie productions, video game productions require the collaboration of different specialists, some being non programmers.

One aspect of video game production which first took advantage of the increased popularity of video games to see the introduction of development tools has been in computer animation.

The audio part of video game production is conventionally done however under the old production pipeline model: artists or sound specialists prepare the audio assets and programmers code their integration into the game.

A drawback of this authoring method for audio is that every time a change is made to the game or to the audio assets, the programmers have to do the work all over again, hoping that the integration will succeed. Also, since the integration of sound is done by the actual programmers and has to be coded, usual delays and additional workload have to be expected.

The above-mentioned traditional production pipeline is not limited to the production of audio and video for video games. To this day, it is still the common practise to incorporate media assets in a multimedia title production.

Method and system allowing to simplify the production pipeline of a multimedia production title is thus desirable.

### SUMMARY

The present concerns an authoring tool to be used in the production of media assets for a multimedia title. The authoring tool can be used, for example, for developing audio for games. The authoring tool allows building audio asset structures, defining audio behaviours, mixing audio levels, managing sound integration, and integrating the result in sound banks to be used by the game console. The authoring tool also allows auditioning, profiling, and modifying sounds in real time within the game itself.

More specifically, in accordance with a first aspect of the present, there is provided a method in a computer system for authoring media content for a computer application, the method comprising:

providing digital media;

for each one of the digital media, creating a media object which shares content characteristics therewith;

providing a hierarchical structure, including the media objects, and at least one container, to assign at least one selected modifier among at least one of at least one property and at least one behaviour to at least one of the media objects; the at least one container being for including at least one selected object from the media objects so that when the at least one selected modifier is assigned to the at least one container, the at least one selected modifier is shared to the at least one selected object; and

storing information related to the hierarchical structure in at least one project file to be used by the computer application.

According to a second aspect of the present, there is provided an authoring tool for authoring media content for a computer application comprising:

a media file importer component that receives digital media and that creates for each of the digital media a corresponding media object;

a hierarchical structure editor component, to provide at least one container, to assign at least one selected modifier selected among at least one property and at least one behaviour to at least one of the media objects; the at least one container being for including at least one first selected object among the media objects so that when the at least one selected modifier is assigned to the at least one container, the at least one selected modifier is shared with the at least one first selected object; and

a project file generator component that stores information related to at least one of the media objects and the at least one container in a project file to be used by the computer application.

According to a third aspect of the present, there is provided a computer-readable medium containing instructions for controlling a computer system to generate an application for authoring media content for a computer application, comprising:

a media file importer component that receives digital media and that creates for each of the digital media a corresponding media object;

a hierarchical structure editor component, to provide at least one container, to assign at least one selected modifier selected between at least one property and at least one behaviour to at least one of the media objects; the at least one container being for including at least one first selected object among the media objects so that when the at least one selected modifier is assigned to the at least one container, the at least one selected modifier is shared with the at least one first selected object; and

a project file generator component that stores information related to at least one of the media objects and the at least one container in a project file to be used by the computer application.

The computer-readable medium can be a CD-ROM, DVD-ROM, universal serial bus (USB) device, memory stick, hard drive, etc.

According to a fourth aspect of the present there is provided a system for authoring media content comprising:

a computer programmed with instructions for generating an application for authoring media content for a computer application including:

a digital media importer that receives digital media and that creates for each of the digital media a corresponding media object;

a hierarchical structure editor, to create a hierarchical structure including at least one container, to assign at least one selected modifier selected among at least one of at least one property and at least one behaviour to at least one of the media objects; the at least one container being for including at least one selected object among the media objects so that when the at least one selected modifier is assigned to the at least one container, the at least one selected modifier is shared to the at least one selected object; and

a project file generator that stores in a project file to be used by the computer application information related to the hierarchical structure.

According to a fifth aspect of the present, there is provided a method in a computer system for displaying media object in an authoring process by a computer system, the method comprising:

displaying a digital media importer user interface to allow receiving digital media and for each of the digital media, to allow creating a corresponding media object;

displaying a hierarchical structure editor user interface to allow creating a hierarchical structure including the media objects and containers and assigning at least one of properties and behaviours to the media objects; and

displaying a project file generator user interface to allow storing information related to the hierarchical structure.

According to a sixth aspect of the present, there is provided an authoring tool for authoring audio content for a computer application comprising:

a lower-level hierarchy for grouping and organizing audio assets in a project using audio objects as working copies of the audio assets; and

a higher-level hierarchy for defining the routing and output of the audio objects using one or more control busses.

The expression “computer application” is intended to be construed broadly as including any sequence of instructions intended for a computer, game console, wireless phone, personal digital assistant (PDA), multimedia player, etc. which produces sounds, animations, display texts, videos, or a combination thereof, interactively or not.

Similarly, the expression “computer system” will be used herein to refer to any device provided with computational capabilities, and which can be programmed with instructions for example, including without restriction a personal computer, a game console, a wired or wireless phone, a PDA, a multimedia player, etc.

Other objects, advantages and features of the present method and system will become more apparent upon reading the following non restrictive description of illustrated embodiments thereof, given by way of example only with reference to the accompanying drawings.

### BRIEF DESCRIPTION OF THE DRAWINGS

In the appended drawings:

FIG. 1 is a perspective schematic view of a system for authoring audio for a video game according to a first illustrative embodiment;

FIG. 2 is a flowchart illustrating a method for authoring audio for a video game according to a first illustrative embodiment;

FIGS. 3 and 4 are flow diagrams illustrating the audio file import process according to a specific aspect of the method from FIG. 2;

FIG. 5 is a flowchart illustrating the relationship between sound object, audio source and audio file;

FIG. 6 is an example of a user interface for a file importer from the Authoring tool part of the system from FIG. 1;

FIG. 7 is a schematic view of the user interface from FIG. 6, illustrating a list of files to import;

FIG. 8 is an illustration of a first level hierarchical structure according to the first illustrative embodiment;

FIG. 9 is a first example of application of the first level hierarchical structure from FIG. 8, illustrating the use of containers to group sound objects;

FIG. 10 is a second example of application of the first level hierarchical structure from FIG. 8, illustrating the use of actor mixers to further group containers and sound object;

FIG. 11 illustrates a first example of a project hierarchy including Master-Mixer and Actor-Mixer hierarchies;

FIG. 12 is a block diagram illustrating the routing of the sound through the hierarchy;

FIG. 13 is an example of a user interface for a browser allowing to create and manage the hierarchical structure; the user-interface is from the Authoring tool part of the system from FIG. 1;

FIG. 14 illustrates the operation of two types of properties within the hierarchy;

FIG. 15 illustrates a third example of application of the hierarchical structure to group and manage sound objects;

FIG. 16A is an example of a user interface for a Property Editor from the Authoring tool part of the system from FIG. 1;

FIG. 16B is an example of an Effects tab user interface for managing effects from the Authoring tool part of the system from FIG. 1;

FIG. 17 is a pitch property menu portion from the Property Editor, illustrating various indicators;

FIG. 18 is an example of a user interface for a Contents Editor from the Authoring tool part of the system from FIG. 1;

FIGS. 19A-19E illustrate an example of use of the Property Editor from FIG. 16A to edit an Actor-Mixer object;

FIG. 20 is a flow diagram illustrating an example of use of a random container;

FIG. 21A is an example of a user interface for the Contents Editor as illustrated in FIG. 18 as it appears in the context of a container;

FIG. 21B is an example of an interactive menu portion from the Property Editor from FIG. 16A to characterize a random/sequence container;

FIG. 22 is a flow diagram illustrating a first example of use of a sequence container;

FIG. 23 is an example of an interactive menu portion from the Property Editor from FIG. 16A to characterize a sequence container;

FIG. 24 is an example of the user interface for the Contents Editor as illustrated in FIG. 18 as it appears in the context of a Sequence container, illustrating the Playlist pane;

FIGS. 25A-25B are flow diagrams illustrating a second example of use of a random/sequence container and more specifically the use of the step mode;

FIG. 26 is a third example of use of a random/sequence container, illustrating use of the continuous mode;

FIG. 27 is an example of an interactive menu portion from the Property Editor from FIG. 16A to characterize the playing condition for objects in a continuous sequence or random container;

FIG. 28 is a first example of use of a switch container for footstep sounds;

FIGS. 29A-29B are flow diagrams illustrating an example of use of a switch container;

FIG. 30 is an example of a user interface for the Contents Editor from the Authoring tool part of the system from FIG. 1 as it appears in the context of a switch container;

FIG. 31 is a close-up view of the “Assigned Objects” pane form the user interface from FIG. 30;

FIG. 32 illustrates the use of a switch container in a game;

FIG. 33 is an example of an Game Syncs tab user interface for managing effects from the Authoring tool part of the system from FIG. 1;

FIG. 34 illustrates an example of use of relative state properties on sounds;

FIG. 35 illustrates an example of use of absolute state properties on sounds;

FIG. 36 illustrates an example of use of states in a game;

FIG. 37 is an example of a user interface for the State Property Editor from the Authoring tool part of the system from FIG. 1;

FIG. 38 is a close up view of part of the user interface from FIG. 37 further illustrating the interaction GUI element allowing the user to set the interaction between the objects properties and the state properties;

FIG. 39 is an example of a user interface for a State Group Property Editor from the Authoring tool part of the system from FIG. 1;

FIG. 40 is an example of a portions from a user interface for a States editor from the Authoring tool part of the system from FIG. 1;

FIG. 41 illustrates an hybrid view illustrating how the volume of the engine of a car in a game can be affected by the speed of the racing car, based on how it is mapped in the project using real time parameter control (RTPC);

FIG. 42 is an example of a user interface for a graph view provided in the RTPC tab of the Property Editor to edit real-time parameter value changes;

FIG. 43 is an example of a graph view from a RTPC Editor from the Authoring tool part of the system from FIG. 1;

FIG. 44 is an example of a user interface for a RTPC property dialog box from the Authoring tool part of the system from FIG. 1;

FIG. 45 is an example of a portion of the user interface for editing RTPCs for displaying the RTPC list from the Authoring tool part of the system from FIG. 1;

FIG. 46 is an example of a user interface for a Switch Group Property Editor from the Authoring tool part of the system from FIG. 1;

FIG. 47 is the user interface from FIG. 46, further including an example of graph view;

FIG. 48 is a first example illustrating the use of Events to drive the sound in game;

FIG. 49 is a second example illustrating the use of Events to drive the sound in game;

FIG. 50 is an example of shortcut menu part of an Event Editor, which can be used to assign actions to an Event;

FIG. 51 is an example of a user interface for a Event tab from the Authoring tool part of the system from FIG. 1;

FIG. 52 is an isolated view of an example of an Event Actions portion from the Event Editor user Interface from FIG. 55;

FIG. 53 is the shortcut menu from FIG. 50, which is displayed from the Event Editor from FIG. 55;

FIG. 54 illustrates the use of the Audio tab to create an Event;

FIG. 55 is an example of a user interface for an Event Editor from the Authoring tool part of the system from FIG. 1;

FIG. 56 is an example of a user interface for an Audio tab, including the hierarchical tree structure and a general purpose shortcut menu, from the Authoring tool part of the system from FIG. 1;

FIGS. 57A-57B illustrate the use of control buses to route sound and a method for re-routing sound objects that were connected to a bus that is deleted;

FIG. 58 is a schematic view illustrating the application of audio and environmental-related effects to a control bus to alter and enhance the character of selected sounds;

FIG. 59 is an example of a Schematic view user interface illustrating the creation of an Environmental bus to receive both a sound effect bus and a voice bus to be affected by environmental effects;

FIG. 60A illustrates how environmental effect instances are applied onto game objects before being mixed;

FIG. 60B illustrates an example of application of the environmental effects on a control bus in the context of haunted graveyard environments in a video game;

FIG. 61 is a graph illustrating the ducking process;

FIG. 62 is an example of user interface for an Auto-ducking control panel from the Authoring tool part of the system from FIG. 1;

FIG. 63 is an example of a user interface for a Master-Mixer Console from the Authoring tool part of the system from FIG. 1;

FIG. 64 is the user interface from FIG. 56, illustrating the use of the shortcut menu to access the Multi Editor user interface illustrated in FIGS. 65A-65B;

FIGS. 65A-65B illustrate an example of a user interface for a Multi Editor from the Authoring tool part of the system from FIG. 1;

FIG. 66 is a flowchart illustrating how the Authoring tool determines which sounds within the actor-mixer structure are played per game object;

FIG. 67 is a flowchart illustrating how the Authoring tool determines which sounds are outputted through a bus;

FIG. 68 illustrates the setting of playback limit within the Actor-Mixer hierarchy;

FIG. 69 is an example of a user interface for the Property Editor in the context of a Random/Sequence Container, illustrating a “Playback Limit” group box;

FIG. 70 is an example of a user interface for a SoundBank Manager from the Authoring tool part of the system from FIG. 1;

FIG. 71 is an example of text inputs for a definition file, which lists events in the game in a SoundBank;

FIG. 72 is an example of a user interface for an Import Definition log dialog box from the Authoring tool part of the system from FIG. 1;

FIG. 73 is an example of a user interface for a SoundBank Generator from the Authoring tool part of the system from FIG. 1;

FIG. 74 is an example of a user interface for a Project Launcher menu from the Authoring tool part of the system from FIG. 1;

FIG. 75 is an example of content for a Project Folder as created from the Authoring tool part of the system from FIG. 1;

FIG. 76 is an example of a user interface for a Project Settings dialog box from the Authoring tool part of the system from FIG. 1;

FIG. 77 is an example of a user interface for a Schematic Viewer from the Authoring tool part of the system from FIG. 1;

FIG. 78 is an example of a user interface for a Schematic View settings dialog box from the Authoring tool part of the system from FIG. 1;

FIG. 79 is the user interface from FIG. 77, further including selected properties information for each object and bus;

FIG. 80 is an example of a user interface for an auditioning tool from the Authoring tool part of the system from FIG. 1;

FIG. 81 is a close up view of the Playback Control area from the auditioning tool from FIG. 80;

FIG. 82 is a close up view of the Game Syncs area from the auditioning tool from FIG. 80;

FIG. 83 is a schematic view illustrating the segmentation of a project into work units;

FIG. 84 is the user interface from FIG. 56, illustrating the segmentation of the Actor-Mixer hierarchy into work units;

FIG. 85 is an example of a user interface for a pop up menu allowing specifying the name and location of a new Work Unit;

FIG. 86 is an example of a user interface for the States tab of the Property Editor from the Authoring tool part of the system from FIG. 1, illustrating the icon buttons in the title bar which provide access to the templates functionalities;

FIG. 87 is a schematic view illustrating how a Property Set shares effect properties on a plurality of sound objects;

FIG. 88 is an example of a user interface for an Effect Editor from the Authoring tool part of the system from FIG. 1; and

FIG. 89 is an example of a user interface for a Profiler from the Authoring tool part of the system from FIG. 1.

### DETAILED DESCRIPTION

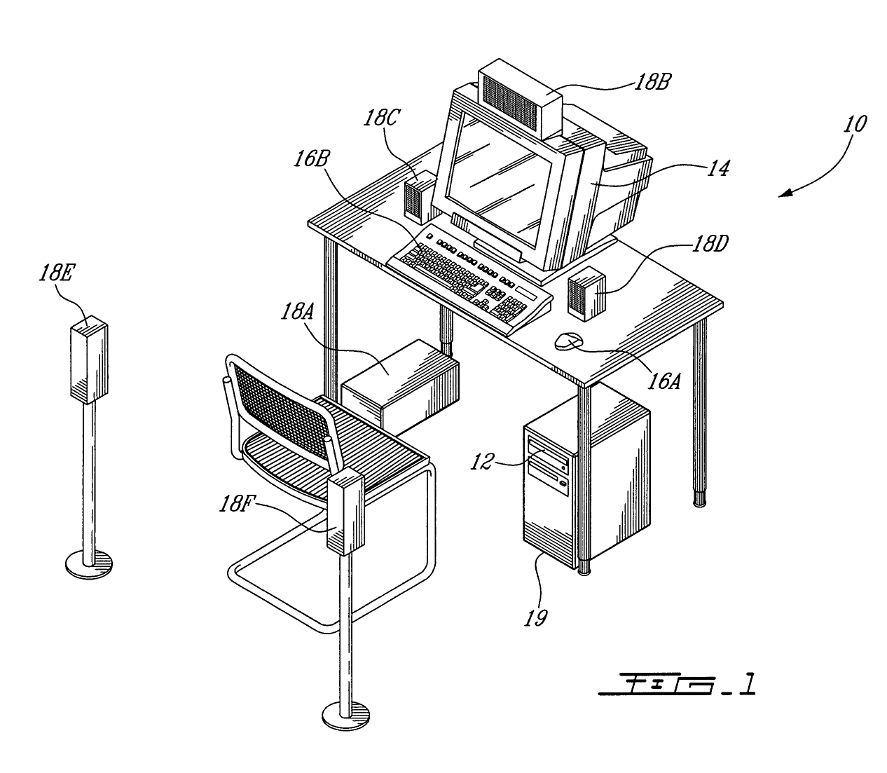

A system 10 for authoring media content according to a first illustrative embodiment will now be described with reference to FIG. 1. The system 10 according to this first illustrative embodiment is for authoring audio for a video game.

The system 10 comprises a computer 12 programmed with instructions for generating an authoring application, which will be referred to herein as the “Authoring tool”, allowing for:
receiving audio files;
creating a sound object from and for each of the audio file;
providing a hierarchical structure including the sound objects and containers to assign properties and behaviours to the sound objects; and
storing links to the sound objects in a project file to be used by the computer application.

The system 10 further comprises a display 14, conventional input devices, in the form for example of a mouse 16A and keyboard 16B, and six (6) sound speakers 18A-18F, including a sub-woofer 18A, configured to output sounds to discreet channels that can optionally be encoded in a 5.1 Dolby™ Digital setup. The system 10 is of course not limited to this setup. The number and type of input and output device may differ and/or the sound output setup may also be different.

The system 10 also includes a conventional memory (not shown), which can be of any type. The system 10 is further configured for network connectivity 19. Since it is believed to be well-known in the art to provide a computer or other similar devices with network connectivity, such implementation will not be described herein in further detail.

As will be described hereinbelow, the computer 12 is further programmed with instructions to generate user interactive interfaces to manage the hierarchical sound structure and to create, assign and manage properties and behaviours and to manage and create project files, among others.

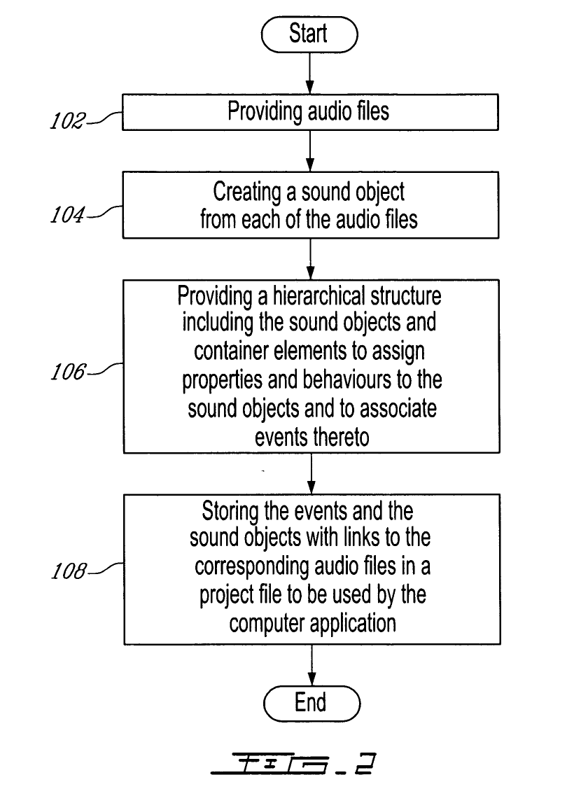

These and other characteristics and features of the system 10, and more specifically of the Authoring tool, will become more apparent upon reading the following description of a method 100 for authoring media content for a computer application according to a first illustrative embodiment, which is illustrated in FIG. 2.

According to the first illustrative embodiment, the method 100 is in the form of a method for authoring audio for a video game. The method 100 comprises the following steps:

102—providing audio files;

104—for each of the audio files, creating a sound object which is linked thereto;

106—providing a hierarchical structure including the sound objects and containers to assign properties and behaviours to the sound objects and to associate events thereto;

108—storing the events and the sound objects with links to the corresponding audio files in a project file to be used by the computer application.

Each of these steps and further characteristics of the Authoring tool will now be described in more detail.

In step 102, audio files are provided. These media files are used to author the media content for the computer application.

According to the first illustrative embodiment, step 102 includes importing audio files and then managing them effectively so that a project is regularly updated with the most current audio files. The Authoring tool comprises an audio file importer component for that purpose.

The files are loaded from a selected path located on the system 10 or from a remote path accessible from the network 19. They are centrally stored to be accessed by many users in a predetermined folder, which will be referred to as the “Originals” folder” and locally in a project cache for individual users, to cope with situations wherein the game audio developer may not be the only person working with these files.

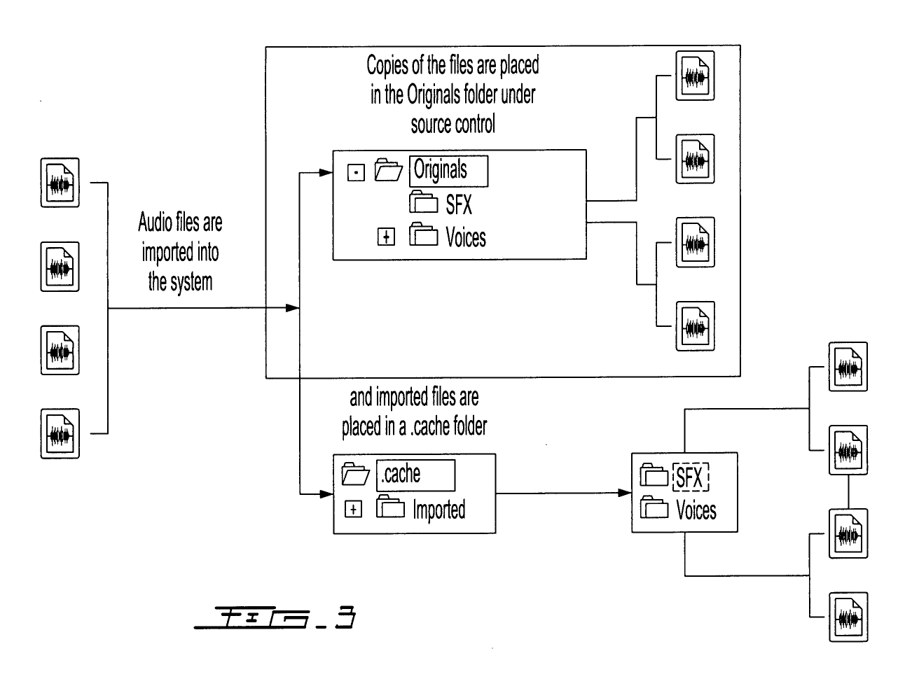

Step 102 then proceeds with the creation of work copies of the audio files including an import process. The importing steps will now be described in more detail with reference to FIGS. 3 and 4.

The import process includes the following sub-steps:
The audio files are validated, and imported into the project. The audio files can be for example in the form of WAV files including uncompressed audio in the pulse-code modulation (PCM) format. Other file formats, including MP3 (MPEG-1 Audio Layer 3) files or MIDI (Musical Instrument Digital Interface) files can also be used. Since WAV, MP3 and MIDI files are believed to be well known in the art, and for concision purposes, they will not be described herein in more detail;
The original files remained untouched and are copied into the Originals folder;
In cases of WAV files, copies of the imported files undergo an import conversion process wherein 24 bit files are converted to 16 bit. These copies are stored in a dedicated repertoire (Project\.cache\Imported in the present example). It has been found advantageous, before the import process, to remove the DC offset using a DC offset filter. Indeed, DC offsets can affect volume and cause artifacts. There are some cases however where the DC offset should not be removed, for example for sample accurate containers. In other cases, for example, where sounds are normalized to 0 dB, the DC offset may or may not be removed;
Audio sources are created for the audio files;
Sound objects that contain the audio sources are created.

It is to be noted that the above-described import conversion process may be adapted depending on the application.

Sound objects are provided in the project hierarchy to represent the individual audio assets that are created therefor. Each sound object contains a source, which defines the actual audio content that will be played in game.

The sources can be segregated into different types. According to the first illustrative embodiment, the types include: audio sources, silence sources, and plug-in sources, the most common type of source being the audio source.

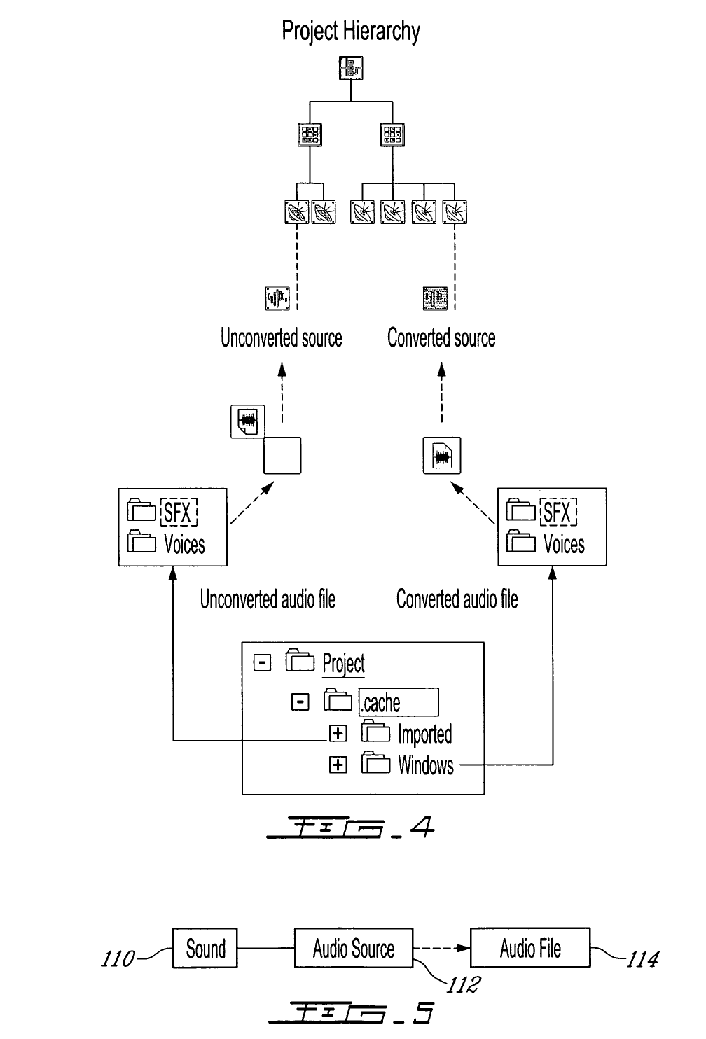

As illustrated in FIG. 5, an audio source 112 creates a separate layer between the audio file 114 and the sound object 110. It is linked to the audio file imported into the project and includes the conversion settings for a specific game platform. The audio file importer component is configured for automatically creating objects and their corresponding audio sources when an audio file is imported into a project. The audio source remains linked to the audio file imported into the project so that it can be referenced at any time.

The Authoring tool is further configured to allow a game audio author to enhance the game audio by creating source plug-ins. These plug-ins, which can be in the form for example of synthesizers or physical modeling, can be integrated into the project where they are added to sound objects.

The Audio File Importer includes an Audio File Importer graphical user interface (GUI) 116 including interface elements to allow the user to import new audio files and to define the context from which they are imported. Indeed, an audio file can be imported at different times and for different reasons, according to one of the following two situations:
to bring audio files into a project at the beginning of the project, or as the files become available; or
to replace audio files previously imported, for example, to replace placeholders or temporary files used at the beginning of the project.

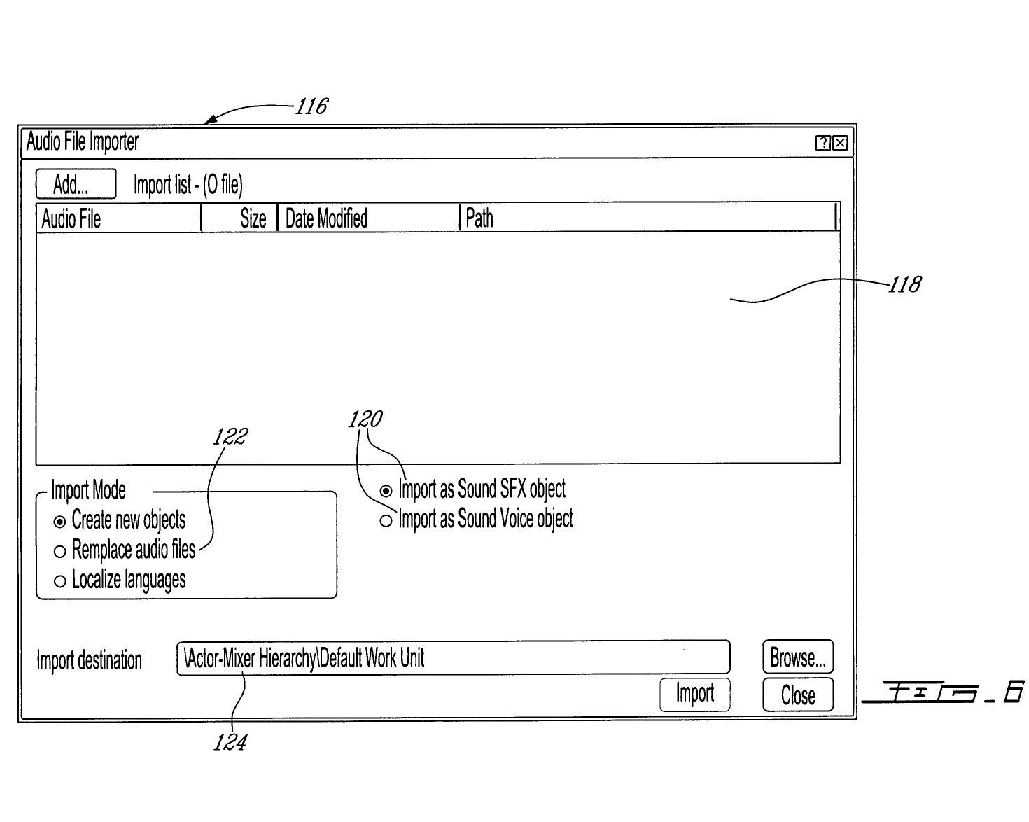

An example of such an Audio File Importer GUI 116 is illustrated in FIG. 6. The Audio File Importer GUI 116 further includes a window 118 for displaying the imported audio files and their characteristics, including their sizes, name, date of modification, etc. FIG. 7 illustrates the GUI of FIG. 6 including a list of audio files to import 120.

The Audio File Importer GUI 116 is configured to allow importing files by dragging computer files in the GUI.

Since, in some specific applications, it might be useful to further segregate the sound objects, the Authoring tool is further configured for their characterization at the importing step. For that purpose, as illustrated in FIGS. 6 and 7, the Audio File Importer GUI includes GUI elements 120 to select the type of sound object. According to the first illustrated embodiment, the sound object can be characterized as being a voice-over object or and sound effect (SFX) object. Of course, the present system and method is not limited to these types of objects, which are given for illustrative purposes only.

The Authoring tool is configured to allow using temporary files as placeholders until the intended files to be used are available or, in any case, to replace imported files, for example, if there are technical problems therewith. As can be seen in FIGS. 6 and 7, the Audio File Importer includes a select item option 122 to put the system in a file replacing mode wherein the listed files will be replaced by the new files which will be imported, for example by dragging them into the GUI. Since the GUI used for this replacement process is the same than for the initial importation process, the Authoring tool allows defining the type of objects that the files will become after the replacement process (sound effect or voice).

Step 102 further includes verifying for errors while importing files. These errors may include recoverable errors and non-recoverable errors. The Authoring tool includes a Conflict Manager to provide means for the user to resolve recoverable errors. Unrecoverable errors include errors for which solutions have not been foreseen in the Authoring tool but which can be solved outside the Tool using traditional programming tools.

A conflict may arise for example when an already existing file is imported and the Replace mode 122 has not been selected.

The Conflict Manager includes a pop up window informing the user of the conflict and offering alternate choices. In the previous example, the system may offer 1) to replace the existing audio file with the file being imported, 2) to continue using the file which is currently linked to the audio source, or 3) to cancel the import operation.

The Conflict Manager can take other forms allowing informing the user of a conflict and prompting an alternate choice or solution.

As illustrated in FIGS. 3 and 4, the copies of the imported files are stored in a dedicated folder, advantageously stored in a cache folder, which contains the project files. This dedicated folder will be referred to herein as the “Imported” folder. The Audio File Importer GUI 116 includes an interface element in the form of a text box 124 for inputting the import destination in the system 10.

The Authoring tool is provided with a File Managing component including a GUI (both not shown) to manage audio files, including clearing the cache folder to remove files that are no longer used, are outdated, or are problematic.

For example, if an object has been deleted, the audio files or orphans are no longer needed but are still associated with the objects and will remain in the cache folder until they are cleared. In any case, the File Managing Component can be used to clear the entire audio cache before updating the files in the project from the Originals folder.

The File Managing component is configured to selectively clear the cache folder based on audio files allowing specifying which type of files to clear: all files, only the orphan files, or converted files.

The Authoring tool is further configured to allow updating the .cache folder so that the project references the new audio files for sound objects when the files in the Originals folder are changed, or new files are added. During the update process, out of date files in the .cache folder are detected and then updated.

According to a further embodiment, the importing process is omitted and unconverted versions of the digital media files provided in step 102 are used by the Authoring tool.

The media files may be provided from any sources, such as the computer 12 memory, a remote location via the network connectivity 19, an external support (not shown), etc.

Also, depending on the application and according to other embodiments, the media files can be of any type and are therefore not limited to audio files and more specifically to .WAV files.

The media files can alternatively be streamed directly to the system 10 via, for example, but not limited to, a well-known voice-over-ip, protocol. More generally, step 102 can be seen as providing digital media, which can be in the form of a file or of a well-known stream.

More generally, in step 102, the digital media files are provided in such a way that the media objects that will be created therefrom in step 104 will share content characteristics therewith so that at least part of it can be used by the Authoring Tool. For example, part of each digital media files can be extracted, a work copy can be done, etc.

Media Objects—Sounds

Referring briefly to FIG. 2, the method 100 then proceeds with the creation of a sound object for each of the audio file (step 104).

Objects are created for imported audio files, and the objects reference audio sources, wherein the sources contain the conversion settings for a selected project platform.

In step 106 of the method 100, the sound objects are grouped and organized in a first hierarchical structure, yielding a tree-like structure including parent-child relationships whereby when properties and behaviours are assigned to a parent, these properties and behaviours are shared by the child thereunder.

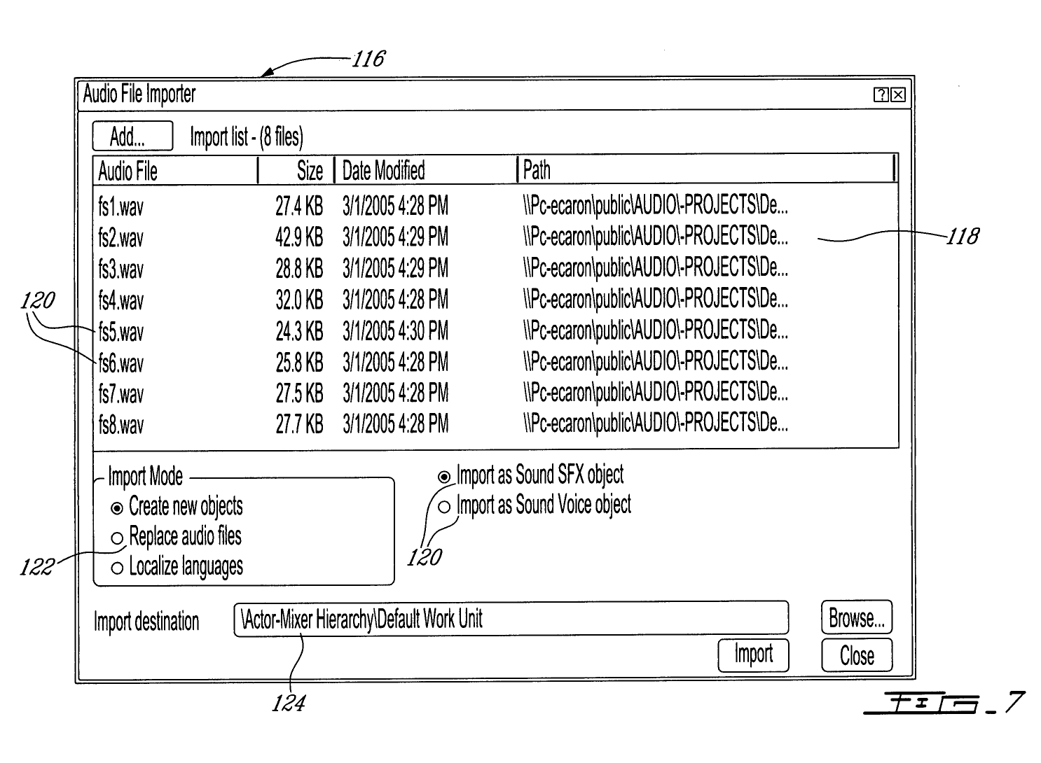

More specifically, as illustrated in FIG. 8, the hierarchical structure includes containers (C) to group sound objects (S) or other containers (C), and actor-mixers (AM) to group containers (C) or sound objects (S) directly, defining parent-child relationships between the various objects.

As will be described hereinbelow in more detail, sound objects (S), containers (C), and actor-mixers (AM) all define object types within the project which can be characterized by properties, such as volume, pitch, and positioning, and behaviours, such as random or sequence playback.

Also, by using different object types to group sounds within a project structure, specific playback behaviours of a group of sounds can be defined within a game.

The following table summarizes the objects that can be added to a project hierarchy:

TABLE 1

| Object | Icon | Description |
|---|---|---|
| Sounds | | Objects that represent the individual |
| | | audio asset and contain the audio |
| | | source. There are two kinds of sound |
| | | objects: |
| | [symbol] | Sound SFX - sound effect object |
| | [symbol] | Sound Voice - sound voice object. |
| Containers | | A group of objects that contain |
| | | sound objects or other containers |
| | | that are played according to certain |
| | | behaviours. Properties can be |
| | | applied to containers which will |
| | | affect the child objects therein. |
| | | There are two kinds of containers: |
| | [symbol] | Random Containers - group of one |
| | | or more sounds and/or containers |
| | | that can be played back in a random |
| | | order or according to a specific |
| | | playlist. |
| | [symbol] | Sequence Container - group of one |
| | | or more sounds and/or containers |
| | | that can be played back according to |
| | | a specific playlist. |
| | [symbol] | Switch Container - A group of one |
| | | or more containers or sounds that |
| | | correspond to changes in the game. |
| Actor-Mixers | [symbol] | High level objects into which other |
| | | objects such as sounds, containers |
| | | and/or actor-mixers can be grouped. |
| | | Properties that are applied to an |
| | | actor-mixer affect the properties of |
| | | the objects grouped under it. |
| Folders | [symbol] | High level elements provided to |
| | | receive other objects, such as |
| | | folders, actor-mixers, containers and |
| | | Sounds. Folders cannot be child |
| | | objects for actor-mixers, containers, |
| | | or sounds. |
| Work Units | [symbol] | High level elements that create XML |
| | | files and are used to divide up a |
| | | project so that different people can |
| | | work on the project concurrently. It |
| | | can contain the hierarchy for project |
| | | assets as well as other elements. |
| Master-Mixers | [symbol] | Master Control Bus/Control Bus |

The icons illustrated in the above table are used both to facilitate the reference in the present description and also to help a user navigate in an Audio Tab of a Project Explorer provided with the Authoring tool which allows a user to create and manage the hierarchical structure as will be explained hereinbelow in more detail.

As illustrated in FIG. 9, containers are the second level in the Actor-Mixer Hierarchy. Containers can be both parent and child objects. Containers can be used to group both sound objects and containers. As will be described hereinbelow in more detail, by “nesting” containers within other containers, different effects can be created and realistic behaviours can be simulated.

Actor-mixers sit one level above the container. The Authoring tool is configured so that an actor-mixer can be the parent of a container, but not vice versa.

Actor-mixers can be the parent of any number of sounds, containers, and other actor-mixers. They can be used to group a large number of objects together to apply properties to the group as a whole.

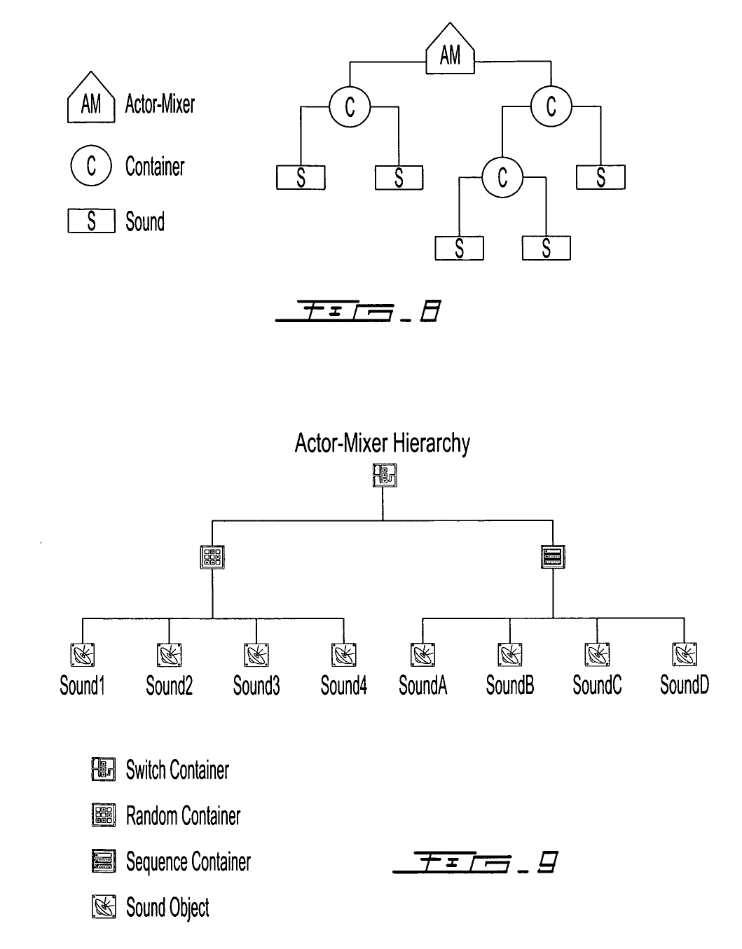

FIG. 10 illustrates the use of actor-mixers to group sound objects, containers, and other actor-mixers.

The characteristics of the random, sequence, and switch containers will also be described hereinbelow in more detail.

The above-mentioned hierarchy, including the sound objects, containers, and actor-mixers will be referred to herein as the Actor-Mixer hierarchy.

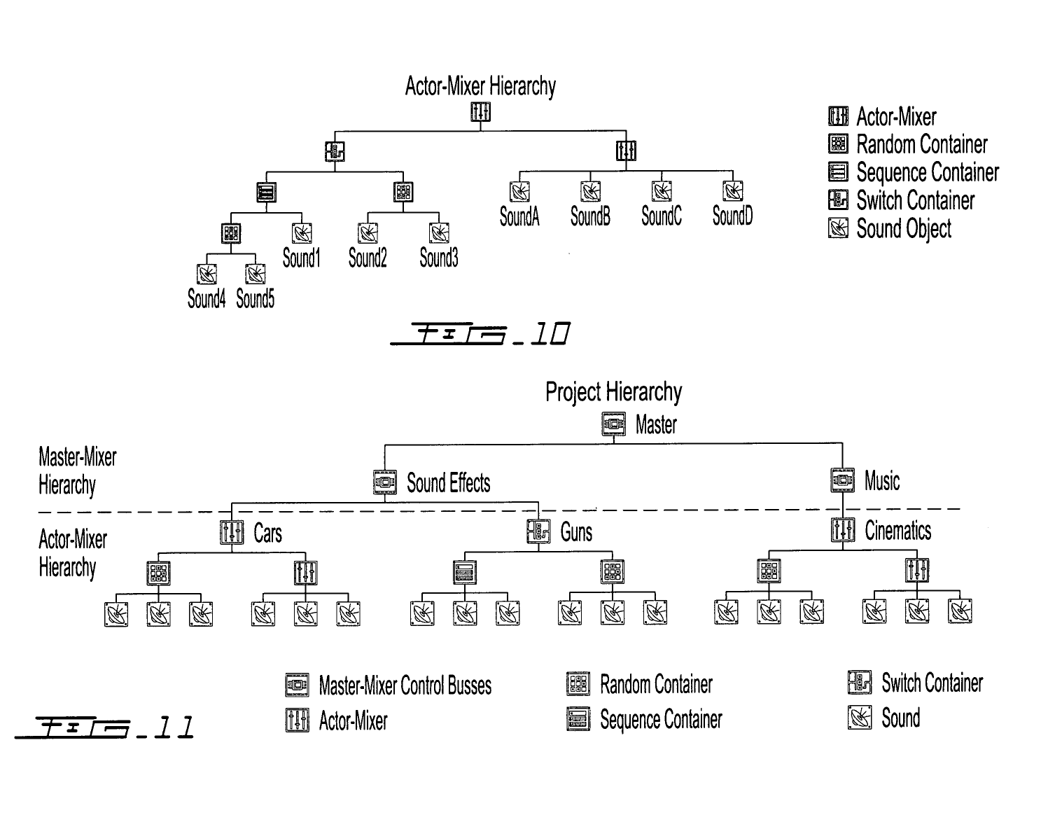

An additional hierarchical structure sits on top of the Actor-Mixer hierarchy in a parent-like relationship: the Master-Mixer hierarchy. The Master-Mixer Hierarchy is a separate hierarchical structure of control busses that allows re-grouping the different sound structures within the Actor-Mixer Hierarchy and preparing them for output. The Master-Mixer Hierarchy consists of a top-level “Master Control Bus” and any number of child control busses below it. FIG. 11 illustrates an example of a project hierarchy including Master-Mixer and Actor-Mixer hierarchies. As can also be seen in FIG. 11, the Master-Mixer and control busses are identified by a specific icon.

The child control busses allow grouping the sound structures according to the main sound categories within the game. Examples of user-defined sound categories include:
voice;
ambience;
sound effects; and
music.

These control busses create the final level of control for the sound structures within the project. They sit on top of the project hierarchy allowing to create a final mix for the game. As will be described hereinbelow in more detail, effects can also be applied to the busses to create the unique sounds that the game requires.

Since the control busses group complete sound structures, they can further be used to troubleshoot problems within the game. For example, they allow muting the voices, ambient sounds, and sound effects busses, to troubleshoot the music in the game.

Each object within the hierarchy is routed to a specific bus. However, as illustrated in FIG. 12, the hierarchical structure allows defining the routing for an entire sound structure by setting them for the top-level parent object. The output routing is considered an absolute property. Therefore, these settings are automatically passed down the child objects below it. Other characteristics and functions of the Master-Mixer hierarchy will be described hereinbelow in more detail.

The Authoring tool includes a Project Explorer GUI allowing creating and editing an audio project, including the project hierarchy structure.

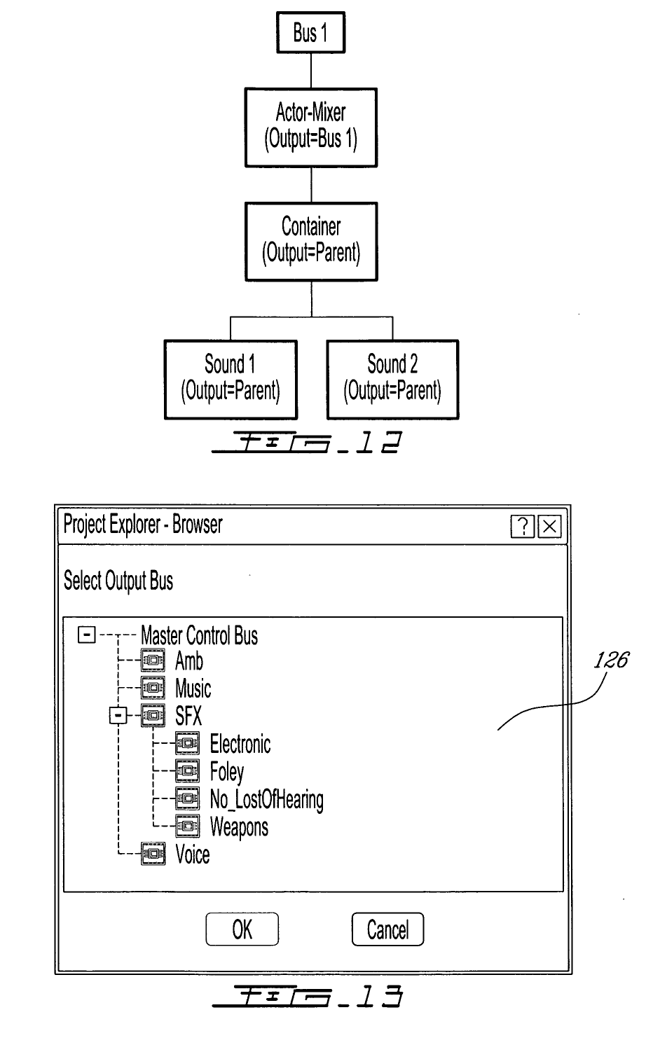

FIG. 13 illustrates an example of browser 126 within the Project Explorer allowing editing the master control bus via conventional pop up menus associated to bus elements.

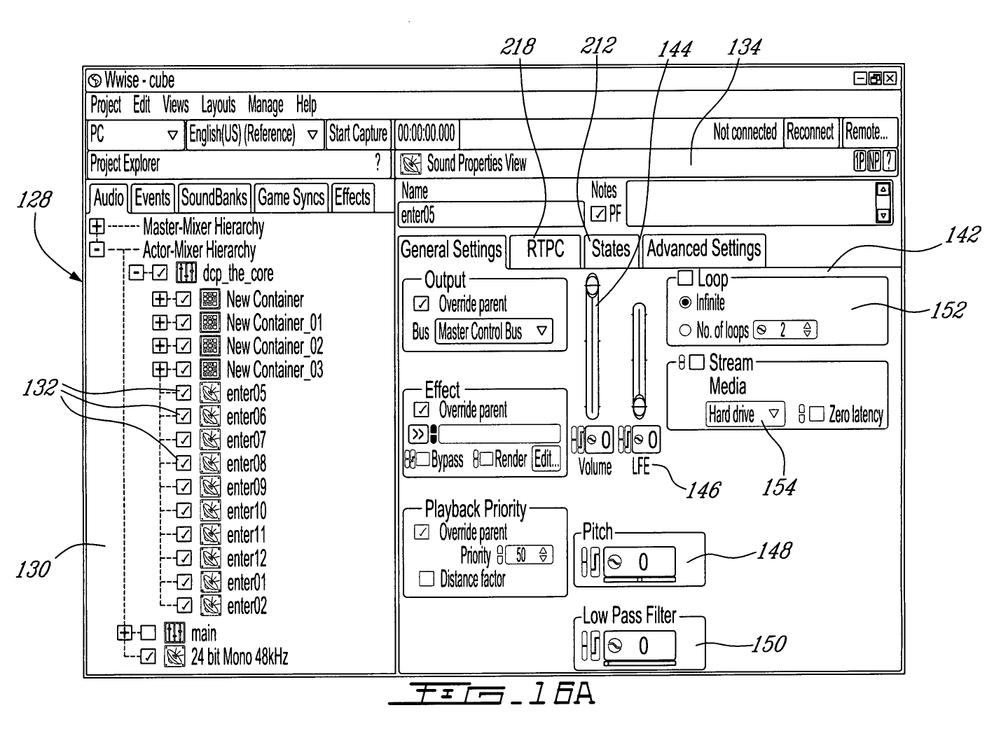

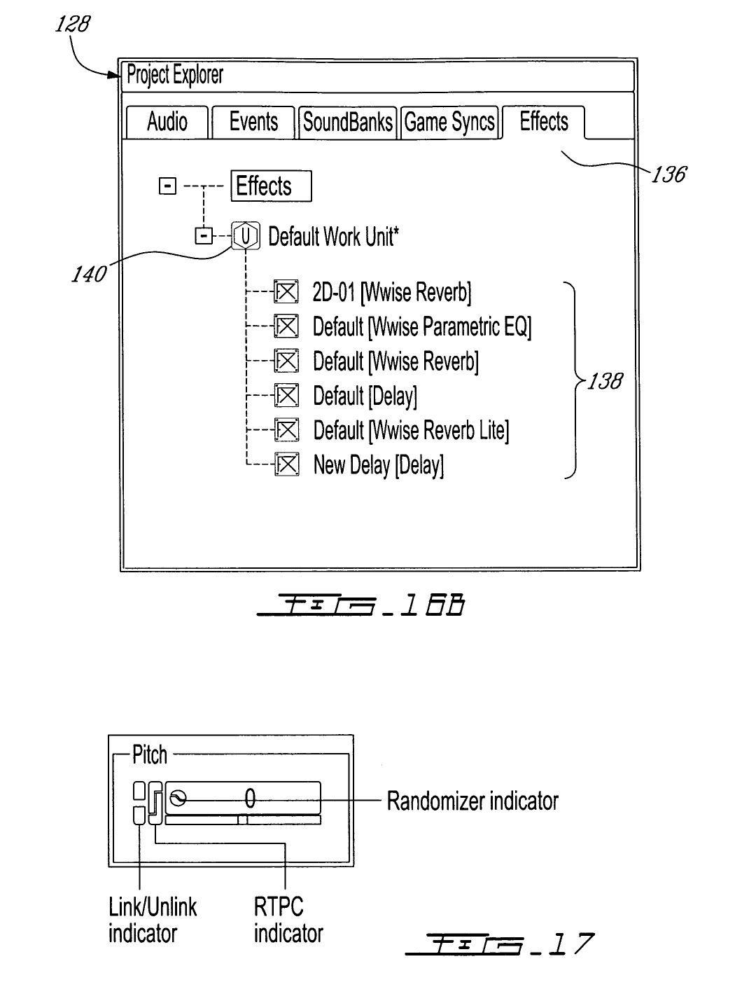

The Project Explorer 128 includes a plurality of secondary user interfaces accessible through tabs allowing to access different aspects of the audio project including: audio, events, soundbanks, game syncs, effects, simulations (see FIG. 16B for example). Each of these aspects will be described hereinbelow in more detail.

An Audio tab 130 is provided to display the newly created sound objects 132 resulting from the import process and to build the actual project hierarchy (see FIG. 16A). It is configured to allow either:
setting up the project structure and then importing audio files therein;
importing audio files and then organizing them afterwards into a project structure.

As briefly described in Table 1, a hierarchy can be built under work units.

The hierarchical structure is such that when sounds are grouped at different levels in the hierarchy, the object properties and behaviours of the parent objects will affect the child objects differently based on the property type.

Properties

The properties of an object can be divided into two categories:
relative properties, which are cumulative and are defined at each level of the hierarchy, such as pitch and volume. The sum of all these values determines the final property; and
absolute properties, are defined at one level in the hierarchy, usually the highest. Examples of absolute properties include positioning and playback priority. As will be described hereinbelow in more detail, the Authoring tool is so configured as to allow overriding the absolute property at each level in the hierarchy.

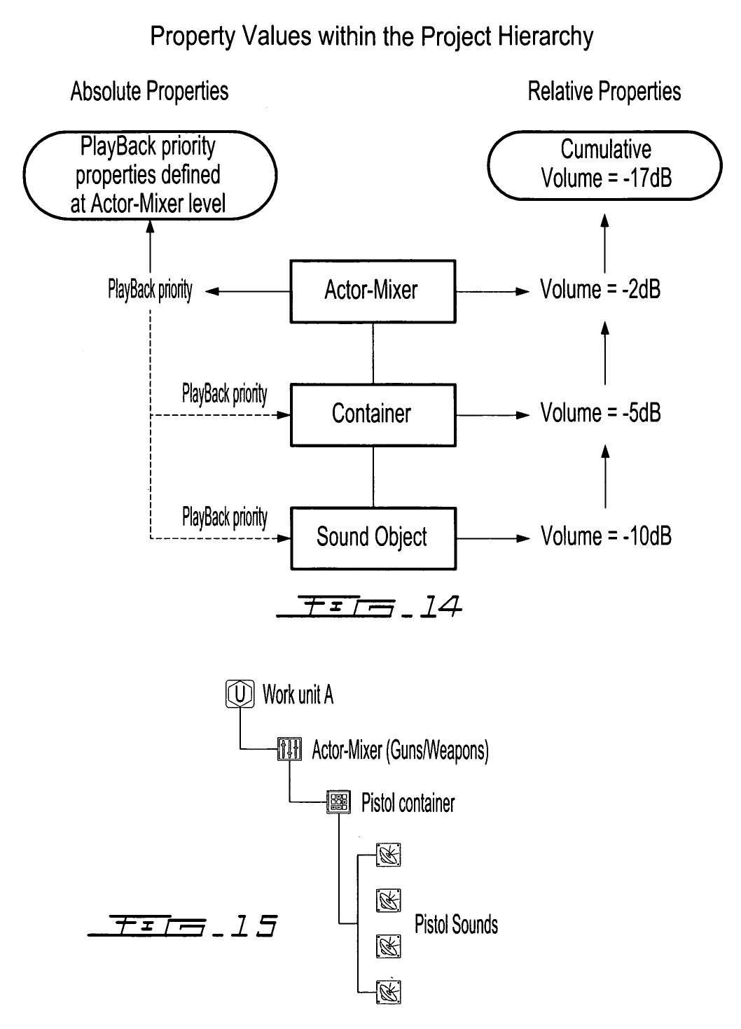

FIG. 14 illustrates how the two types of property values work within the project hierarchy. In this example, the positioning properties are absolute properties defined at the Actor-Mixer level. This property is therefore assigned to all children object under the actor-mixer. On the other hand, different volumes are set for different objects within the hierarchy, resulting in a cumulative volume which is the sum of all the volumes of the objects within the hierarchy since the volume is defined as a relative property.

A preliminary example of the application of the hierarchical structure to group and manage sound objects according to the first illustrative embodiment is illustrated in FIG. 15 referring to pistol sounds in a well-known first person shooter game.

The game includes seven different weapons. Grouping all the sounds related to a weapon into a container allows the sounds for each weapon to have similar properties. Then grouping all the weapon containers into one actor-mixer provides for controlling properties such as volume and pitch properties of all weapons as one unit.

Object behaviours determine which sound within the hierarchy will be played at any given point in the game. Unlike properties, which can be defined at all levels within the hierarchy; behaviours can be defined for sound objects and containers. The Authoring tool is also configured so that the types of behaviours available differ from one object to another as will be described furtherin.

Since the Authoring tool is configured so that absolute properties are automatically passed down to each of a parent's child objects, they are intended to be set at the top-level parent object within the hierarchy. The Authoring tool is further provided with a Property Editor GUI allowing a user to specify different properties for a particular object should the user decide to override the parent's properties and set new ones. The Authoring tool also includes a Multi-Editor, which will be described hereinbelow in more detail, allowing a user to override a plurality of selected properties for selected objects.

The Property Editor 134 (see FIG. 16A) is provided to edit the property assigned to an object 132 (“enter05” in the example of FIG. 16A). The Property Editor 134 can be used for example to apply effects to the objects within the hierarchy to further enhance the sound in-game. Examples of effects that can be applied to a hierarchical object include: reverb, parametric EQ, delay, etc.

The Authoring tool is configured as an open architecture allowing a user to create and integrate their own effect plug-ins. As illustrated in FIG. 16B, the Project Explorer 128 includes an Effects tab GUI 136 including a tree-like list 138 of the sound effects available for each work unit 140. The Effects tab 136 further includes tools (not shown) to edit and manage the corresponding effects.

Property sets are provided to manage the different variations of an effect in the project. Property sets can also be used to share the properties of an effect across several objects. Therefore, the effects properties don't have to be modified for each object individually. Using property sets across objects allows saving time when many instances of the same effect are used in many different areas of the project. Custom property sets are applied to one sound object. If the properties of a custom property set are changed, that object is affected. Property Sets will be described hereinbelow in more detail.

Returning to FIG. 16A, the Property Editor includes GUI elements to assign effects to a selected object. The Property Editor GUI further includes element for bypassing a selected effect, allowing a user to audition the original unprocessed version. In addition the Property Editor GUI further includes an element for rendering an effect before it is processed in SoundBanks to save processing power during game play.

As illustrated in FIG. 16A, the Property Editor further includes a control panel 142 to define relative properties for the object selected in the hierarchy through the Audio tab 130.

According to the illustrative embodiment, the Property Editor includes control panel elements 144-150 to modify the value of the following four relative properties:
volume;
LFE (Low Frequency Effect);
pitch; and
LPF (Low Pass Filter).

The control panel 142 includes sliding cursors, input boxes, and check boxes for allowing setting the property values.

The present Authoring tool is however not limited to these four properties, which are given for illustrative purposes only.

As mentioned hereinabove, a Multi-Editor allows editing the relative and absolute properties and behaviours for a plurality of objects simultaneously.

The Authoring tool is further programmed with a Randomizer to modify some property values of an object each time it is played. More specifically, the Randomizer function is assigned to some of the properties and can be enabled or disabled by the user via a pop up menu accessible, for example, by right-clicking on the property selected in the Property Editor. Sliders, input boxes and/or any other GUI input means are then provided to allow the user to input a range of values for the randomizing effect.

As illustrated in FIG. 17 with reference to the pitch property menu portion 148 from the Property Editor 134, selected properties include a randomizer indicator to show the user whether the corresponding function has been enabled.

Behaviours

In addition to properties, each object in the hierarchy, including sound objects and containers, can be characterized by behaviours.

The behaviours determine how many times a sound object will play each time it is called and whether the sound is stored in memory or streamed directly from an external medium such as a DVD, a CD, or a hard drive. Unlike properties that can be defined at all levels within the hierarchy, behaviours are defined for sound objects and containers. The Authoring tool is configured such that different types of behaviours are made available from one object to another.

The Property Editor 134 includes control panel elements 152-154 allows defining the respectively following behaviours for a sound object:
Looping; and
Streaming.

The Authoring tool is configured so that, by default, sound objects play once from beginning to end. However, a loop can be created so that a sound will be played more than once. In this case, the number of times the sound will be looped should also be defined. The loop control panel element 152 (“Loop”) allows setting whether the loop will repeat a specified number of times or indefinitely.

The Authoring tool uses a pitch shift during the re-convert process to ensure that the files meet the requirements of the compression format. The loops remain sample accurate and the sample rate of the file is not changed.

The stream control panel element (“Stream”) allows setting which sounds will be played from memory and which ones will be streamed from the hard drive, CD, or DVD. When media is streamed from the disk or hard drive, an option is also available to avoid any playback delays by creating a small audio buffer that covers the latency time required to fetch the rest of the file. The size of the audio buffer can be specified so that it meets the requirements of the different media sources, such as hard drive, CD, and DVD.

Referring now to FIGS. 16A and 17, the Property Editor includes one or more indicators to show whether the property value is associated with a game parameter using RTPCs, in addition to the Randomizer indicator. The following table describes the indicators that are used in each of these situations:

TABLE 2

| Indicator | Name | Description |
|---|---|---|
| [symbol] _{(blue)} | RTPC - On | A property value that is tied to an in- |
| | | game parameter value using RTPCs. |
| [symbol] | RTPC - Off | A property value is not tied to an in- |
| | | game parameter value. |
| (yellow) | Randomizer - | A property value to which a |
| | On | Randomizer effect has been applied. |
| [symbol] | Randomizer - | A property value to which no |
| | Off | Randomizer effect has been applied. |

The above indicators are shared with a Contents Editor 156 which is part of the Project Explorer.

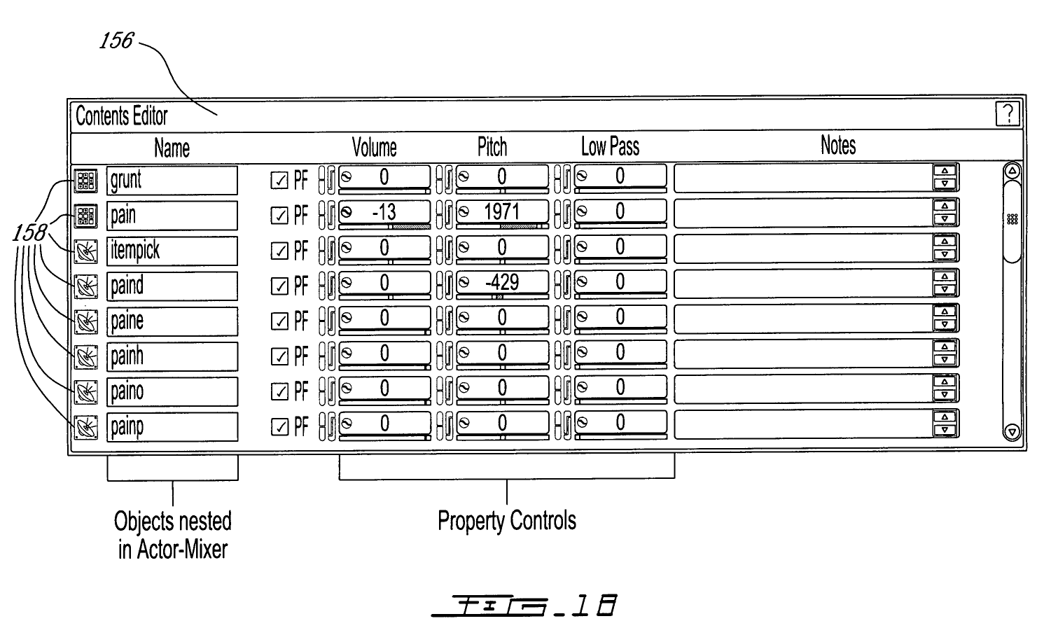

With reference to FIG. 18, the Contents Editor 156 displays the object or objects that are contained within the parent object that is loaded into the Property Editor. Since the Property Editor 134 can contain different kinds of sound structures, the Contents Editor 156 is configured to handle them contextually. The Contents Editor 156 therefore includes different layouts which are selectively displayed based on the type of object loaded.

For example, as illustrated in FIG. 18, when sound structures are loaded into the Contents Editor 156, it provides at a glance access to some of the most common properties associated with each object, such as volume and pitch. By having the settings in the Contents Editor 156, a parent's child objects can be edited without having to load them into the Property Editor 134. The Contents Editor also provides the tools to define playlists and switch behaviours, as well as manage audio sources and source plug-ins as will be described hereinbelow in more detail.

The general operation of the Contents Editor 156 will now be described.

When an object from the hierarchy is added to the Property Editor 134, its child objects 158 are displayed in the Contents Editor 156. As can be seen in FIG. 18, the Contents Editor 156, when invoked for an Actor-Mixer object, includes the list of all the objects 158 nested therein and for each of these nested objects 158, property controls including properties which can be modified using, in some instance, either a conventional sliding cursor or an input box, or in other instances a conventional check box.

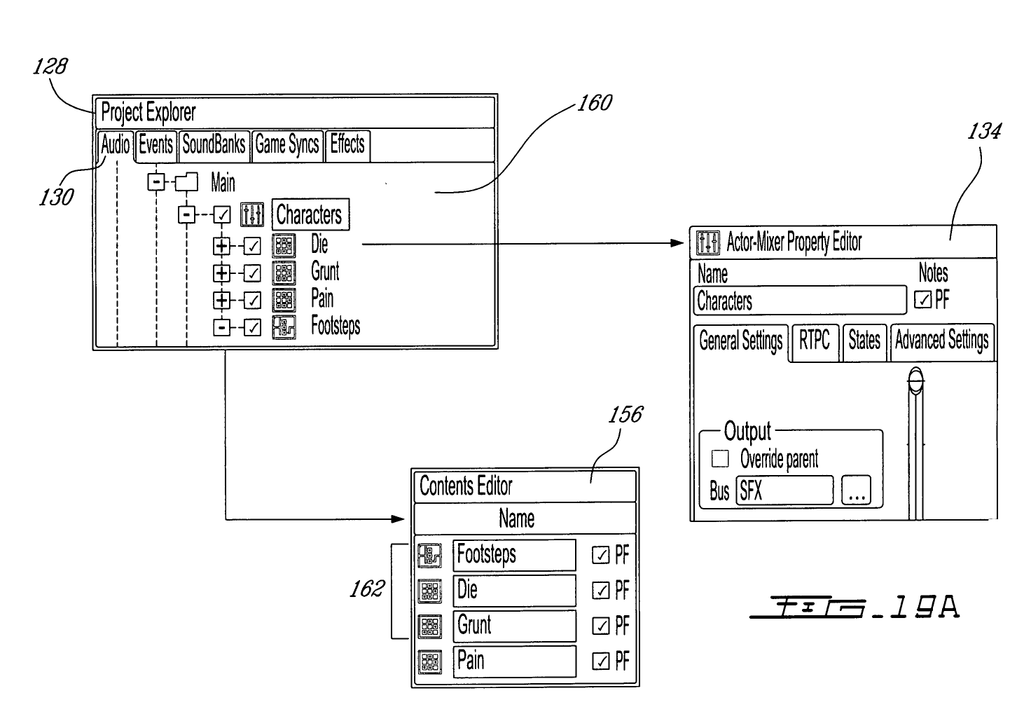

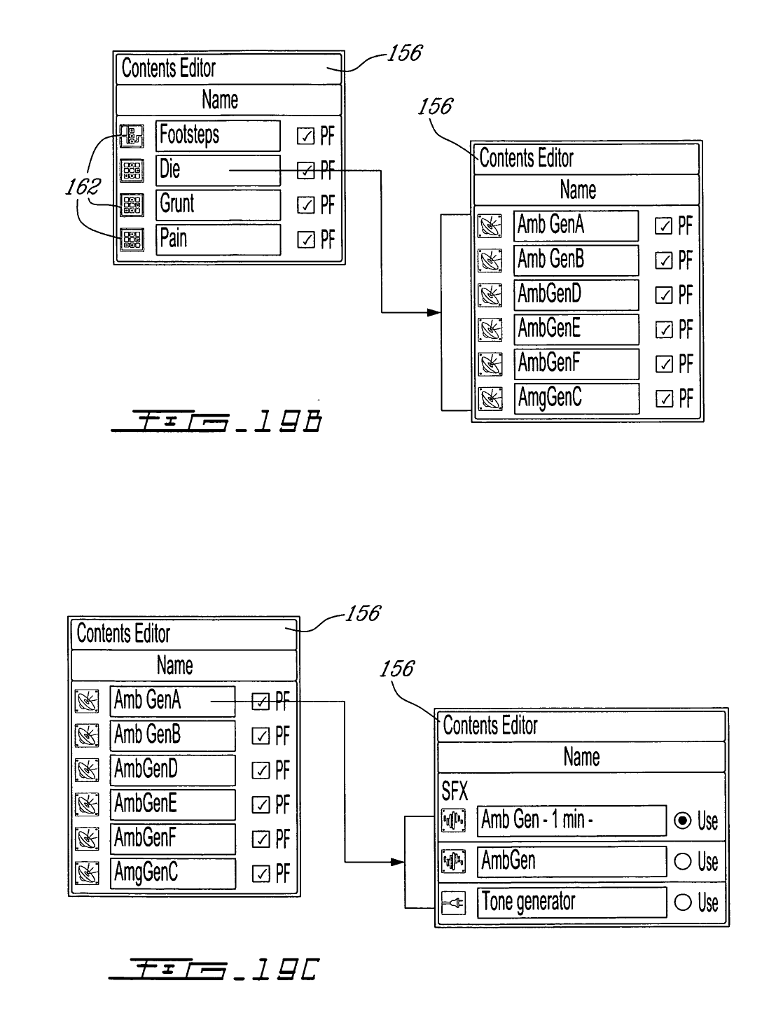

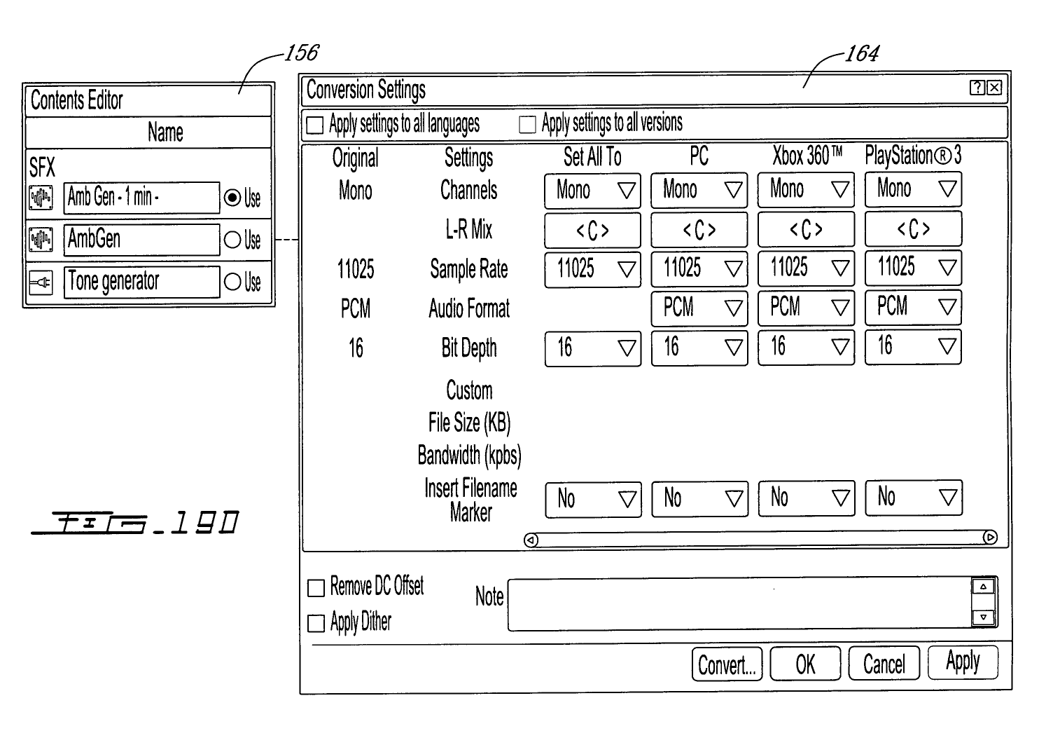

Another example of use of the Property Editor 134 to edit an Actor-Mixer object will now be provided with reference to FIGS. 19A-19E. According to this example, an Actor-mixer named “Characters” 160 is selected in the Audio tab 130 of the Project Explorer 128, it is loaded into the Property Editor 134 and its child random-sequence containers 162 are loaded into the Contents Editor 156.

The Contents Editor 156 is configured so that the project hierarchy can be moved down by double-clicking an object therein. This is illustrated from FIGS. 19A-19C.

Being at the source level in the Contents Editor 156 allows defining the settings for audio sources or source plug-ins. As illustrated in FIG. 19D, selecting an audio-source, for example by double-clicking it, allows opening a Conversion Settings dialog box 164.

Then, as illustrated in FIG. 19E, selected source plug-in properties can be defined, for example by selecting one of the effects, such as the Tone Generator source plug-in 166 in the menu. The Tone Generator source plug-in then opens the Source Plug-in Property Editor.

The Authoring tool is configured so as to allow a user to add an object to the Contents Editor 156 indirectly when it is added to the Property Editor 134, wherein its contents are simultaneously displayed in the Contents Editor 156, or directly into the Contents Editor 156, for example by dragging it into the Contents Editor 156 from the Audio tab 130 of the Project Explorer (see FIG. 16A) 128.

The Contents Editor 156 is further configured to allow a user selectively to delete an object, wherein a deleted object from the Contents Editor 156 is deleted from the current project. However, the Authoring tool is programmed so that deleting an object from the Contents Editor 156 does not automatically delete the associated audio file from the project cache folder. To delete the orphan file, the audio cache has to be cleared as discussed hereinabove.

Containers

Since different situations within a game may require different kinds of audio playback, the Authoring tool provides a hierarchical structure allowing to group objects into different types of containers such as:
Random;
Sequence containers;
Switch container.

As will now be described in further detail, each container type includes different settings which can be used to define the playback behaviour of sounds within the game. For example, random containers play back the contents of the container randomly, sequence containers play back the contents of the container according to a playlist, and switch containers play back the contents of the container based on the current switch, state, or RTPC within the game. A combination of these types of containers can also be used. Each of these types of containers will now be described in more detail.

Random Container

Random containers are provided in the hierarchy to play back a series of sounds randomly, either as a standard random selection, where each object within the container has an equal chance of being selected for playback, or as a shuffle selection, where objects are removed from the selection pool after they have been played. Weight can also be assigned to each object in the container so as to increase or decrease the probability that an object is selected for playback.

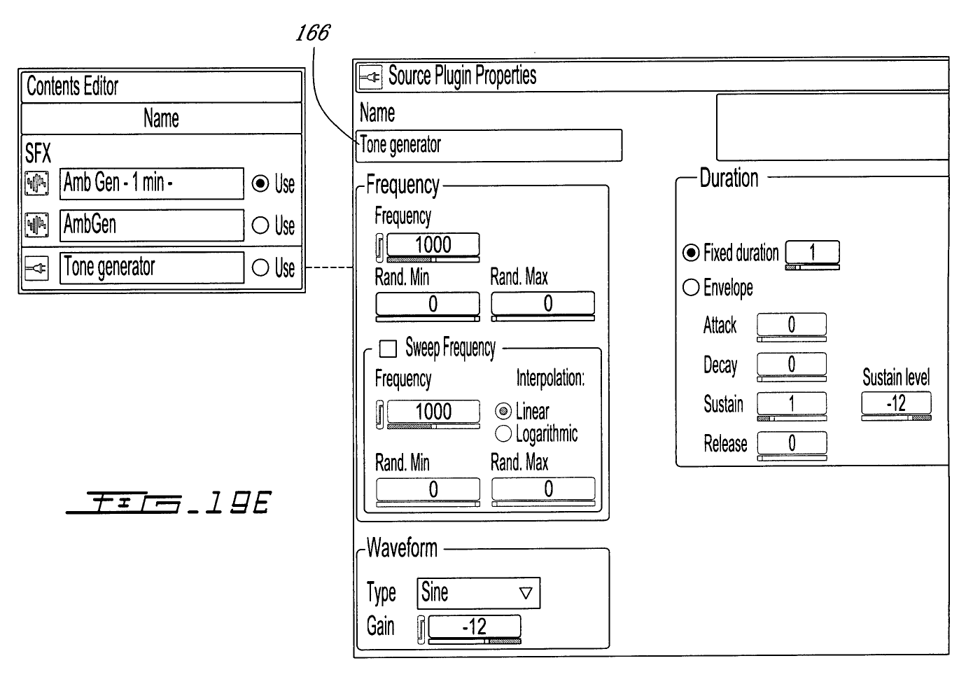

An example of use of a random container will now be described with reference to FIG. 20, where sounds are added in a cave environment in a video game. A random container is used to simulate the sound of water dripping in the background to give some ambience to the cave environment. In this case, the random container groups different water dripping sounds. The play mode of the container is set to Continuous with infinite looping to cause the sounds to be played continuously while the character is in the cave. Playing the limited number of sounds randomly adds a sense of realism.

As will be described hereinbelow in more detail, random and sequence containers can be further characterized by one of the following two play modes: Continuous and Step.

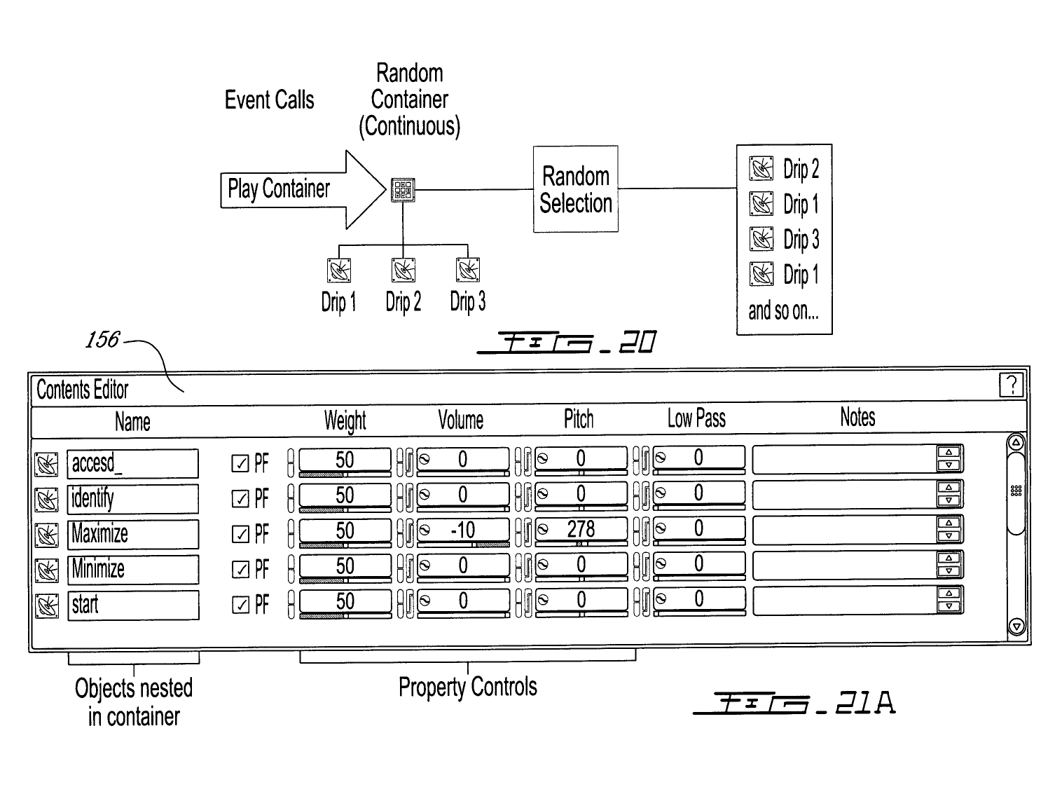

The Property Editor 134 is configured to allow creating a random container wherein objects within the container are displayed in the Contents Editor 156 (see FIG. 21A).

More specifically, the Contents Editor 156 includes a list of the objects nested in the container and associated property controls including properties associated to each object which can be modified using, in some instance, either a conventional sliding cursor or an input box, or in other instances a conventional check box.

The Property Editor 156 further includes a interactive menu portion 168 (see FIG. 21B) allowing to define the container as a random container and offering the following options to the user:
Standard: to keep the pool of objects intact. After an object is played, it is not removed from the possible list of objects that can be played and can therefore be repeated;
Shuffle: to remove objects from the pool after they have been played. This option avoids repetition of sounds until all objects have been played.

As illustrated in FIG. 21B, the interactive menu portion 168 further includes an option to instruct the Authoring tool to avoid playing the last x number of sounds played from the container. Of course, the behaviour of this option is affected by whether you are in Standard or Shuffle mode:
in Standard mode, the object played is selected completely randomly, but the last x objects played are excluded from the list;
in Shuffle mode, when the list is reset, the last x objects played will be excluded from the list.

As mentioned hereinabove, the objects in the container can further be prioritized for playback by assigning a weight thereto.

Sequence Container

Sequence containers are provided to play back a series of sounds in a particular order. More specifically, a sequence container plays back the sound objects within the container according to a specified playlist.

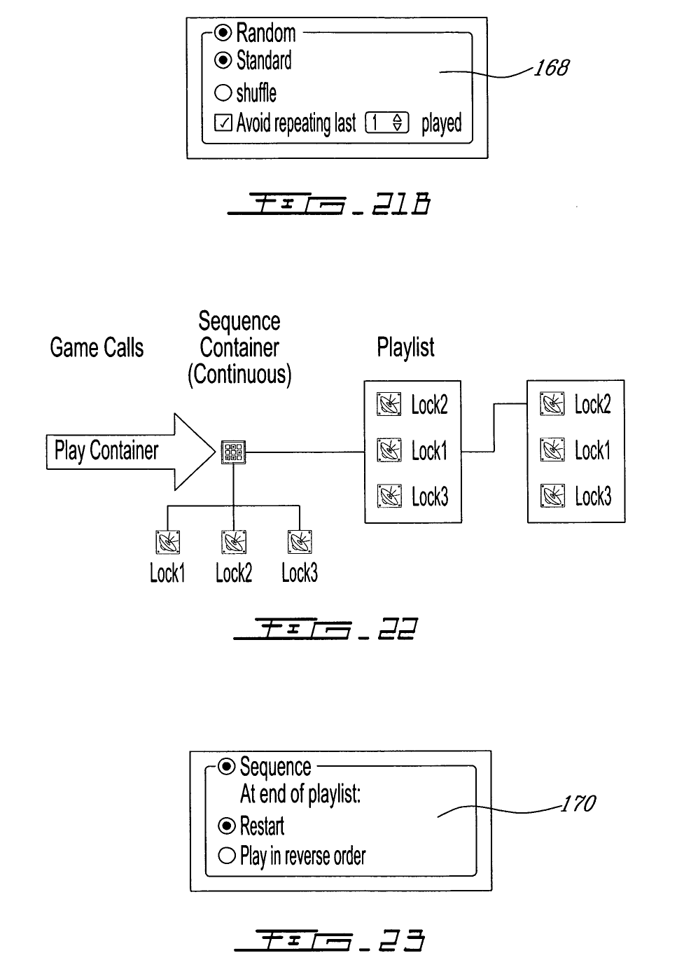

An example of use of a sequence container will now be described with reference to FIG. 22, where sounds are added to a first person shooter game. At one point in the game, the player must push a button to open a huge steel door with many unlocking mechanisms. In this case, all the unlocking sounds are grouped into a sequence container. A playlist is then created to arrange the sounds in a logical order. The play mode of the container is then set to Continuous so that the unlocking sounds play one after the other as the door is being unlocked.

After objects are grouped in a container, the container can be defined as a sequence container in the Property editor 134. The interactive menu portion 170 of the Contents Editor includes the following options to define the behaviour at the end of the playlist (see FIG. 23):
Restart: to play the list in its original order, from start to finish, after the last object in the playlist is played;
Play in reverse order: to play the list in reverse order, from last to first, after the last object in the playlist is played.

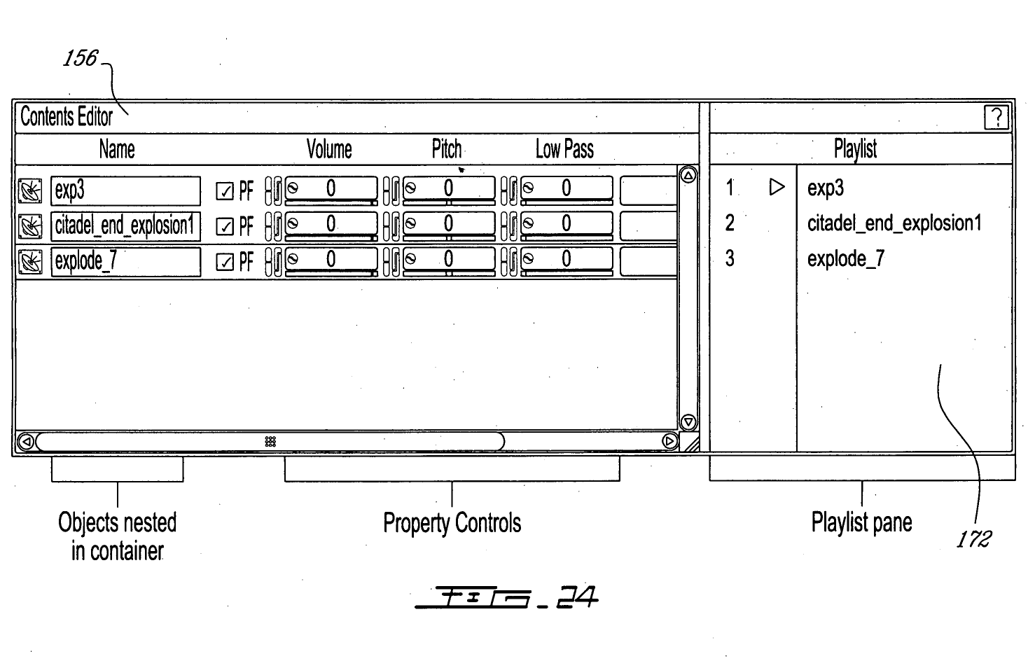

The Contents Editor 156 is configured so that when a sequence container is created, a Playlist pane 172 including a playlist is added thereto (see FIG. 24). The playlist allows setting the playing order of the objects within the container. As will now be described in more detail, the Playlist pane 172 further allows adding, removing, and re-ordering objects in the playlist.

As can also be seen in FIG. 24, the Contents Editor 156 further includes a list of the objects nested in the container and associated property controls including properties associated to each object which can be modified using, in some instance, either a conventional sliding cursor or an input box, or in other instances a conventional check box.

As in the case of any other types of containers or Actor-mixers, the Project Explorer 128 is configured so as to allow conventional drag and drop functionalities to add objects therein. These drag and drop functionalities are used to add objects in the playlist via the Playlist pane 172 of the Contents editor 156.

It is however believed to be within the reach of a person skilled in the art to provide other means to construct the hierarchy and more generally to add elements to lists or create links between elements of the audio projects.

The Playlist pane 172 and more generally the Project Explorer 128 is programmed to allow well-known intuitive functionalities such as allowing deleting of objects by depressing the “Delete” key on the keyboard, etc.

It is reminded that the playlist may include containers, since containers may include containers.

The Playlist pane 172 is further configured to allow re-ordering the objects in the playlist. This is achieved, for example, by allowing conventional drag and drop of an object to a new position in the playlist.

Finally, the Playlist pane is configured to highlight the object being played as the playlist is played. Other means to notify the user which object is being played can also be provided, including for example a tag appearing next to the object.

Defining How Objects Within a Container are Played

Since both random and sequence containers consist of more than one object, the Property Editor 134 is further configured to allow specifying one of the following two play modes:
Step: to play only one object in the container each time the container is played;
Continuous: to play the complete list of objects in the container each time the container is played. This mode further allows looping the sounds and creating transitions between the various objects within the container.

The step mode is provided to play only one object within the container each time it is called. For example, it is appropriate to use the step mode each time a handgun is fired and only one sound is to be played or each time a character speaks to deliver one line of dialogue.

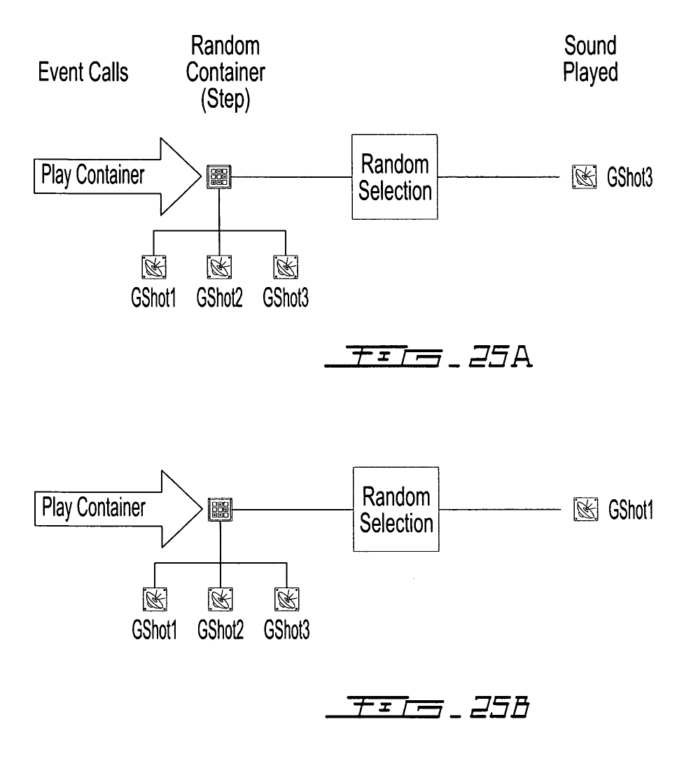

FIGS. 25A-25B illustrate another example of use of the step mode in a random container to play back a series of gun shot sounds.

The continuous mode is provided to play back all the objects within the container each time it is called. For example, the continuous mode can be used to simulate the sound of certain guns fired in sequence within a game.

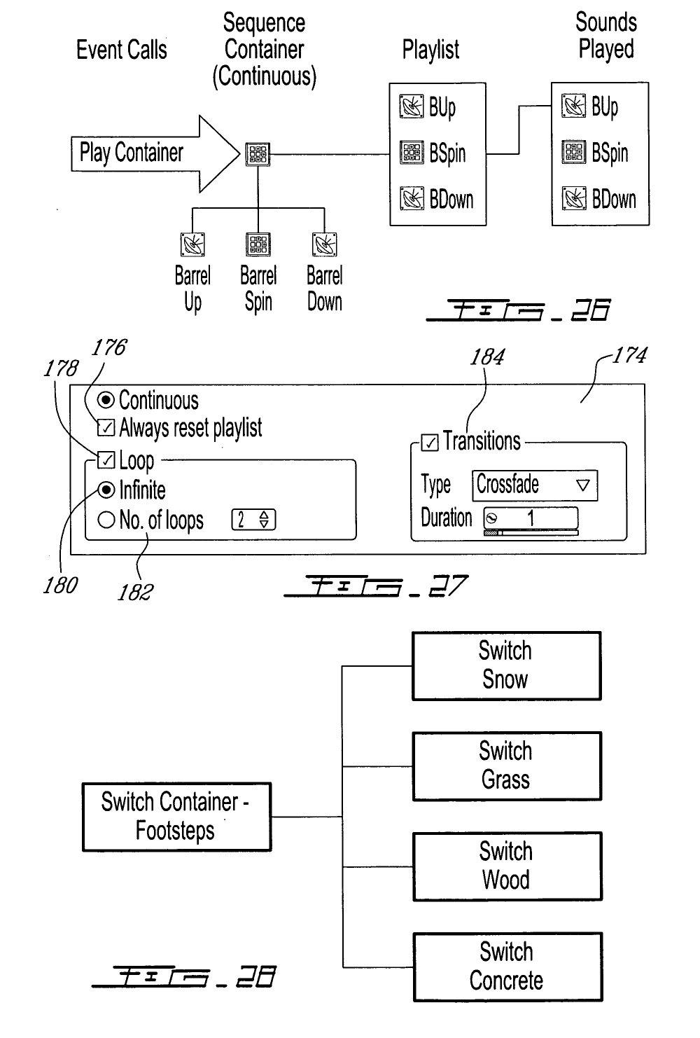

FIG. 26 illustrates an example of use of a sequence container played in continuous mode.

The Property Editor 134 is configured to allow the user to add looping and transitions between the objects when the Continuous playing mode is selected.

It is to be noted that when a random container is in the Continuous mode, since weighting can be applied to each object within the container, some objects may be repeated several times before the complete list has played once.

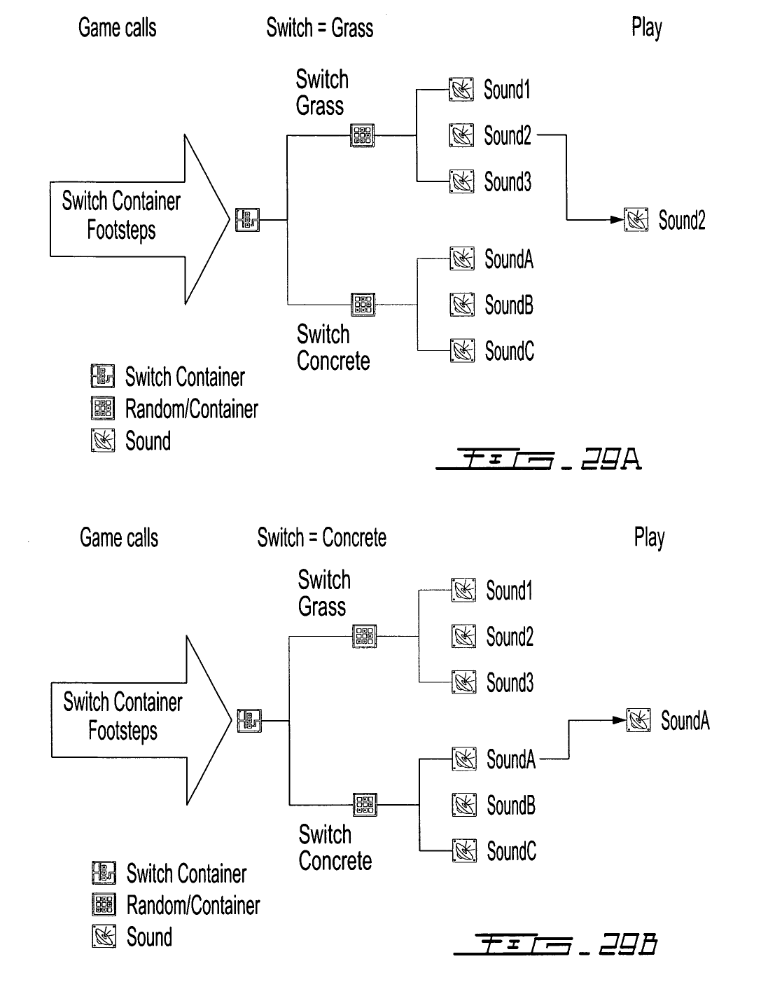

FIG. 27 illustrates an example of a “Continuous” interactive menu portion from the Property Editor 134 allowing a user to define the playing condition for objects in a continuous sequence or random container.

An “Always reset playlist” option and corresponding checkbox 176 are provided to return the playlist to the beginning each time a sequence container is played. A “Loop” option and corresponding checkbox 178 obviously allow looping the entire content of the playlist. While this option is selected, an “Infinite” option 180 is provided to specify that the container will be repeated indefinitely, while the “No. of Loops” option 182 is provided to specify a particular number of times that the container will be played. The “Transitions” option 184 allows selecting and applying a transition between the objects in the playlist. Examples of transitions which can be provided in a menu list include:
a crossfade between two objects;
a silence between two objects; and
a seamless transition with no latency between objects; and
a trigger rate which determines the rate at which new sounds within the container are played. This option can be used, for example, for simulating rapid gun fire.

As illustrated in FIG. 27, a Duration text box in the Transition portion of the GUI 174 is provided for the user to enter the length of time for the delay, trigger rate, or cross-fade.

The Property Editor 134 is further provided with user interface elements allowing the user to select the scope of the container. According to the first illustrative embodiment, the scope of a container can be either:
global: wherein all instances of the container used in the game are treated as one object so that repetition of sounds or voices across game objects is avoided; or
game object: wherein each instance of the container is treated as a separate entity, which means that no sharing of sounds occurs across game objects.

Indeed, since a same container can be used for several different game objects, the Property Editor 134 includes tools to specify whether all instances of the container used in the game should be treated as one object or each instance should be treated independently.

It is to be noted that the Authoring tool is so configured that the Scope option is not available for sequence containers in Continous play mode since the entire playlist is played each time an event triggers the container.

The following example illustrates the use of the Scope option. It involves a first person role-playing game including ten guards that all share the same thirty pieces of dialogue. In this case, the thirty Sound Voice objects can be grouped into a random container that is set to Shuffle and Step. The Authoring tool allows using this same container for all ten guards and setting the scope of the container to Global to avoid any chance that the different guards may repeat the same piece of dialogue. This concept can be applied to any container that is shared across objects in a game or in another computer application for which the media files are being authored.

Switch Containers

Switch containers are provided to group sounds according to different alternatives existing within the game. More specifically, they contain a series of switches or states or Real-time Parameter Controls (RTPC) that correspond to changes or alternative actions that occur in the game. For example, a switch container for footstep sounds might contain switches for grass, concrete, wood and any other surface that a character can walk on in game (see FIG. 28).

Switches, states and RTPCs will be referred to generally as game syncs. Game syncs are included in the Authoring tool to streamline and handle the audio shifts that are part of the game. Here is a summary description of what each of these three game syncs are provided to handle:
States: a change that affects the audio properties on a global scale;
Switches: a change in the game action or environment that requires a completely new sound;
RTPCs: game parameters mapped to audio properties so that when the game parameters change, the mapped audio properties will also reflect the change.

The icons illustrated in the following table are used both to facilitate the reference in the present description and also to help a user navigate in the Audio Tab of the Project Explorer.

TABLE 3

| Icon | Represents |
|---|---|
| [symbol] | State |
| [symbol] | Switch |
| [symbol] | RTPC |

Each of these three game syncs will now be described in further detail.

Each switch/state includes the audio objects related to that particular alternative. For example, all the footstep sounds on concrete would be grouped into the “Concrete” switch; all the footstep sounds on wood would be grouped into the “Wood” switch, and so on. When the game calls the switch container, the sound engine verifies which switch/state is currently active to determine which container or sound to play.

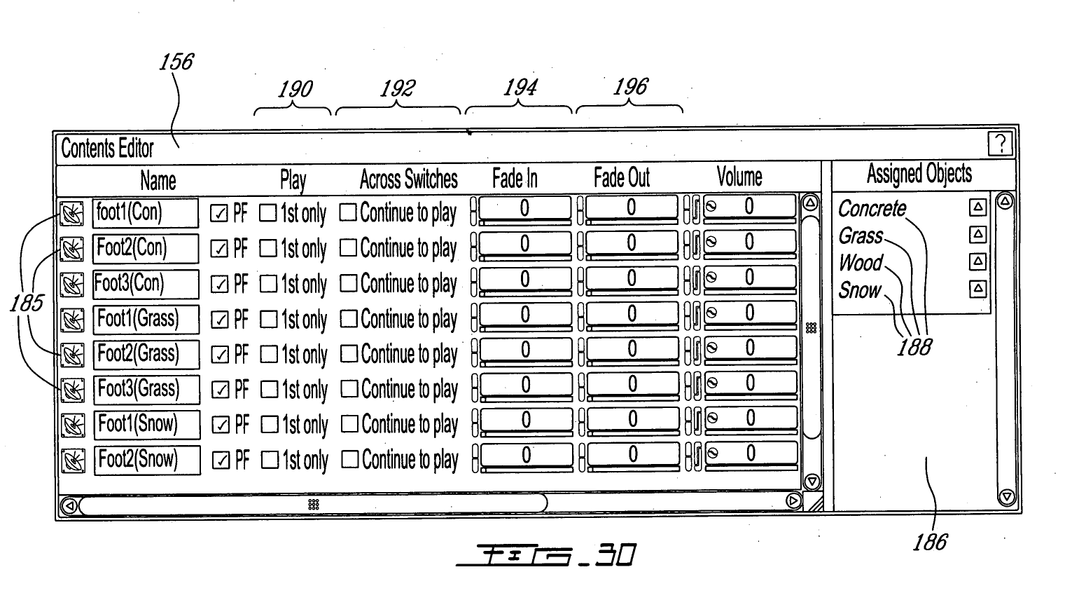

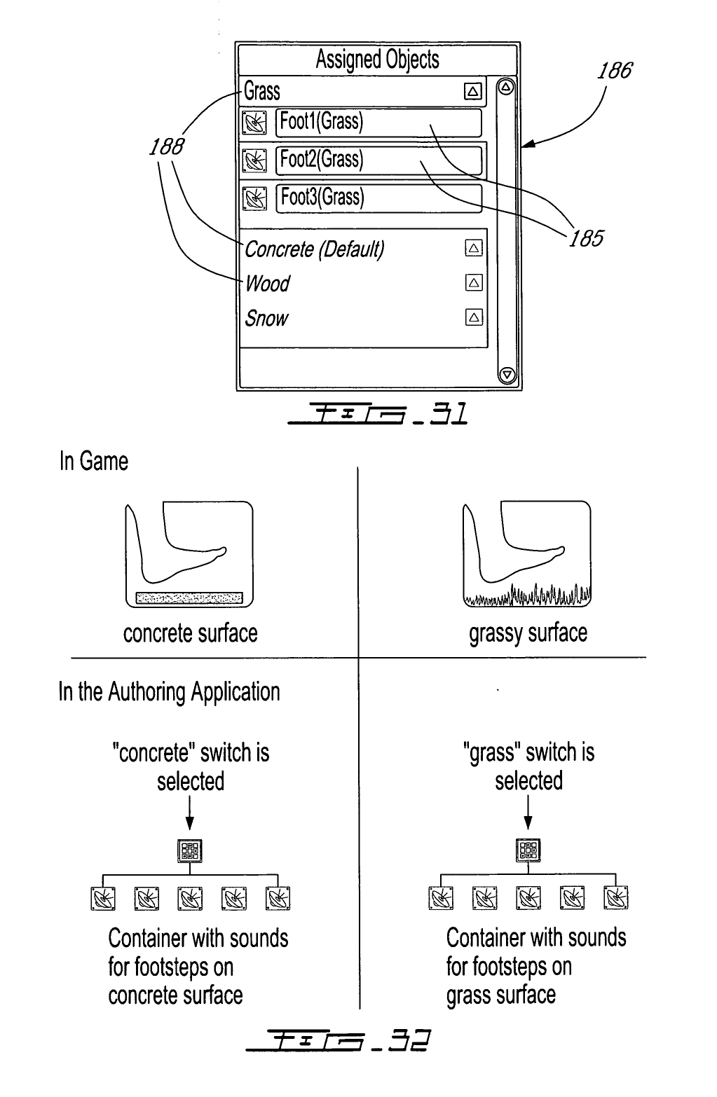

FIGS. 29A-29B illustrate what happens when an event calls a switch container called “Footsteps”. This container has grouped the sounds according to the different surfaces a character can walk on in game. In this example, there are two switches: Grass and Concrete. When the event calls the switch container, the character is walking on grass (Switch=Grass), so the footstep sounds on grass are played. A random container is used to group the footstep sounds within the switch so that a different sound is played each time the character steps on the same surface.

The Property Editor 134 includes a Switch type GUI element (not shown), in the form for example, of a group box, to allow a user selecting whether the switch container will be based on states or switches. The Property Editor 134 further includes a GUI element (not shown) for assigning a switch, state group or RTPC to the container. Of course, this switch, state group or RTPC has been previously created as will be described furtherin.

The Property Editor 134 is configured so that when a switch container is loaded thereinto, its child objects 185 are displayed in the Contents Editor 156 (see FIG. 30). The Contents Editor 156 further includes a list of behaviours for each of the objects nested in the container. These behaviours are modifiable using GUI elements as described hereinabove. The Contents Editor 156 further includes an “Assigned Objects” window pane 186 including switches 188 within a selected group. The objects 185 can be assigned to these switches 188 so as to define the behaviour for the objects when the game calls the specific switch.

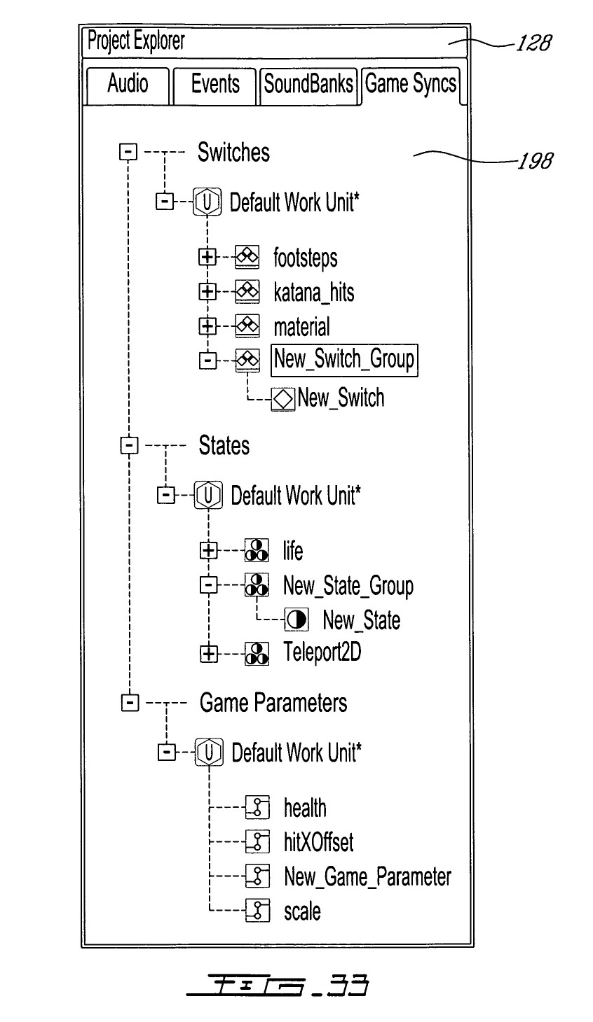

As illustrated in FIG. 31, the Assigned Objects pane 186 of the Contents Editor is configured to add and remove objects 185 therein and assign these objects 185 to a selected switch. More specifically, conventional drag and drop functionalities are provided to assign, de-assign and move an object 185 to a pre-determined switch 188. Other GUI means can of course be used.

With reference to FIG. 30, the Contents Editor 156 is configured to allow a user to determine the playback behaviour for each object within the container since switches and states can change frequently within a game. More specifically, the following playback behaviours can be set through the Contents Editor 156 using respective GUI elements:
Play: determines whether an object 185 will play each time the switch container is triggered or just when a change in switch/state occurs;
Across Switches: determines whether an object 185 that is in more than one switch will continue to play when a new switch/state is triggered;
Fade In: determines whether there will be a fade in to the new sound when a new switch/state is triggered; and
Fade Out: determines whether there will be a fade out from the existing sound when a new switch/state is triggered.

The switch container is configured with the “step” and “continuous” play mode which has been described herein with reference to sequence containers for example.

Since switches and states syncs share common characteristics, the GUI of the Contents Editor 156 is very similar in both cases. For such reason, the GUI of the Contents Editor 156 when it is invoked for States will not be described hereinbelow in more detail.

Switch

The concept of switches will now be described in further detail.

As mentioned hereinabove, switches are provided to represent various changes that occur for a game object. In other words, sounds are organized and assigned to switches so that the appropriate sounds will play when the changes take place in the game.

Returning to the surface switch example began with reference to FIGS. 28, 29A and 29B, one can create a switch called “concrete” and assign a container with footstep sounds that match the concrete surface to this switch. Switches for grass, gravel and so on can also be created and corresponding sounds assigned to these switches.

In operation, the sounds and containers that are assigned to a switch are grouped into a switch container. When an event signals a change in sounds, the switch container verifies the switch and the correct sound is played. As will be described hereinbelow in more detail, RTPCs can be used instead of events to drive switch changes.

With reference to FIGS. 29A-29B and 32, when the main character of a game is walking on a concrete surface for example, the “concrete” switch and its corresponding sounds are selected to play, and then if the character moves from concrete to grass, the “grass” switch is called by the sound engine.

Before being used in a switch container, switches are first grouped in switch groups. Switch groups contain related segment in a game based on the game design. For example, a switch group called “Ground Surfaces” can be created for the “grass” and “concrete” switches illustrated in FIGS. 29 and 32 for example.

The icons illustrated in the following table are used both to facilitate the reference in the present description and also to help a user navigate in the Audio Tab of the Project Explorer.

TABLE 4

| Icon | Represents |
|---|---|
| [symbol] | Switch |
| [symbol] | Switch group |

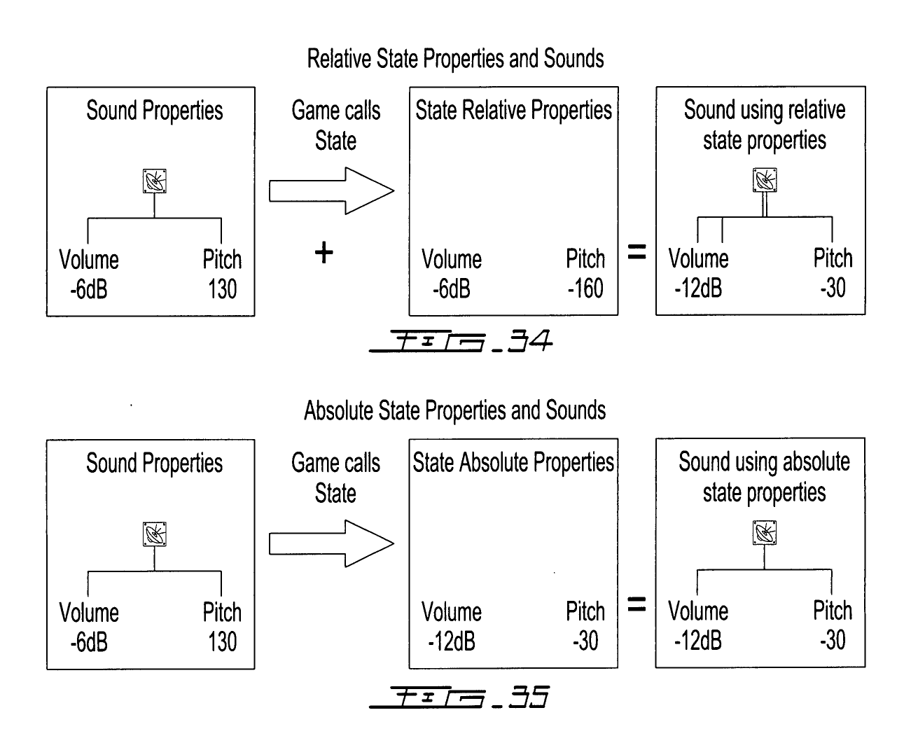

As illustrated in FIG. 33, the Project Explorer 128 includes a Game Syncs tab 198 similar to the Audio tab 130 which allows creating and managing the switch groups, including renaming and deleting a group. As can be seen in the upper portion of FIG. 33, the Game Syncs tab includes a Switches manager including, for each work unit created for the project, the list of switch groups displayed in an expandable tree view and for each switch group, the list of nested switches displayed in an expandable tree view.

The Project Explorer 128 is configured to allow creating, renaming and deleting switches within the selected groups. Conventional pop up menus and functionalities are provided for these purposes.

States

States are provided in the Authoring tool to apply global property changes for objects in response to game conditions. Using a state allows altering the properties on a global scale so that all objects that subscribe to the state are affected in the same way. As will become more apparent upon reading the following description, using states allows creating different property kits for a sound without adding to memory or disk space usage. By altering the property of sounds already playing, states allow reusing assets and saving valuable memory.

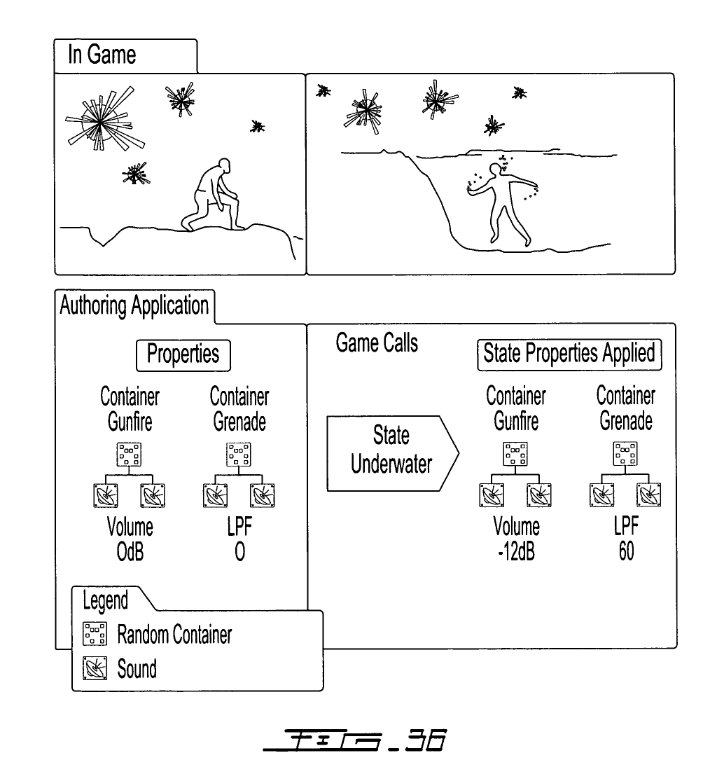

A state property can be defined as absolute or relative. As illustrated in FIG. 34, and similarly to what has been described hereinabove, applying a state whose properties are defined as relative causes the effect on the object's properties to be cumulative.

Applying a state whose properties are defined as absolute causes the object's properties to be ignored and the state properties will be used.

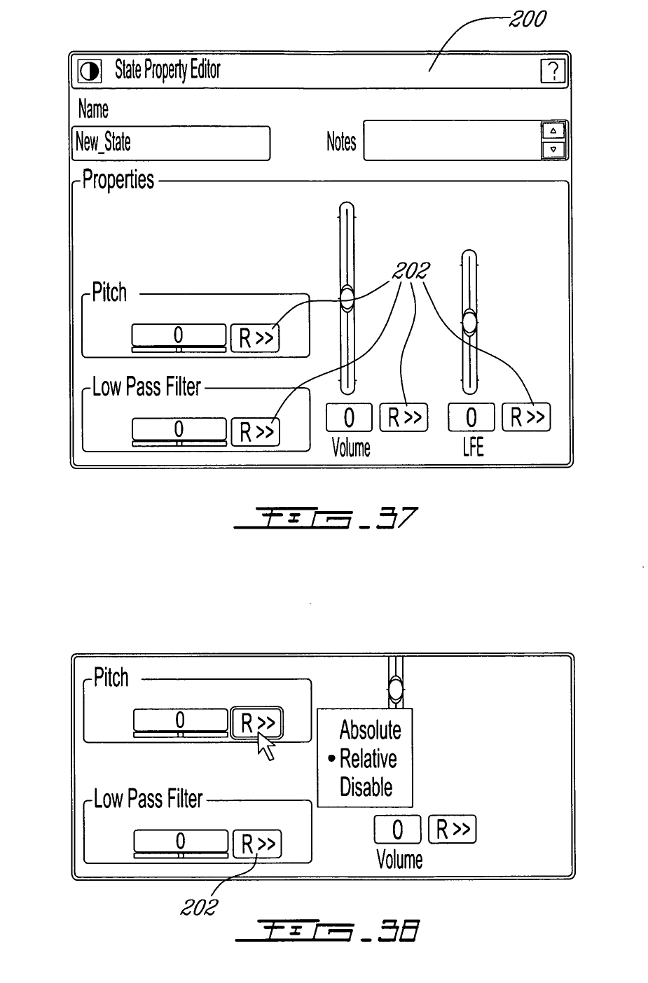

An example illustrating the use of states is shown in FIG. 36. This example concerns the simulation of the sound treatment that occurs when a character goes underwater in a video game. In this case, a state can be used to modify the volume and low pass filter for sounds that are already playing. These property changes create the sound shift needed to recreate how gunfire or exploding grenade should sound when the character is under water.

Similarly to switches, before being usable in a project, states can first be grouped in state groups. For example, after a state group called Main Character has been created, states can be added that will be applied to the properties for the objects associated with the Main Character. From the game, it is for example known that the main character will probably experience the following states: stunned, calm, high stress. So it would be useful to group these together.

The icons illustrated in the following table are used both to facilitate the reference in the present description and also to help a user navigate in the Audio Tab 130 of the Project Explorer 128.

TABLE 5

| Icon | Represents |
|---|---|
| [symbol] | State |
| [symbol] | State group |

Since the GUI elements and tools provided with the Authoring Tool and more specifically with the Property Editor 134 for managing the states are very similar than those provided to manage the switches and which have been described hereinabove, only the differences between the two sets of GUI elements and tools will be described furtherin.

Since a state is called by the game to apply global property changes for objects in response to game conditions, the Project Explorer 128 is configured to allow editing property settings for states as well as information about how the states will shift from one to another in the game. The process of creating a new state therefore includes the following steps non-restrictive steps:
creating a state;
editing the properties of a state; and
defining transitions between states.

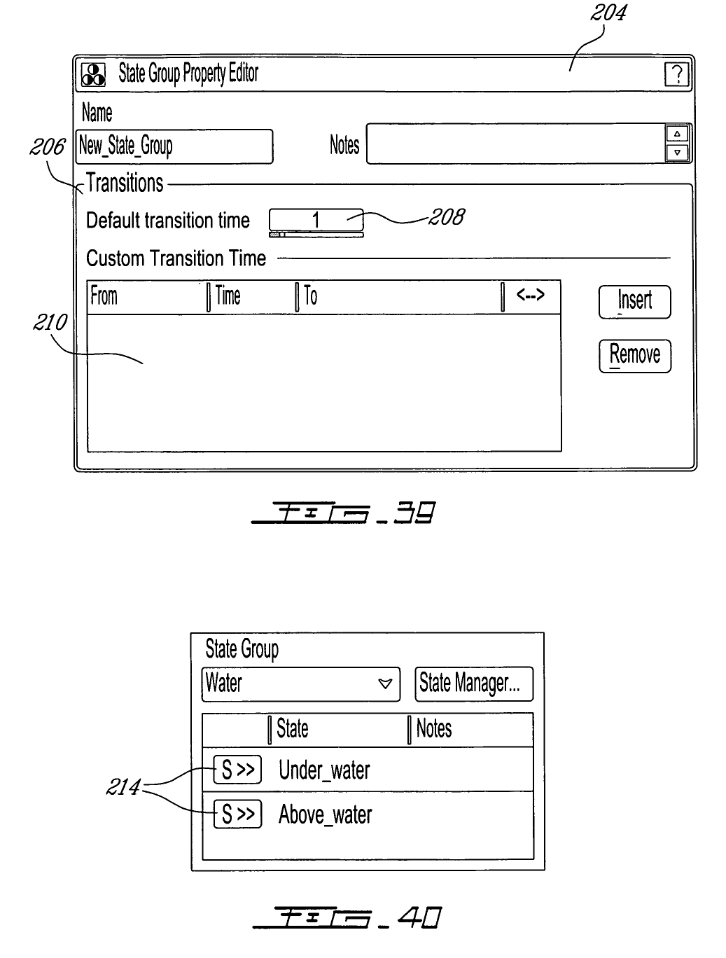

The Authoring Tool includes a State Property Editor including a Stated Property Editor GUI 200 to define the properties that will be applied when the state is triggered by the game. For each state, the following properties can be modified: pitch, low pass filter (LPF), volume, and low frequency effects and corresponding GUI elements are provided in the State Property Editor GUI 200. The State Property Editor 200 is illustrated in FIG. 37. The State Property Editor Includes user interface elements similar to those provided in the Property Editor 134 for the corresponding properties.

In addition, the State Property Editor 200 allows setting how the state properties will interact with the properties already set for the object. Indeed, as can be better seen in FIG. 38, each GUI element provided to input the value of a respective state property is accompanied by an adjacent interaction GUI element 202 allowing the user to set the interaction between the objects properties and the state properties. One of the following three options is available:
Absolute: to define an absolute property value that will override the existing object property value;
Relative: to define a relative property value that will be added to the existing properties for the object;
Disable: to use the existing property set for the object. This option enables the property controls, but disables the property controls in the States editor.

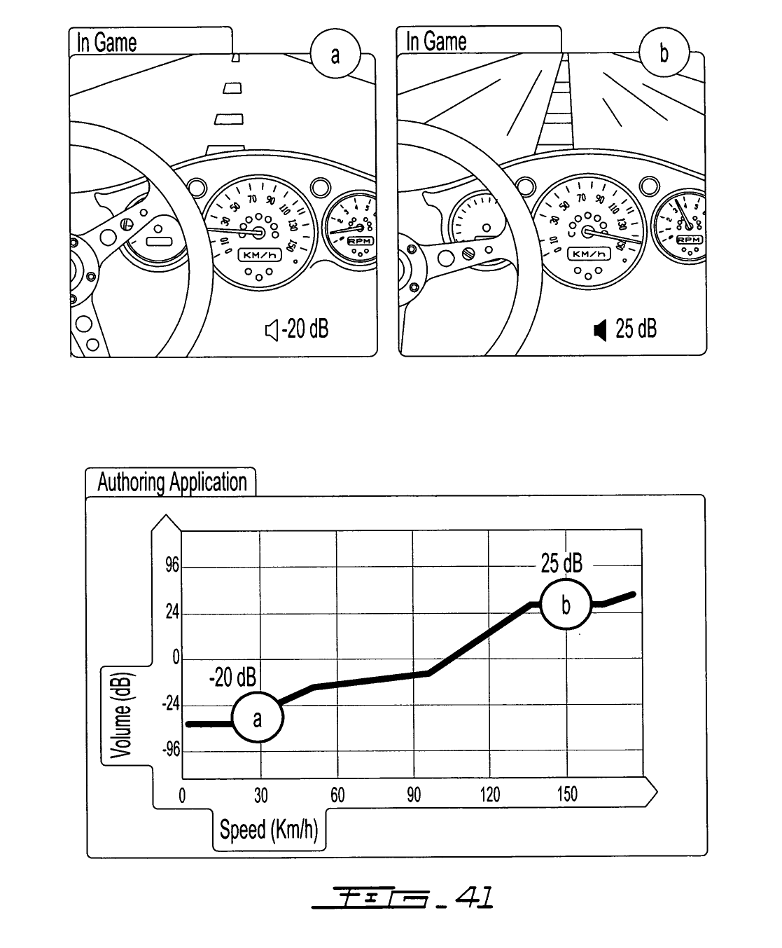

The Authoring Tool is further provided with a State Group Property Editor 204 to allow setting transitions between states. Indeed, a consequence of providing states in the game is that there will be changes from one state to another. Providing transitions between states allows means to prevent these changes from being abrupt. To provide smooth transitions between states, the State Group Property Editor 204, which is illustrated in FIG. 39, provides a GUI allowing defining the elapsed time between state changes. More specifically, a Transition Time tab 206 is provided to set such time. Other parameters can be used to define transitions between states.

In the Transition Time tab 206, a Default Transition Time 208 is provided to set the same transition time between states for all states in a state group.

A Custom Transition Time window 210 is provided to define different transition times between states in a state group.

After states have been created, they can be assigned to objects from the hierarchy. The first step is to choose a state group. The Authoring Tool according to the first illustrative embodiment is configured so that by default all states within that state group are automatically assigned to the object and so that the properties for each individual state can then be altered. States can also be assigned to control busses in the Master-Mixer hierarchy.

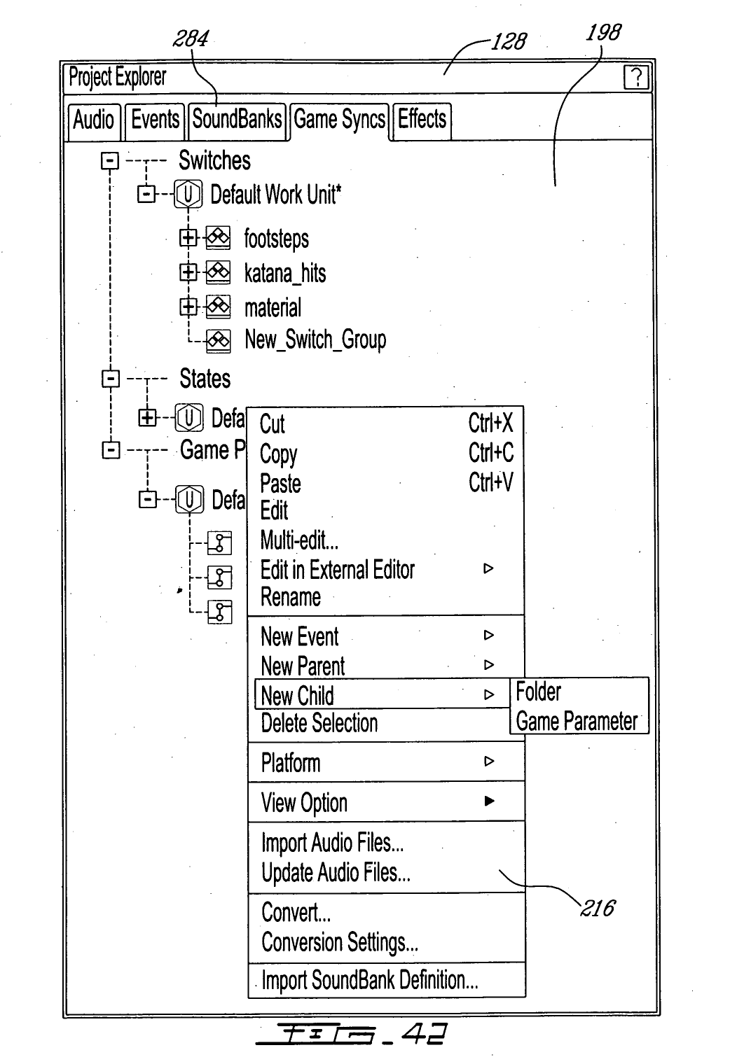

A portion of the States tab 212 (see FIG. 16B) of the Property Editor 134 is illustrated in FIG. 40. This tab is provided with a list of state groups 214 from which a user may select a state group 214 to assign to the object currently loaded in the Property editor 134.

After a state group has been assigned to an object, the properties of its individual states can be customized as described hereinabove.

According to another embodiment, for example when the method and system are used to author media content for another computer application, the state is called by the computer application to apply global property changes for objects in response to any conditions or variations in the computer application.

RTPCs

Real-time Parameter Controls (RTPCs) are provided to edit specific sound properties in real time based on real-time parameter value changes that occur within the game. RTPCs allow mapping the game parameters to property values, and automating property changes in view of enhancing the realism of the game audio.

For example, using the RTPCs for a racing game allows editing the pitch and the level of a car's engine sounds based on the speed and RPM values of an in-game car. As the car accelerates, the mapped property values for pitch and volume react based on how they have been mapped. The parameter values can be displayed, for example, in a graph view, where one axis represents the property values in the project and the other axis represents the in-game parameter values.

The Authoring Tool is configured so that the project RTPC values can be assigned either absolute values, wherein the values determined for the RTPC property will be used and ignore the object's properties, or relative values, wherein the values determined for the RTPC property will be added to the object's properties. This setting is predefined for each property.

FIG. 41 illustrates how the volume can be affected by the speed of the racing car in a game, based on how it is mapped in the project.

The Property Editor 134 is provided to map audio properties to already created game parameters. As can be seen from FIG. 16A, the already discussed Game syncs tab of the Property Editor 134 includes a RTPC manager section provided with a graph view for assigning these game parameters and their respective values to property values.

The RTPC manager allows to:
create a game parameter;
edit a game parameter;
delete a game parameter.

Creating a game parameter involves adding a new parameter (including naming the parameter) and defining the minimum and maximum values for that parameter. A new parameter can be created through the Game Syncs tab 198 of the Project Explorer 128 where a conventional shortcut menu 216 associated to the Game Parameters tree section includes an option for that purpose. Input boxes are provided for example in a Game Parameter Property Editor (not shown) to set the range values for the parameter.

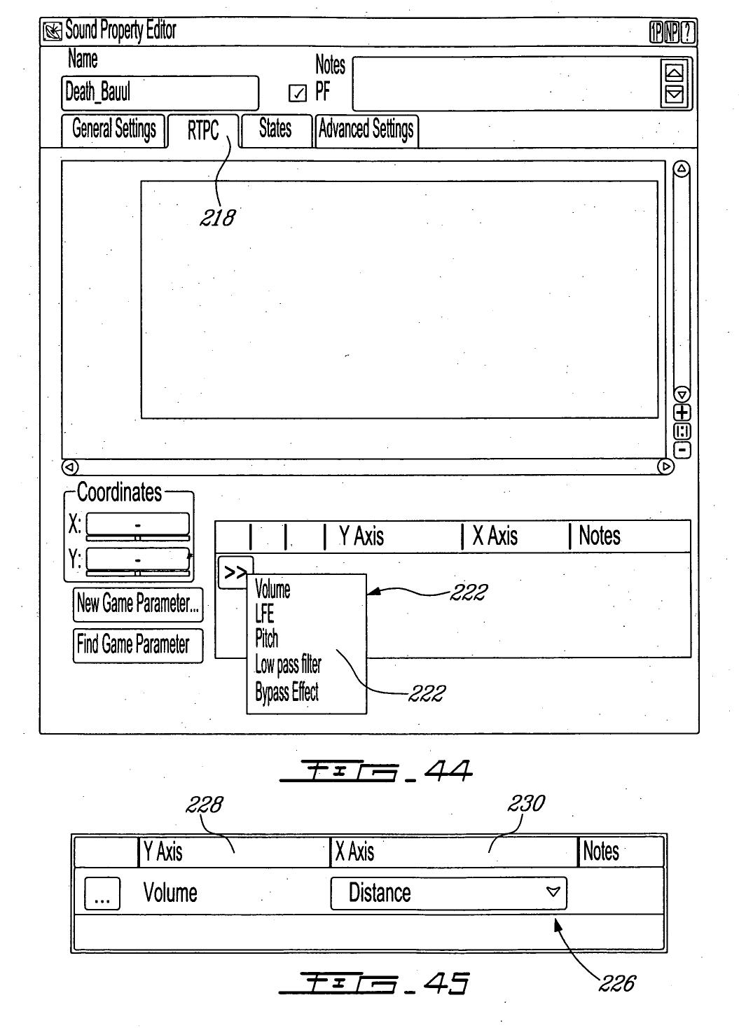

A graph view 220 is provided in the RTPC tab 218 of the Property Editor 134 to edit real-time parameter value changes which will affect specified game sound properties in real time. One axis of the graph view represents the property values in the project and the other axis represents the in-game parameter values. An example of a graph view is illustrated in FIG. 43.

The RTPCs for each object or control bus are defined on the RTPC tab 218 of the Property Editor 134.

An example of use of RTPCs to base the volume of the character's footstep sounds on the speed of the character in game will now be provided with reference to a first shooter game. For example, when the character walks very slowly, it is desirable according to this example that the footstep sounds be very soft and that when the character is running, that the sounds be louder. In this case, RTPCs can be used to assign the game parameter (speed) to the project property (volume). Then the graph view can be used to map the volume levels of the footstep sounds to the speed of the character as it changes in game.

RTPCs can also be used to achieve other effects in a game, such as mapping low pass filter values to water depth, low frequency effect values to the force of an explosion, and so on.

The RTPC tab 218 of the Property Editor is configured to allow assigning object properties to game parameters. A RTPC property dialog box 222 (see FIG. 44) includes a list of properties 224 that can be selected.

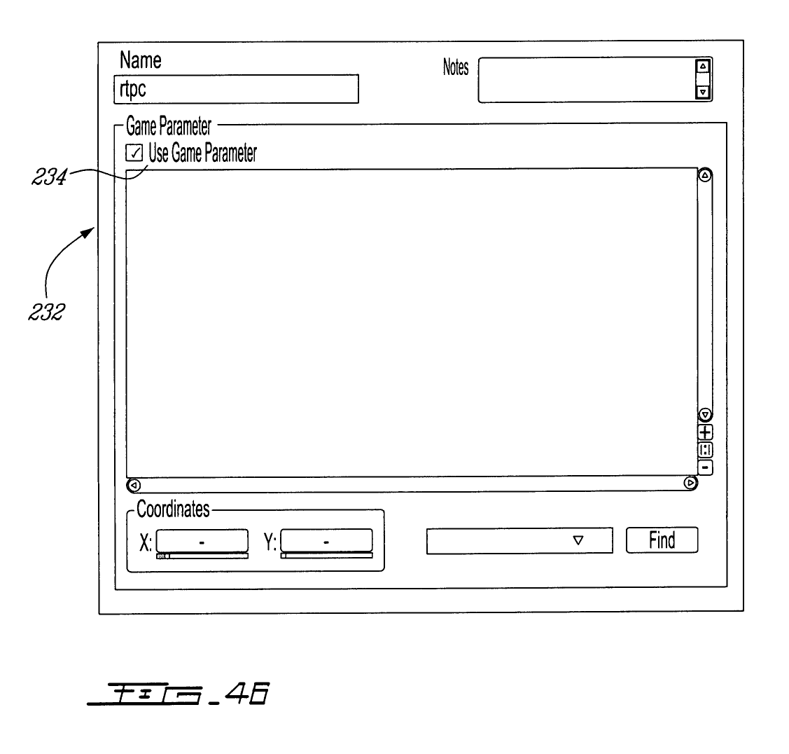

The selected property is added to the RTPC list 226 in the RTPC tab 198 from the Property Editor 134 (see FIG. 45) and is assigned to the Y axis in the graph view 220 (FIG. 43).

The RTPC tab further includes an X axis list 230 associated to the Y axis list 228 as illustrated in FIG. 45, from which the user can select the game parameter to assign to the property.

After the X and Y axes are defined by the game parameter and the property, the Graph view 220 can be used to define the relationship between the two values. More specifically, property values can be mapped to game parameter values using control points. For example, to set the volume of the sound at 50 dB when the car is traveling at 100 km/h, a control point can be added at the intersection of 100 km/h and 50 dB.

Conventional editing tools are provided for zooming and panning the graph view 220, adding, moving, and deleting controls points thereon.

The RTPC list 226 in the RTPC tab 198 is editable so that RTPCs can be deleted.

The Authoring Tool according to the first illustrative embodiment further allows managing switch changes by mapping switches to game parameter values. After the switch groups and the game parameters have been created as described hereinabove, they can be mapped so that the game parameter values can trigger switch changes.

For example, RTPCs can be used to drive switch changes in a car collision so that the sounds of impact differ depending on the intensity of the impact based on the impact force. Using the impact force values to trigger switch changes, allows ensuring that the correct sounds play when the collision occurs.

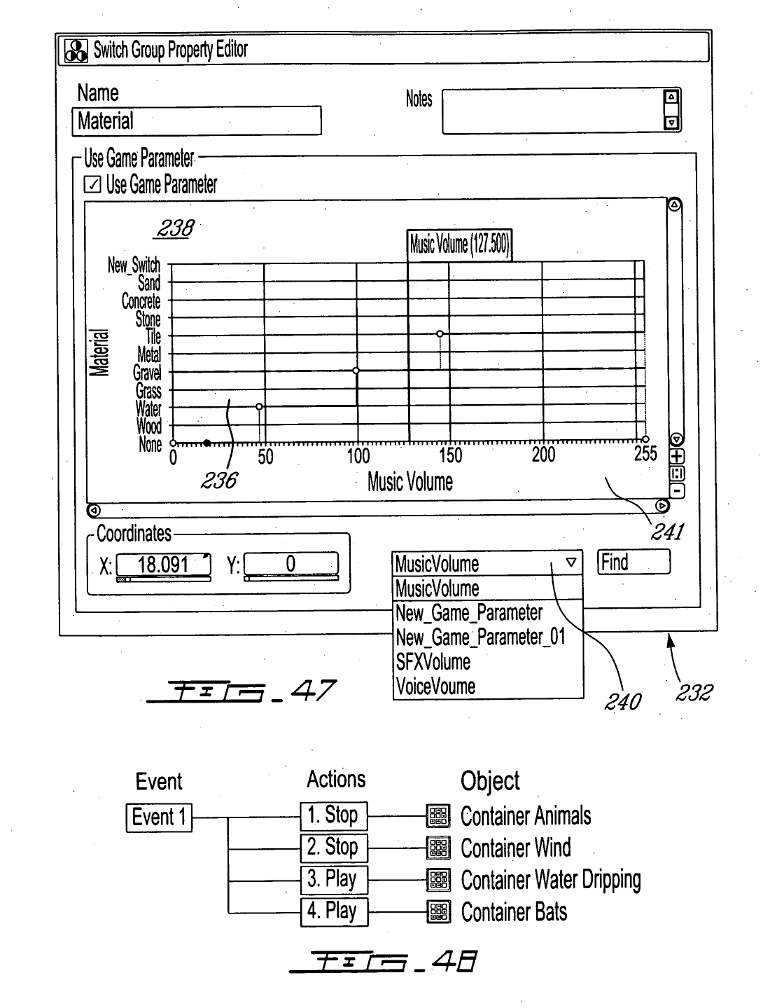

FIG. 46 illustrates a Switch Group Property Editor user interface 232 available, for example, through the Game Syncs tab 198 of the Project Explorer 128. The Switch Group Property Editor user interface 232 includes a user interface element in the form of a “Use Game Parameter” check box 234 to enable a graph view 236 in the Switch Group Property Editor 232 (see FIG. 47).

As can be seen in FIG. 47, a list of the switches included in the current switch group (‘Material’ in the illustrated example) is displayed along the Y axis.

A game parameter list 240 is provided to allow the user selecting the game parameter 241 to drive the switch change.

Points can be added on the graph similarly to what has been described hereinabove with reference to RTPCs game parameter mapping. This allows mapping the switch change to specified game parameter values. Similar graph editing functionalities can also be provided.

Events

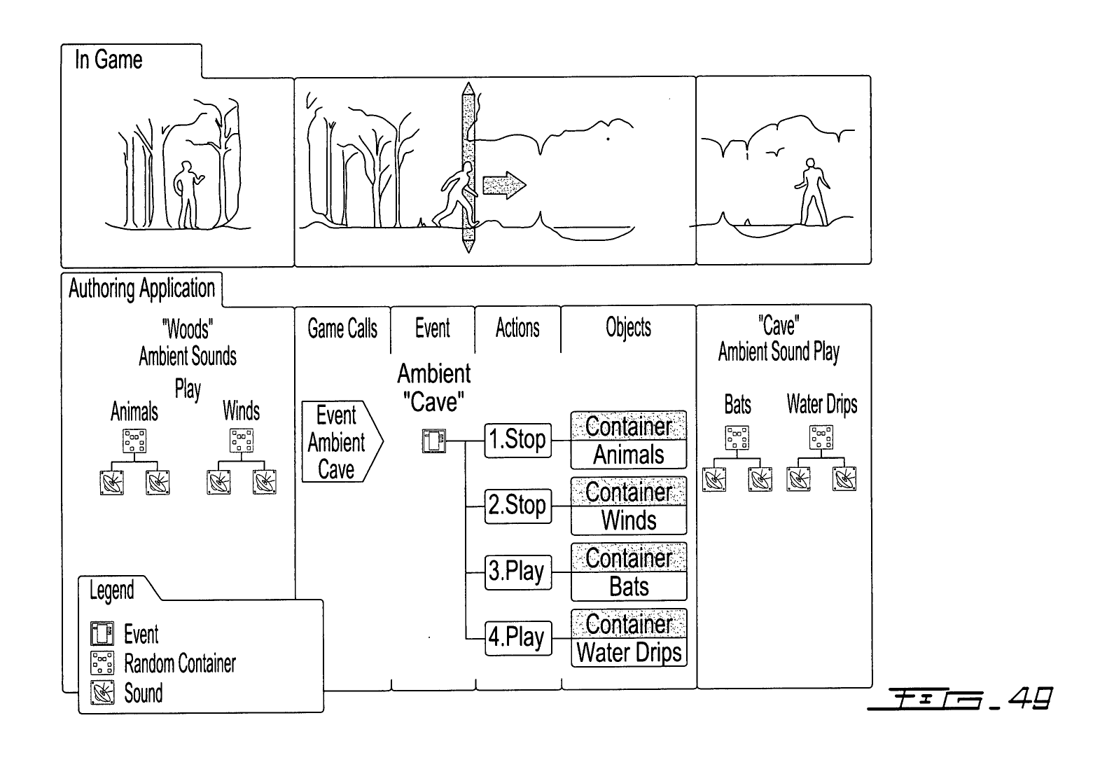

The Authoring Tool is configured to include Events to drive the sound in-game. Each event can have one or more actions or other events that are applied to the different sound structures within the project hierarchy to determine whether the objects will play, pause, stop, etc (see FIG. 48).

After the events are created, they can be integrated into the game engine so that they are called at the appropriate times in the game.

Events can be integrated into the game even before all the sound objects are available. For example, a simple event with just one action such as play can be integrated into a game. The event can then be modified and objects can be assigned and modified without any additional integration procedures required.

The icon illustrated in the following table is used both to facilitate the reference in the present description and also to help a user navigate in the Event Tab of the Project Explorer.

TABLE 6

| Icon | Represents |
|---|---|
| [symbol] | Event |

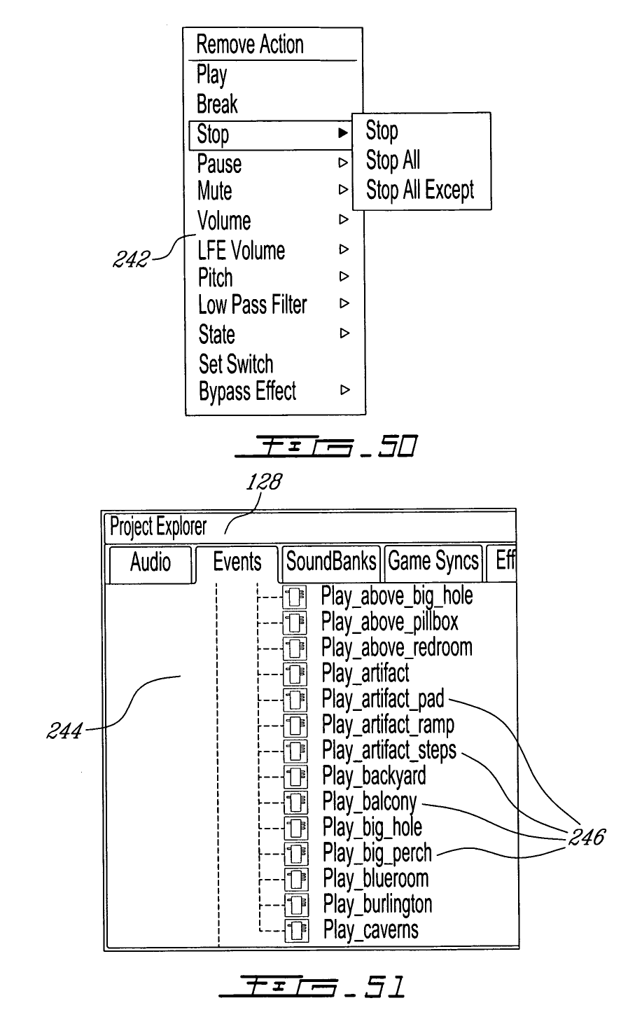

An example of use of events will now be provided with reference to FIG. 49 which concerns a first person role-playing game. According to this game, the character will enter a cave from the woods in one level of the game. Events are used to change the ambient sounds at the moment the character enters the cave. At the beginning of the project, an event is created using temporary or placeholder sounds. The event contains a series of actions that will stop the ambient “Woods” sounds and play the ambient “Cave” sounds. After the event is created, it is integrated into the game so that it will be triggered at the appropriate moment. Since no additional programming is required after the initial integration, different sounds can be experimented with, actions can be added and removed, and action properties can be changed until it sounds as desired.

A variety of actions are provided to drive the sound in-game. The actions are grouped by category and each category contains a series of actions that can be selected.

Each action also has a set of properties that can be used to fade in and fade out incoming and outgoing sounds as well as add delays and other properties. The following table describes examples of event actions that can be assigned to an Event in the Events Editor 246, using for example the shortcut menu 242 shown in FIG. 50:

TABLE 7

| Event Action | Description |
|---|---|
| Play | Plays back the associated object. |
| Break | Breaks the loop of a sound or the continuity of a |
| | container set to continuous without stopping the |
| | sound that is currently playing. |
| Stop | Stops playback of the associated object. |
| Stop All | Stops playback of all objects. |
| Stop All Except | Stops playback of all objects except those |
| | specified. |
| Mute | Silences the associated object. |
| Unmute | Returns the associated object to its original |
| | “pre-silenced” volume level. |
| Unmute All | Returns all objects to their original “pre- |
| | silenced” volume levels. |
| Unmute All Except | Returns all objects, except those specified, to |
| | their original “pre-silenced” volume levels. |
| Pause | Pauses playback of the associated object. |
| Pause All | Pauses playback of all objects. |
| Pause All Except | Pauses playback of all objects except those |
| | specified. |
| Resume | Resumes playback of the associated object that |
| | had previously been paused. |
| Resume All | Resumes playback of all paused objects. |
| Resume All Except | Resumes playback of all paused objects, |
| | except those specified. |
| Set Volume | Changes the volume level of the associated |
| | object. |
| Reset Volume | Returns the volume of the associated object to |
| | its original level. |
| Reset Volume All | Returns the volume of all objects to their |
| | original levels. |
| Reset Volume All | Returns the volume of all objects, except those |
| Except | specified, to their original levels. |
| Set LFE Volume | Changes the LFE volume level of the |
| | associated object. |
| Reset LFE Volume | Returns the LFE volume of the associated |
| | object to its original level. |
| Reset LFE Volume All | Returns the LFE volume of all objects to their |
| | original levels. |
| Reset LFE Volume | Returns the LFE volume of all objects, except |
| All Except | those specified, to their original levels. |
| Set Pitch | Changes the pitch for the associated object. |
| Reset Pitch | Returns the pitch of the associated object to its |
| | original value. |
| Reset Pitch All | Returns the pitch of all objects to their original |
| | values. |
| Reset Pitch All Except | Returns the pitch of all objects, except those |
| | specified, to their original values. |
| Set LPF | Changes the amount of low pass filter applied |
| | to the associated object. |
| Reset LPF | Returns the amount of low pass filter applied to |
| | the associated object to its original value. |
| Reset LPF All | Returns the amount of low pass filter applied to |
| | all objects to their original values. |
| Reset LPF All Except | Returns the amount of low pass filter applied to |
| | all objects, except the ones that are specified, |
| | to their original values. |
| Set State | Activates a specific state. |
| | Note: There is no associated object with the Set |
| | State action because it applies to all objects |
| | that subscribe to the current state. |
| Enable State | Re-enables a state for the associated object. |
| Disable State | Disables the state for the associated object. |
| Set Switch | Activates a specific switch. |
| | Note: There is no associated object with the |
| | Switch action. |
| Enable Bypass | Bypasses the effect applied to the associated |
| | object. |
| Disable Bypass | Removes the effect bypass which re-applies the |
| | effect to the associated object. |
| Reset Bypass Effect | Returns the bypass effect option of the |
| | associated object to its original setting. |
| Reset Bypass Effect | Returns the bypass effect option of all objects to |
| All | their original settings. |
| Reset Bypass Effect | Returns the bypass effect option of all objects, |
| All Except | except the ones that you specified, to their |
| | original settings. |

The event creation process involves the following steps:
creating a new event;
adding actions to the created event;
assigning objects to event actions;
defining the scope of an event action; and
setting properties for the event action.

To provide additional control and flexibility, the Authoring Tool is configured so that events can perform one action or a series of actions.

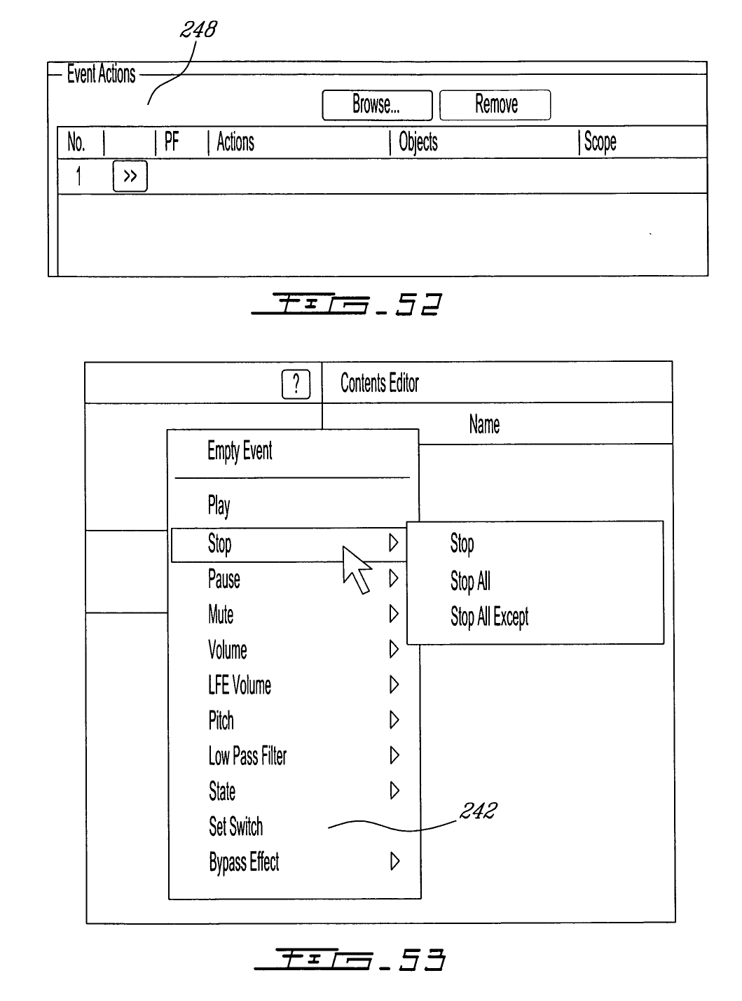

The Project Explorer 128 is provided with an Events tab 244 including GUI elements for the creation and management of events. An example of the Events tab 244 is illustrated in FIG. 51.

The Events tab 244 displays all the events 246 created in a project. Each event 246 is displayed for example alphabetically under its parent folder or work unit. The Events tab 244 is provided to manage events, including without restrictions: adding events, organizing events into folders and work units, and cut and pasting events.

To help discriminate works on the same project between teams, the Events tab 244 allows assigning events to different work units so that each member of the team can work on different events simultaneously.

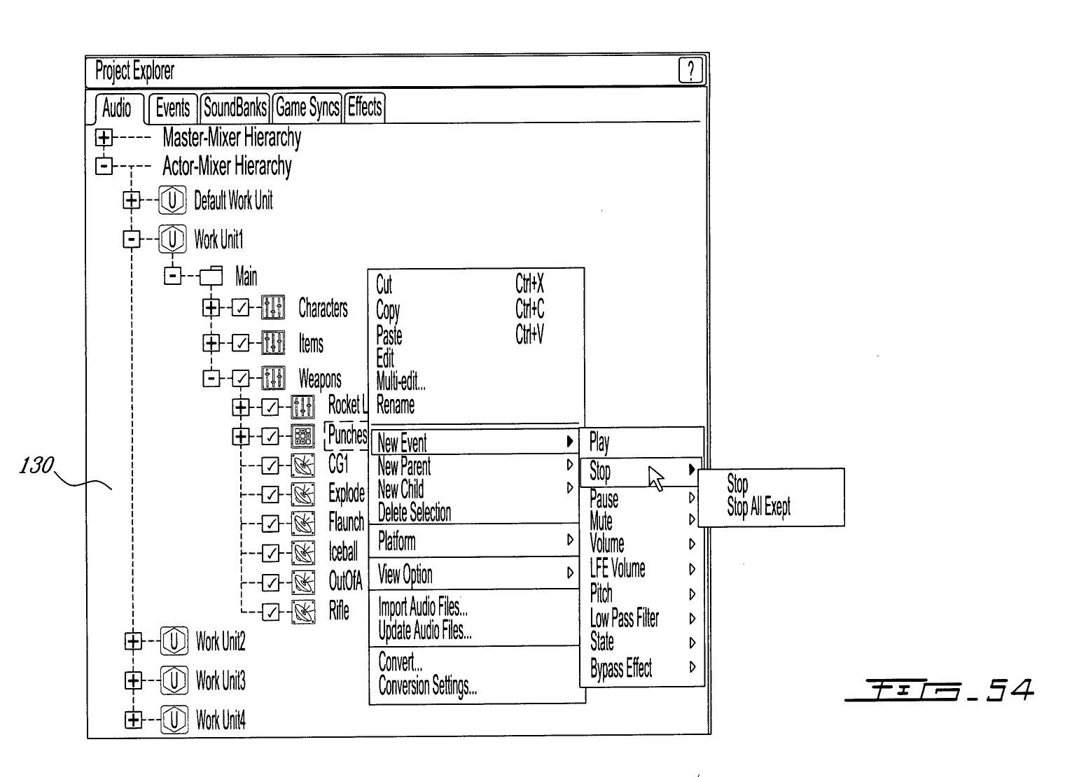

Turning now briefly to FIG. 55, an Event Editor GUI 246 is provided in the Event tab 244 as a further means to create events. As can be better seen from FIG. 52, the Event Editor 246 further includes an Event Actions portion 248 in the form of a field listing events created, and for each event created including a display menu button (>>) to access the event action list 242 described hereinabove, including a submenu for some of the actions listed (see also FIG. 53). The Event Editor 246 is advantageously configured so that when an event is loaded therein, the objects associated with the event are simultaneously displayed in the Contents Editor 156 so that properties for these objects can be edited.

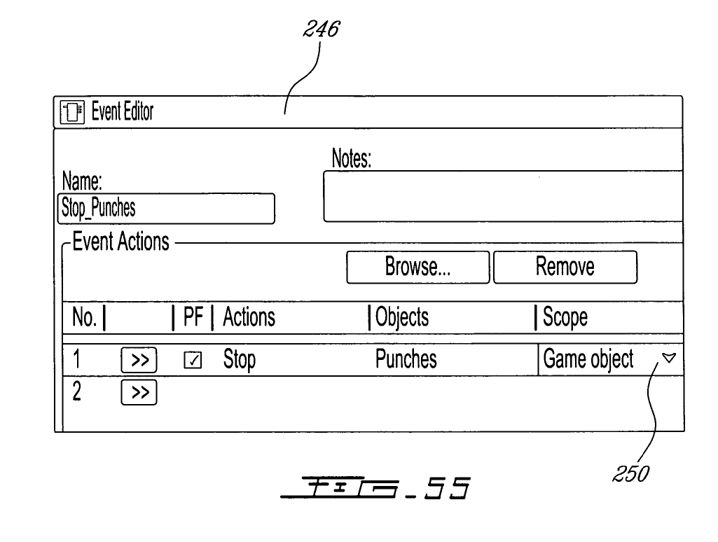

FIG. 54 shows that the Audio tab 130 of the Project Explorer 128 is also configured to create events. The Audio tab 130 is more specifically configured so that a GUI menu similar to the one illustrated in FIG. 53 is accessible from each object in the object hierarchy allowing to create an event in the Event Editor 246 and associate the selected object to the event (see FIG. 55).

The Event Editor 246 is further provided to define the scope for each action. The scope specifies the extent to which the action is applied to objects within the game. More specifically, the Event Editor 246 includes a Scope list 250 to select whether to apply the event action to the game object that triggered the event or to apply the event action to all game objects.

Moreover, each event action is characterized by a set of related properties that can be used to further refine the sound in-game, which fall into for example one of the following possible categories,:
delays;
transitions; and
volume, pitch, or state settings.

The Event Editor 246 is further configured to allow a user to rename an event, remove actions from an event, substitute objects assigned to event actions with other objects and find an event's object in the Audio tab 130 of the Project Explorer 128 that is included in an event. For these purposes, the Event Editor 246 includes conventional GUI means, including for example, pop up menus, drag and drop functionalities, etc.

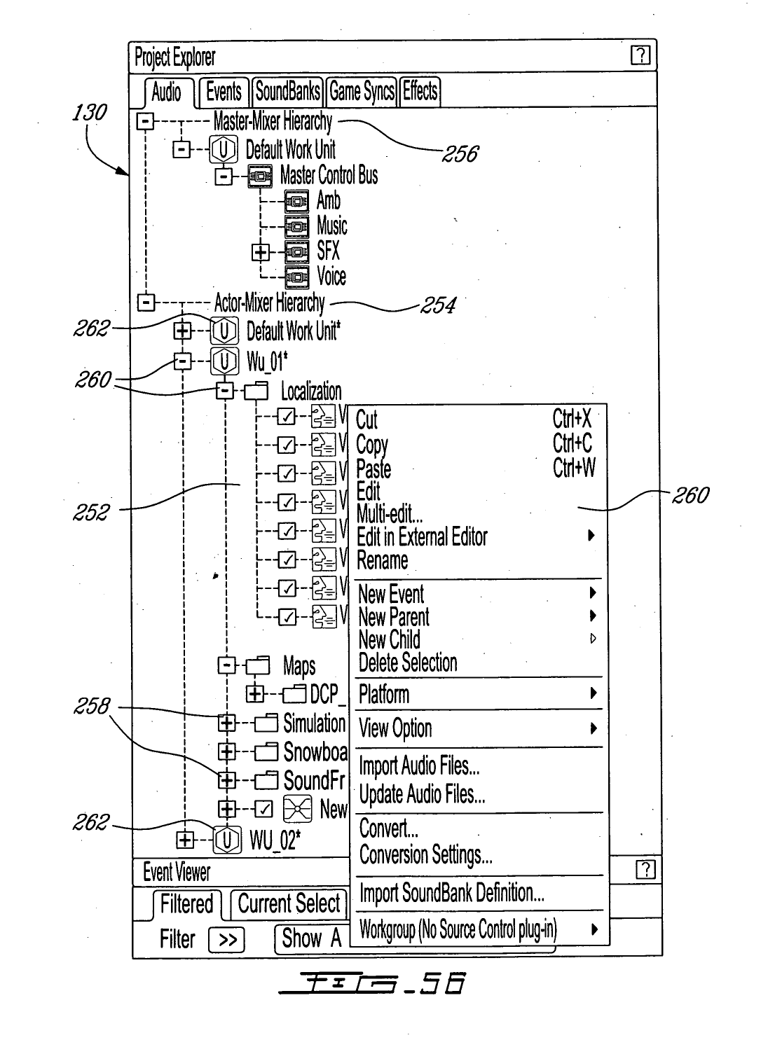

Before describing the Master-Mixer hierarchy in more detail, further characteristics and functionalities of the Audio tab 130 of the Project Explorer 128 will now be briefly discussed with reference to FIG. 56. More specifically, GUI tools provided with the Audio tab 130 of the Project Explorer 128 to create and manage a project hierarchy will now be described.

It is first recalled that the Audio tab 130 includes a tree view 252 of the hierarchical structure including both the Actor-Mixer 254 and the Master-Mixer 256 hierarchies. Navigation through the tree is allowed by clicking conventional alternating plus (+) 258 and minus (−) 260 signs which causes the correspondent branch of the tree to respectively expand or collapse.

In addition to the icons used to identify different object types within the project, other visual elements, such as color are used in the Audio tab 130 and more generally in the Project Explorer 128 to show the status of certain objects.

Of course, as illustrated in numerous examples hereinabove, indentation is used to visually distinguished parent from child levels. Other visual codes can be used including, colors, geometrical shapes and border, text fonts, text, etc.

A shortcut menu 260, such as the one illustrated in FIG. 56, is available for each Work unit 262 in the hierarchy. This menu 260 can be made available through any conventional user interface means including for example by right-clicking on the selected Work unit name 262 from the list tree. The menu 260 offers the user access to hierarchy management-related options. Some of the options from the menu include sub-menu options so as to allow creating the hierarchical structure as described hereinabove. For example, a “New Child” option, which allows creating a new child in the hierarchy to the parent selected by the user, further includes the options of defining the new child as folder, an actor-mixer, a switch-container, a random-sequence container, a sound effects or a sound voice for example. A similar process can be used to create a parent in the hierarchy. As can also be seen from FIG. 56, the Audio tab 130 is further configured with conventional editing functionalities, including cut and paste, deleting, renaming and moving of objects. These functionalities can be achieved through any well-known conventional GUI means.

The Contents Editor 156 is provided with similar conventional editing functionalities which will not be described herein for concision purposes and since they are believed to be within the reach of a person of ordinary skills in the art.

Master-Mixing

The Master-Mixer hierarchical structure is provided on top of the Actor-Mixer hierarchy to help organize the output for the project. More specifically, the Master-Mixer hierarchy is provided to group output busses together, wherein relative properties, states, RTPCs, and effects as defined hereinabove are routed for a given project.

The Master-Mixer hierarchy consists of two levels with different functionalities:
Master Control Bus: the top level element in the hierarchy that determines the final output of the audio. As will be described hereinbelow in more detail, while other busses can be moved, renamed, and deleted, the Master Control Bus is not intended to be renamed or removed. Also, according to the first illustrative embodiment, effects can be applied onto the Master Control Bus;
Control Busses: one or more busses that can be grouped under the master control bus. As will be described hereinbelow in more detail, these busses can be renamed, moved, and deleted, and special behaviours, effects and auto-ducking can be applied thereon.

The Authoring tool is configured so that, by default, the sounds from the Actor-Mixer hierarchy are routed through the Master Control Bus. However, as the output structure is built, objects can systematically be routed through the busses that are created. Moreover, a GUI element is provided in the Authoring Tool, and more specifically in the Audio tab 130 of the Project Explorer 128, for example in the form of a Default Setting dialog box (not shown) to modify this default setting.

With reference to FIG. 56, the Master-Mixer hierarchy can be created and edited using the same GUI tools and functionalities provided in the Audio tab 130 of the Project Explorer 128 to edit the Master-Mixer hierarchy.

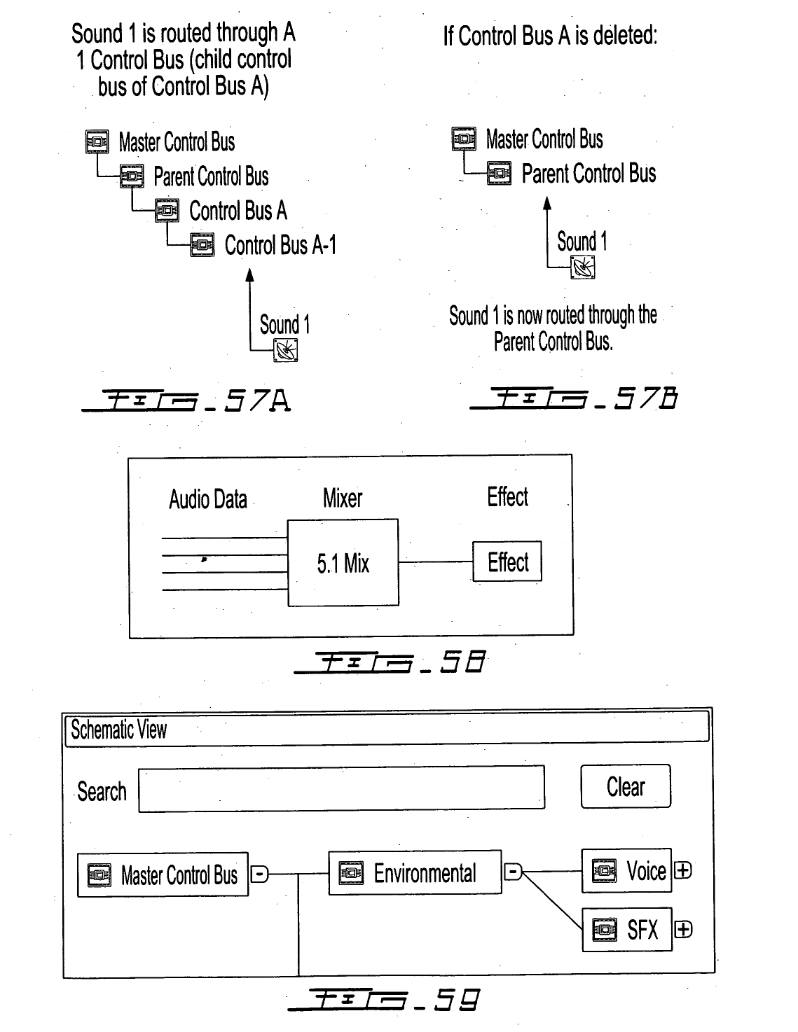

A method for re-routing sound objects that were connected to a bus that is deleted will now be described with reference to FIG. 57. Indeed, when a control bus is deleted for having being created by mistake or for being no longer needed, all of its child control busses are also deleted. According to the present re-routing method, the sounds that were routed through the deleted bus are reassigned to the next parent object in the hierarchy. Also, the property overrides for the rerouted objects remain intact.

Similarly to objects in the Actor-Mixer hierarchy, each control bus can be assigned properties that can be used to make global changes to the audio in the game. The properties of a control bus can be used to do for example one of the following:
add effects;
specify values for volume, LFE, pitch, and low pass filter;
duck audio signals; and
mute busses

Since the control busses are the last level of control, any changes made will affect the entire group of objects below them.

As in the case for objects, RTPCs can be used, states can be assigned and advanced properties can be set for control busses.

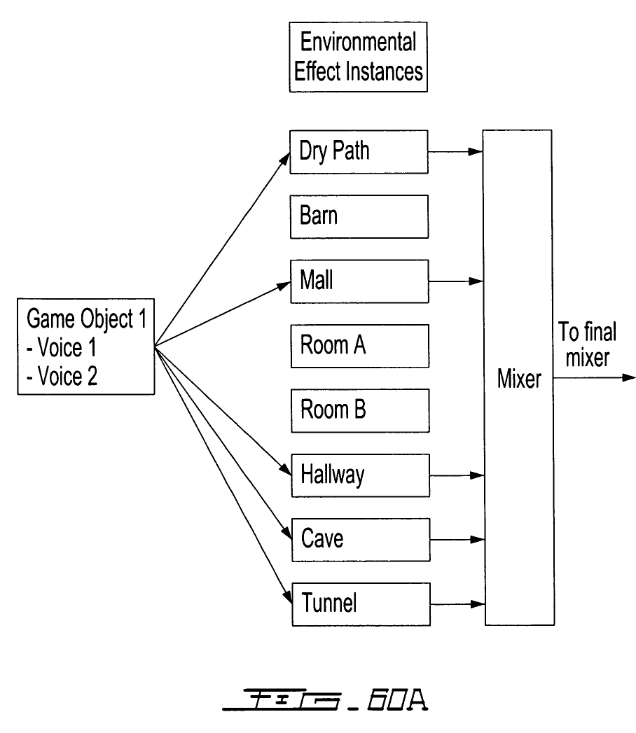

As illustrated in FIG. 58, audio and environmental-related effects can be applied to a control bus to alter and enhance the character of selected sounds. These effects can be applied to any control bus in the Master-Mixer hierarchy including the Master Control Bus. However, environmental effects have the additional capability of being applied dynamically according to game object location data.

The control busses are linked to objects from the Actor-Mixer hierarchy in a parent-child relationship therewith so that when effects are applied to a control bus, all incoming audio data is pre-mixed before the effect is applied.

A “Bypass effect” control GUI element (not shown) is provided for example in the Property Editor window 134 which becomes available when a control bus is selected to bypass an effect.

The Property Editor 134 shares the same GUI effect console section for selecting and editing an effect to assign to the current control bus which can be used to assign an effect to an object within the Actor-Mixer hierarchy (see FIG. 16A). This effect is applied to all sounds being mixed through the bus. Examples of effects include reverb, parametric equalizing, expander, compressor, peak limiter, parametric EQ and delay. Since these effects are believed to be well-known in the art, they will not be described herein in more detail.

Effect plug-ins can also be created and integrated using the GUI effect console element. The GUI effect console section or element is identical to the one which can be seen in FIG. 16A.

Using the same GUI effect console, environmental effects can be added. The environmental effect, while sharing some characteristics with a reverb effect, has a different implementation. The environmental plug-in allows to define a particular reverb property set for each environment in a game. It also allows listeners to hear transitions between reverb property sets as they move between environments.

Environmental plug-in property sets can be created and edited, and a bus to which these property sets will be assigned can be specified. Environmental property sets are applied to sounds passed through this bus based on game object positioning. In operation,
the sound designer defines property sets corresponding to environments in the game, such as small room, church, or cave;
the game developer maps these property sets to the environments as they appear in the game geometry; and
the sound engine calculates which environmental effect or effects to apply to the sounds triggered by each game object based on its position in the game geometry.

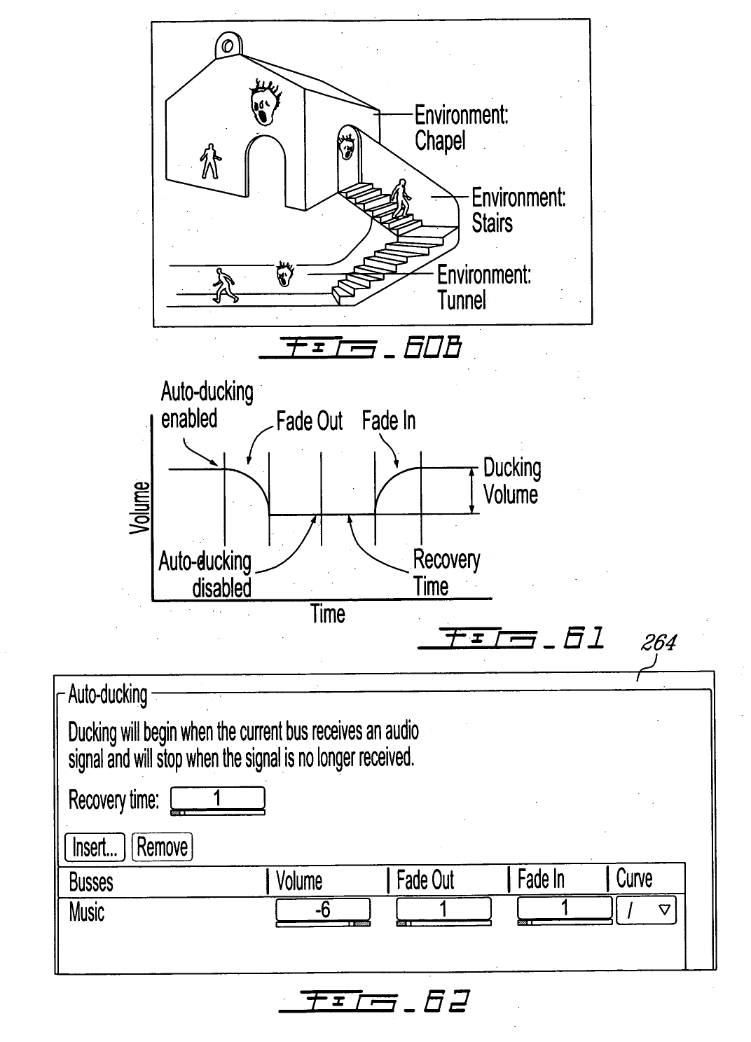

Environmental effects are intended to be applied to a single bus in a project. Therefore, in order to have for example both a sound effect bus and a voice bus to be affected by environmental effects, a new bus called Environmental is created and both the sound effect and voice busses are moved under that parent bus (see FIG. 59).

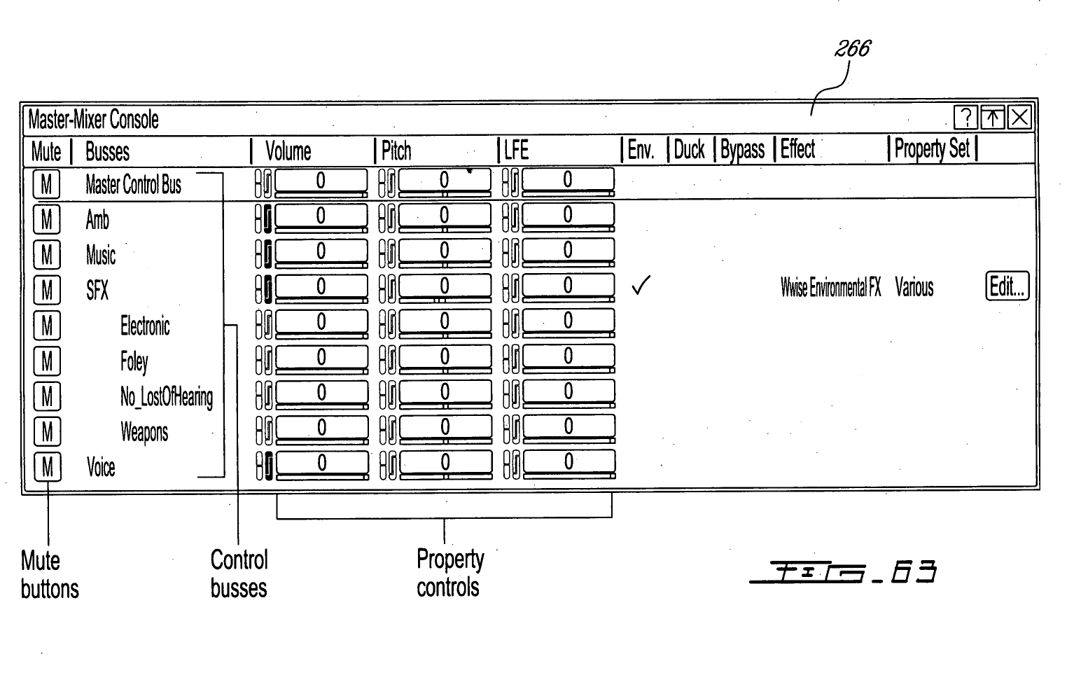

When a sound triggered by a game object moves through the various environments of a game, sounds passing through the environmental bus are affected by the property sets the game developer has mapped to those areas. This smoothes game object transitions between environments and creates more realistic soundscapes and mixing. Game objects have environmental effect instances applied to them dynamically before being mixed. The proportion of each instance that is applied to the particular sounds depends on the position of each game object within the game geometry. This is illustrated in FIG. 60A.

An example of application of the environmental effects on a control bus will now be presented with reference to FIG. 60B with refers to haunted graveyard environments in a video game.

According to this specific example, the game takes place in and around a haunted graveyard. The game includes ghosts, and one would want the ghosts to sound different depending on which environment the ghost sounds are coming from. The player can explore a chapel, a tunnel, and the stairway connecting the two. Therefore, the following environmental property sets are defined: chapel, stairs, and tunnel.

These three environments can each have a distinct reverb property set. For example, the tunnel is a much smaller space than the chapel, and has cavernous stone walls; therefore, its reverb will be much more pronounced than that of the chapel. The Authoring Tool is used to create the environmental property sets, including, for example, a higher reverb level and shorter decay time for the Tunnel property set. Later, a level designer maps the property sets to locations in the game's geometry. As a result, when a ghost is in the tunnel, ghost sounds echo far more than when the ghost is in the chapel.

The environmental plug-in can also be used, for example, to emulate the movement between environments. For example, considering an player descending the stairs from the chapel into the tunnel, with a ghost in close pursuit. Partway through the tunnel, the player and ghost can be defined as being 100% in the Stairs environment, but also 50% in the Chapel environment, and 40% in the Tunnel environment. The ghost's sounds are then processed with each reverb preset at the appropriate percentage.

Similarly to what has been described with reference to objects within the Actor-Mixer hierarchy, relative properties can be defined for each control bus within the Master-Mixer hierarchy using the same GUI that has been described with reference to the Actor-Mixer hierarchy. Also, the same properties which can be modified for objects within the Actor-Mixer hierarchy can be modified for control busses, namely, for example: volume, LFE (low frequency effects), pitch, and low pass filter.

The Master-Mixer hierarchy and more specifically, the control busses can be used to duck a group of audio signals as will now be described. Ducking provides for the automatic lowering of the volume level of all sounds passing through one first bus in order for another simultaneous bus to have more prominence.

For example, when at different points in a game, some sounds are to be more prominent than others or the music is to be lowered when characters are speaking in game, audio signals' importance in relation to others can be determined using ducking.

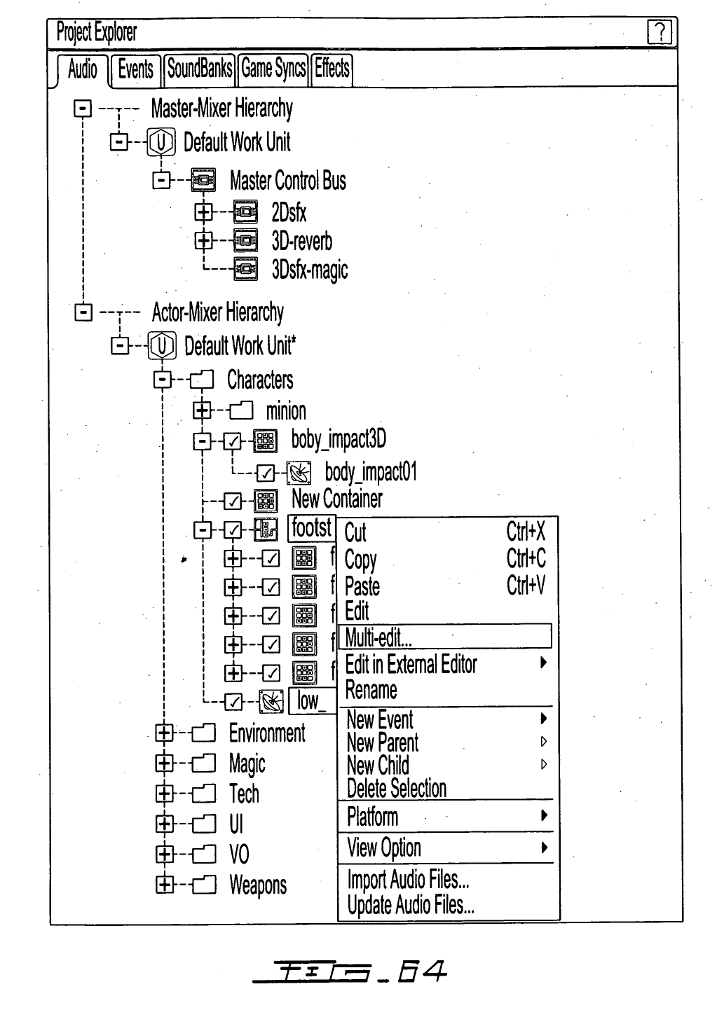

As illustrated in FIG. 61, the following properties and behaviours can be modified to control how the signals are ducked:
ducking volume;
fade out;
fade in;
curve interpolation; and
recovery time.

For the curve interpolation, the curves can have for example the following shapes:
Logarithmic (Base 3);
Logarithmic (Base 2);
Logarithmic (Base 1.41);
Inverted S-Curve;
Linear;
Constant;
S-Curve;
Exponential (Base 1.41);
Exponential (Base 2); and
Exponential (Base 3).

The Property Editor 134 includes an Auto-ducking control panel 264 to edit each of these parameters (see FIG. 62).

Creating the Final Mix

The Authoring Tool includes a Master-Mixer Console GUI 266 to allow the user to fine-tune and troubleshoot the audio mix in the game after the bus structure has been set up. The Master-Mixer Console 266 is provided to audition and modify the audio as it is being played back in game.

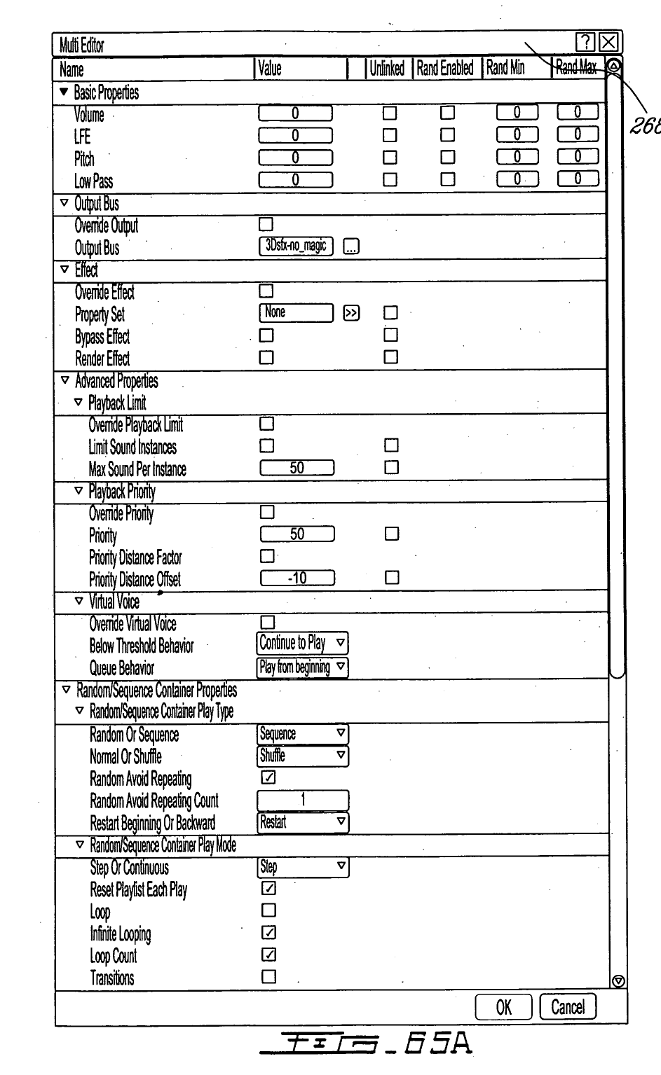

Generally stated the Master-Mixer Console GUI 266 includes GUI elements allowing modifying during playback all of the Master-Mixer properties and behaviours as described hereinabove in more detail. For example, with reference to FIG. 63, the following control bus information can be viewed and edited for the objects that are auditioned:
Env.: indicates when an environmental effect has been applied to a control bus;
Duck: indicates when a control bus is ducked;
Bypass: indicates that a particular effect has been bypassed in the control bus;
Effect: indicate that a particular effect has been applied to the control bus;
Property Set: indicates which property set is currently in use for the effect applied to the control bus.

The Authoring tool is configured for connection to the game for which the audio is being authored.

Once connected, the Master-Mixer console 266 provides quick access to the controls available for the control busses in the Master-Mixer hierarchy.

Since the Master-Mixer and Actor-Mixer share common characteristics and properties, they are both displayed in the Project Explorer 128. Also, to ease their management and the navigation of the user within the Authoring tool, both Actor-Mixer elements, i.e. objects and containers, and Master-Mixer elements, i.e. control busses, are editable and manageable via the same GUIs, including the Property Editor 134, the Contents Editors 156, etc.

Alternatively, separate GUI can be provided to edit and manage the Master-Mixer and Actor-Mixer hierarchies.

Also both the Master-Mixer and Actor-Mixer hierarchies can be created and managed via the Project Explorer 128.

Each object or element in the Project Explorer 128 is displayed alphabetically under its parent. Other sequence of displaying the objects within the hierarchies can also be provided. In the Audio tab 130, for example, the objects inside a parent object are organized in the following order:
work units;
folders;
actor-mixers;
random containers
sequence containers;
switch containers;
sound effects and sound voice objects.

The Project Explorer 128 includes conventional navigation tools to selectively visualize and access different levels and objects in the Project Explorer 128.

The Project Explorer GUI 128 is configured to allow access to the editing commands included on the particular platform on which the computer 12 operates, including the standard Windows Explorer commands, such as renaming, cutting, copying, and pasting using the shortcut menu.

The Authoring tool further includes a Multi Editor 268 for simultaneously modifying the properties of a group of objects, or modifying multiple properties for one object. The Multi Editor 268 allows modifying properties for the following objects:
sounds;
random-sequence containers;
switch containers;
actor-mixers; and
control busses.

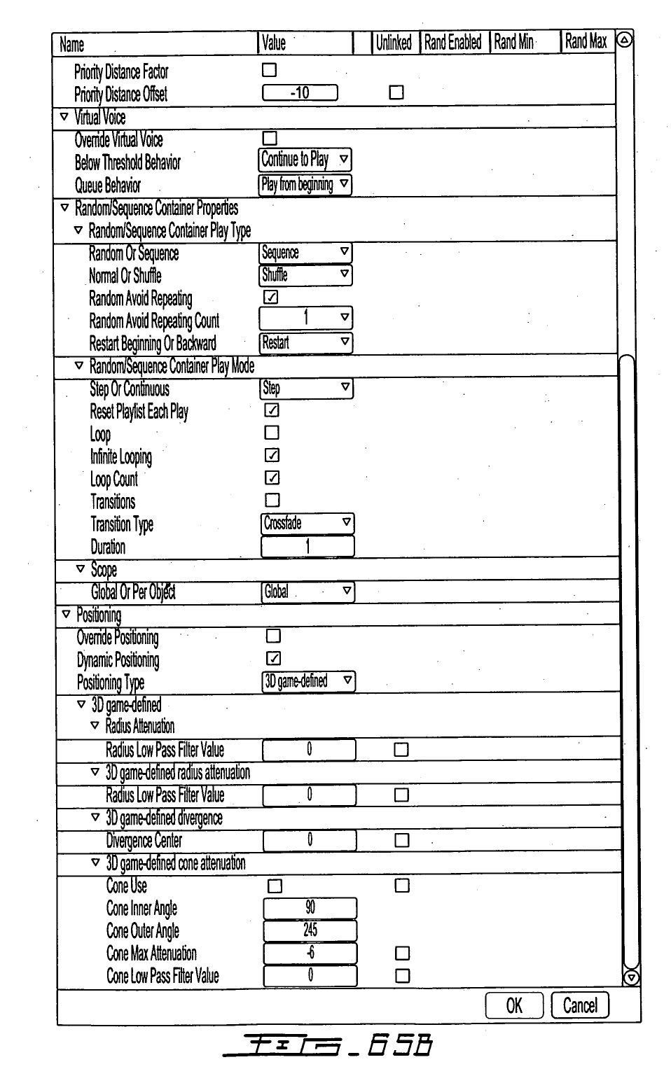

As illustrated in FIG. 64, after at least one object has been selected within the one of the two hierarchies, the Multi Editor 268 can be called from shortcut menu 260 available in the Audio tab 130 of the Project Explorer 128.

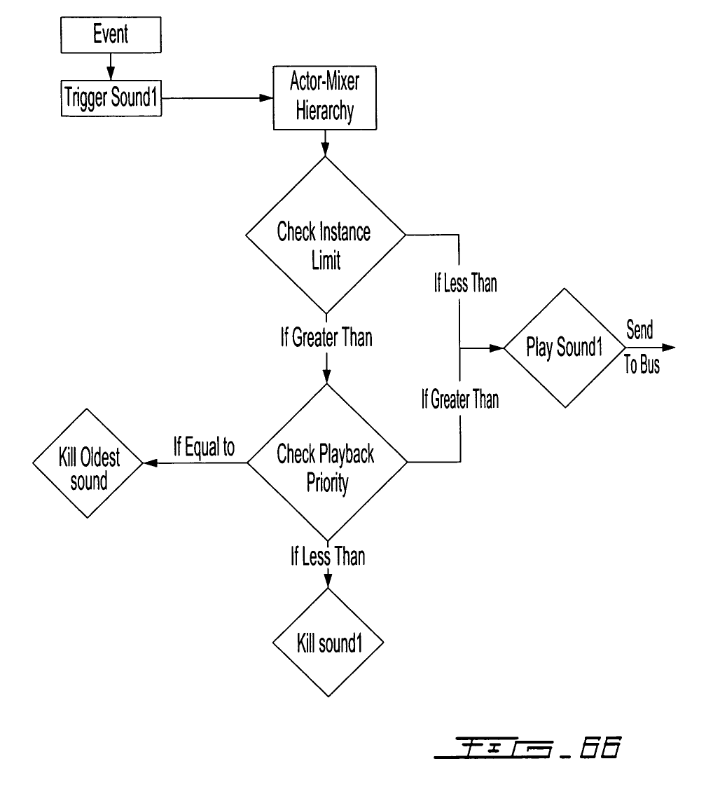

The Multi Editor 268 is in the form of a dialog box including some or all of the editable properties that have been described hereinabove. An example of Multi-Editor 268 is illustrated in FIGS. 65A-65B.

The Multi Editor 268 is provided to define and modify properties for several objects at once. This can be used, for example, to route several containers through a particular control bus, or to modify the volume for a large selection of objects and busses.

The Multi Editor 268 can be used to modify for example the properties of the following objects:
Sounds;
random and sequence containers;
switch containers;
actor-mixers; and
control busses.

As illustrated in FIGS. 65A-65B, the Multi Editor displays the properties for the selected objects contextually: the properties and behaviors that are displayed depend on the kind of objects that are selected. For example, if the Multi Editor is opened for a switch container, the properties that are displayed in the Property Editor for a switch container will be displayed.

The Multi Editor 268 allows, for example:
modifying relative or absolute object properties values for all properties in the Property Editor 134;
enabling randomizers for object properties;
defining minimum and maximum values for a Randomizer.

When the Multi Editor 268 is closed, all the properties are applied to the objects that have been selected.

Playback Limit and Priority

Since many sounds may be playing at the same time at any moment in a game, the Authoring tool includes a first sub-routine to determine which sound per game object to play within the Actor-Mixer hierarchy and a second sub-routine to determine which sound will be outputted through a given bus. These two sub-routines aim at preventing that more sounds be triggered than the hardware can handle.

As will be described hereinbelow in more detail, the Authoring tool further allows the user to manage the number of sounds that are played and which sounds take priority: in other words, to provide inputs for the two sub-routines.

More specifically, in the Authoring tool, there are two main properties that can be set to determine which sounds will be played in game:
playback limit: which specifies a limit to the number of sound instances that can be played at any one time;
playback priority: which specifies the importance of one sound object relative to another.

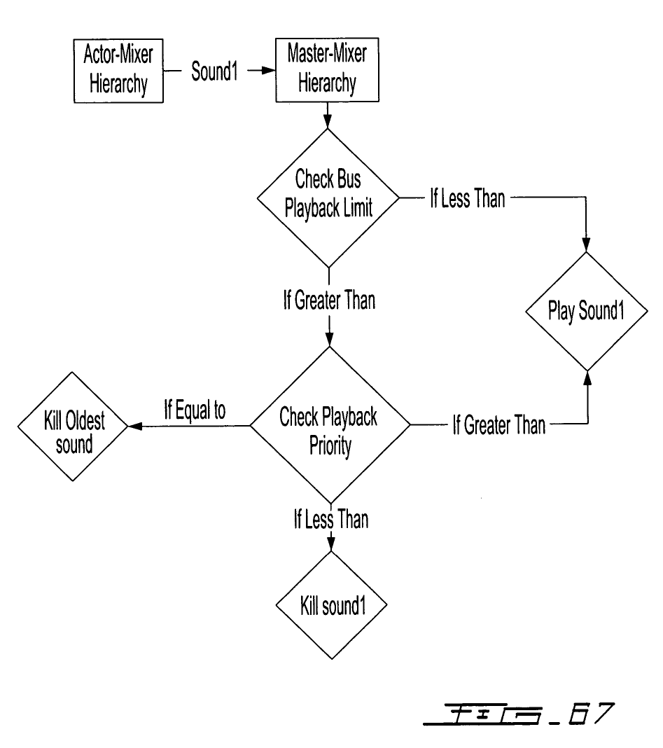

These advanced playback settings are defined at two different levels: at the object level in the Actor-Mixer hierarchy (see FIG. 66), and at the bus level in the Master-Mixer hierarchy (see FIG. 67). Because these settings are defined at two different levels, it results that a sound passes through two separate processes before it is played.

As illustrated in FIG. 66, the first process occurs at the Actor-Mixer level. When the advanced settings for objects are defined within the Actor-Mixer hierarchy, a limit per game object is set. If the limit for a game object is reached, the priority then determines which sounds will be passed to the bus level in the Master-Mixer hierarchy.

FIG. 66 shows how the Authoring tool determines which sounds within the actor-mixer structure are played per game object.

If the new sound is not killed at the actor-mixer level, it passes to the second process at the Master-Mixer level. At this level, a global playback limit is used to restrict the total number of voices that can pass through the bus at any one time. FIG. 67 shows how the Authoring tool determines which sounds are outputted through a bus.

Playback Limit

The simultaneous playback of sounds can be managed using two different methods:
by limiting the number of sound instances that can be played per game object;
by limiting the overall number of sound instances that can pass through a bus.

When either limit is reached, the system 10 uses the priority setting of a sound to determine which one to stop and which one to play. If sounds have equal priority, it is determined that the sound instance having been played the longest is killed so that the new sound instance can play. In case of sounds having equal priority, other rules can also be set to determine which sound to stop playing.

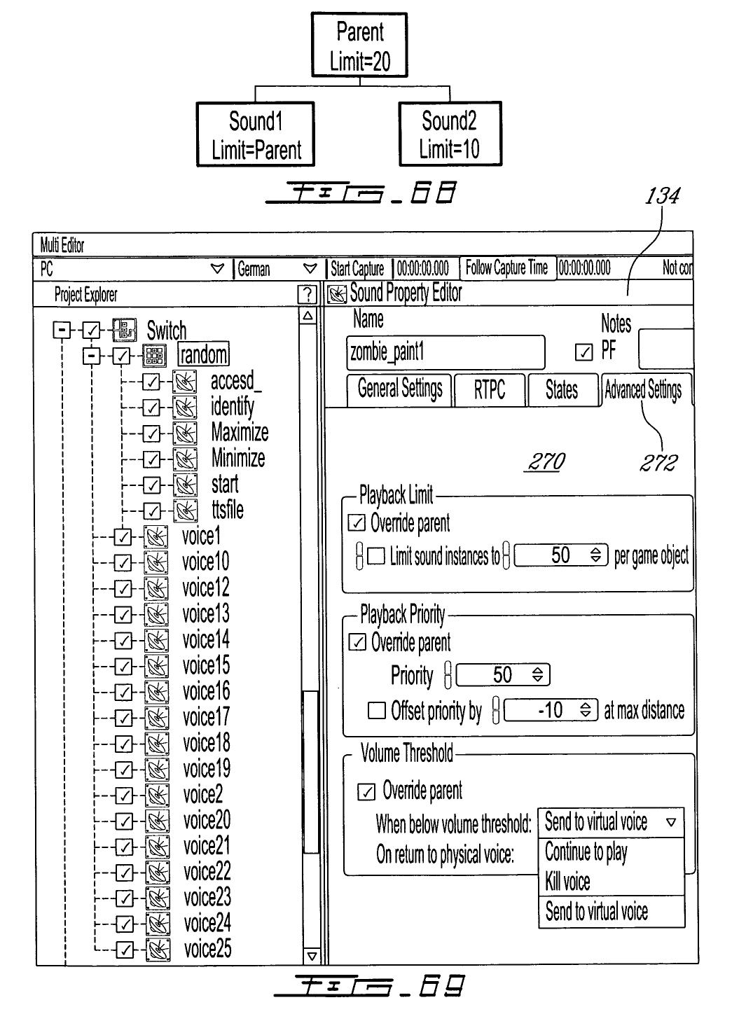

The Authoring tool is configured for setting a playback limit at the Actor-Mixer level so as to allow controlling the number of sound instances within the same actor-mixer structure that can be played per game object. If a child object overrides the playback limit set at the parent level in the hierarchy, the total number of instances that can play is equal to the sum of all limits defined within the actor-mixer structure. This is illustrated in FIG. 68. For example, considering a parent with a limit of 20 and a child with a limit of 10, the total possible number of instances is 30.

The Authoring tool is further configured for setting the playback limit at the Master-Mixer level, wherein the number of sound instances that can pass through the bus at any one time can be specified. Since the priority of each sound has already been specified at the Actor-Mixer level, there is no playback priority setting for busses.

With reference to FIG. 69, the Property Editor 134 includes a “Playback Limit” group box 270 for inputting the limit of sound instances per game object for the current object in the Property Editor 134. Even though the Playback Limit group box 270 is implemented in an Advance Setting tab 272 of the Property Editor 134, it can be accessed differently. Also, the GUI provided to input the limit of sound instances per game object can take other forms.

Playback Priority

When the limit of sounds that can be played is reached at any one time, either at the game object or bus level, the priority or relative importance of each sound is used to determine which ones will be played.

A standard numerical scale, ranging for example between 1-100, where 1 is the lowest priority and 100 is the highest priority, is provided to define the priority for each sound. Other scales can alternatively be used. The Authoring tool deals with priority on a first in first out (FIFO) approach; when a new sound has the same playback priority as the lowest priority sound already playing, the new sound will replace the existing playing sound.

Using Volume Thresholds

A third performance management mechanism is provided with the Authoring tool in the form of virtual voices, which is a virtual environment where sounds below a certain volume level are monitored by the sound engine, but no audio processing is performed. As a way to manage many sounds and optimize performance, this virtual sound environment allows to define behaviors for sounds that are below a user-defined volume threshold. Sounds below this volume threshold may be stopped or may be queued in a virtual voice list, or can continue to play even though they are inaudible. Therefore, sounds defined as virtual voices move from the physical voice to the virtual voice and vice versa based on their volume level as defined by the user.

The implementation of virtual voices is based on the following premises: to maintain an optimal level of performance when many sounds are playing simultaneously, sounds below a certain volume level should not take up valuable processing power and memory. Instead of playing these inaudible sounds, the sound engine queues them in a virtual voice list. The Authoring tool continues to manage and monitor these sounds, but once inside the virtual voice list, the audio is no longer processed by the sound engine.

When the virtual voices feature is selected, selected sounds move back and forth between the physical and the virtual voice based on their volume levels. As the volume reaches a volume threshold for example, they are added to the virtual voice list and audio processing stops. As volume levels increase, the sounds move from the virtual voice to the physical voice where the audio will be processed by the sound engine again.

As can be seen in FIG. 69, a group box 270 is included, for example in the Advance Setting tab 272 of the Property Editor 134, for defining the playback behaviour of sounds selected from the hierarchy tree of the Property Editor 134 as they move from the virtual voice back to the physical voice.

The behaviour can be defined following one of these options:
Play from beginning: to play the sound from its beginning. This option does not reset the sound object's loop count for example.
Play from elapsed time: to continue playing the sound as if it had never stopped playing. This option is not sample accurate, which means that sounds returning to the physical voice may be out of sync with other sounds playing.
Resume: to pause the sound when it moves from the physical voice to the virtual voice list and then resume playback when it moves back to the physical voice.

SoundBanks

Returning to FIG. 2, after the hierarchical structure has been created and the project completed (step 106), the method 100 proceeds with the generation of sound banks in step 108, which are project files including events and with links to the corresponding audio files. Sound banks will be referred to herein as “SoundBanks”.

Each SoundBank is loaded into a game's platform memory at a particular point in the game. As will become more apparent upon reading the following description, by including minimal information, SoundBanks allow optimizing the amount of memory that is being used by a platform. In a nutshell, the SoundBanks include the final audio package that becomes part of the game.

In addition to SoundBanks, an initialization bank is further created. This special bank contains all the general information of a project, including information such as on the bus hierarchy, on states, switches, RTPCs and environmental effects. The Initialization bank is automatically created with the SoundBanks.

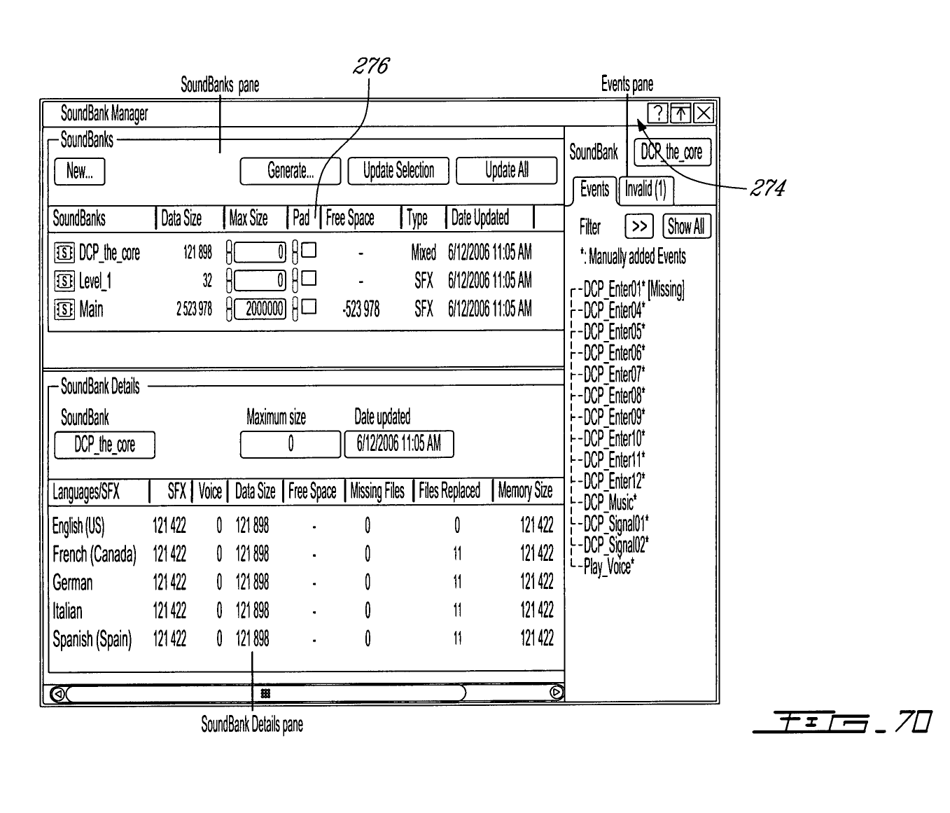

The Authoring tool includes a SoundBank Manager 274 to create and manage SoundBanks. The SoundBank Manager 274 is divided into three different panes as illustrated in FIG. 70:
SoundBanks pane: to display a list of all the SoundBanks in the current project with general information about their size, contents, and when they were last updated;
SoundBank Details: to display detailed information about the size of the different elements within the selected SoundBank as well as any files that may be missing.
Events: displays a list of all the events included in the selected SoundBank, including any possible invalid events.

Building SoundBanks

As will now be described in further detail, the Authoring tool is configured to manage one to a plurality of SoundBanks. Indeed, since one of the advantages of providing the results of the present authoring method in Soundbanks is to optimize the amount of memory that is being used by a platform, in most project it is advisable to present the result of the Authoring process via multiple SoundBanks.

When determining how many SoundBanks to create, the list of all the events integrated in the game can be considered. This information can then be used to define the size limit and number of SoundBanks that can be used in the game in order to optimize the system resources. For example, the events can be organized into the various SoundBanks based on the characters, objects, zones, or levels in game.

The Authoring tools includes GUI elements to perform the following tasks involved in building a SoundBank:
creating a SoundBank;
populating a SoundBank;
managing the content of a SoundBank; and
managing SoundBanks.

The creation of a SoundBank includes creating the actual file and allocating the maximum of in-game memory thereto. As can be seen from FIG. 70, the Soundbank manager includes input text boxes for that purpose. A “Pad” check box option 276 in the SoundBanks pane is provided to allow setting the maximum amount of memory allowed regardless of the current size of the SoundBank.

Populating a SoundBank includes inputting therein the series of events to be loaded in the game's platform memory at a particular point in the game.

The SoundBank manager is configured to allow populating SoundBanks either by importing a definition file or manually.

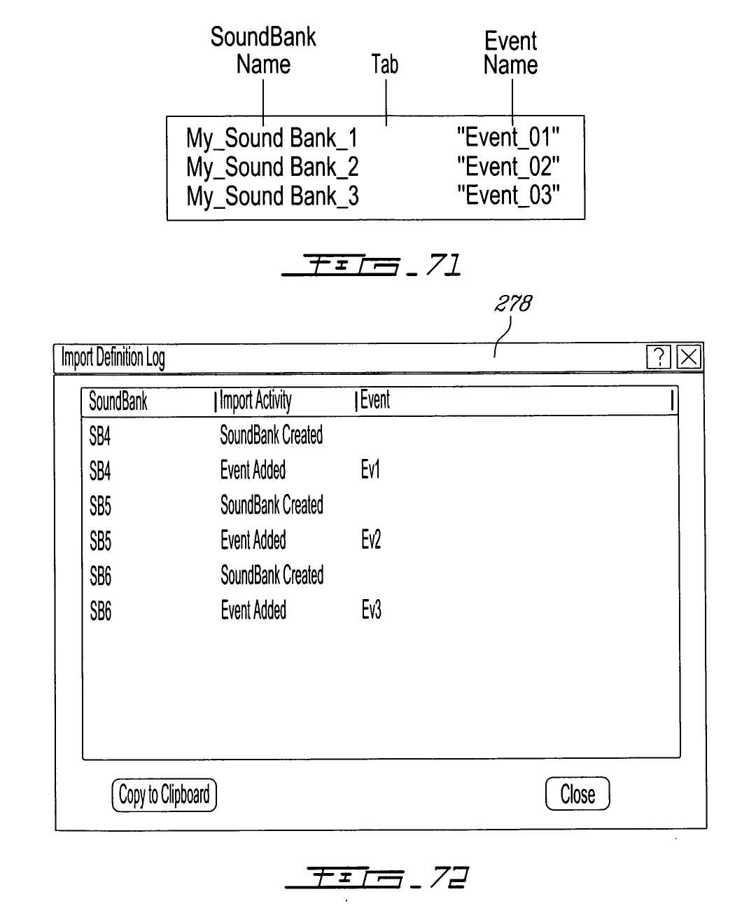

A definition file is for example in the form of a text file that lists all the events in the game, classified by SoundBank. A first example of definition file is illustrated in FIG. 71.

The text file defining the definition file is not limited to include text string as illustrated in FIG. 71. The Authoring tool is configured to read definition files, and more specifically events, presented in the globally unique identifiers (GUID), hexadecimal or decimal system.

The SoundBanks include all the information necessary to allow the video game to play the sound created and modified using the Authoring Tool, including Events and associated objects from the hierarchy or links thereto as modified by the Authoring Tool.

According to a further embodiment, where the Authoring Tool is dedicated to another application for example, the SoundBanks may include other or different information, including selected audio sources or objects from the hierarchical structure.

After SoundBanks have been populated automatically using a definition file, the SoundBank manager 274 is configured to open an Import Definition log dialog box 278. An example of such a dialog box 278 is illustrated in FIG. 72. The Definition Log 278 is provided to allow the user reviewing the import activity.

The Definition Log 278 can include also other information related to the import process.

Returning to FIG. 70, the SoundBank Manager 274 further includes an Events pane to manually populate SoundBanks. This pane allows assigning events to SoundBanks.

The SoundBank manager 274 includes conventional GUI functionalities to edit the SoundBank created, including filtering and sorting the SoundBank event list, deleting events from a SoundBank, editing events within a SoundBank, and renaming SoundBanks.

The SoundBank manager further includes a Details pane which displays information related to memory, space remaining, sizes of SoundBanks, etc. More specifically, the Details pane includes the following information:
Data Size: the amount of memory occupied by the Sound SFX and Sound Voice objects;
Free Space: the amount of space remaining in the SoundBank;
Files Replaced: the number of missing Sound Voice audio files that are currently replaced by the audio files of the Reference Language;
Memory Size: the amount of space occupied by the SoundBank data that is to be loaded into memory;
Prefetch Size: the amount of space occupied by the SoundBank data that is to be streamed; and
File Size: the total size of the generated SoundBank file.

After the SoundBanks have been created and populated, they can be generated.

When a SoundBank is generated, it can include any of the following information:
sound data for in-memory sounds;
sound data for streamed sounds;
pre-fetch sound data for streamed sounds with zero-latency;
event information;
sound, container, and actor-mixer related information; and
events string-to-ID conversion mapping.

The information contained in the SoundBanks is project exclusive, which means that a SoundBank is used with other SoundBanks generated from the same project. Further details on the concept of “project” will follow.

The Authoring tool is configured to generate SoundBanks even if they contain invalid events. These events are ignored during the generation process so that they do not cause errors or take up additional space.

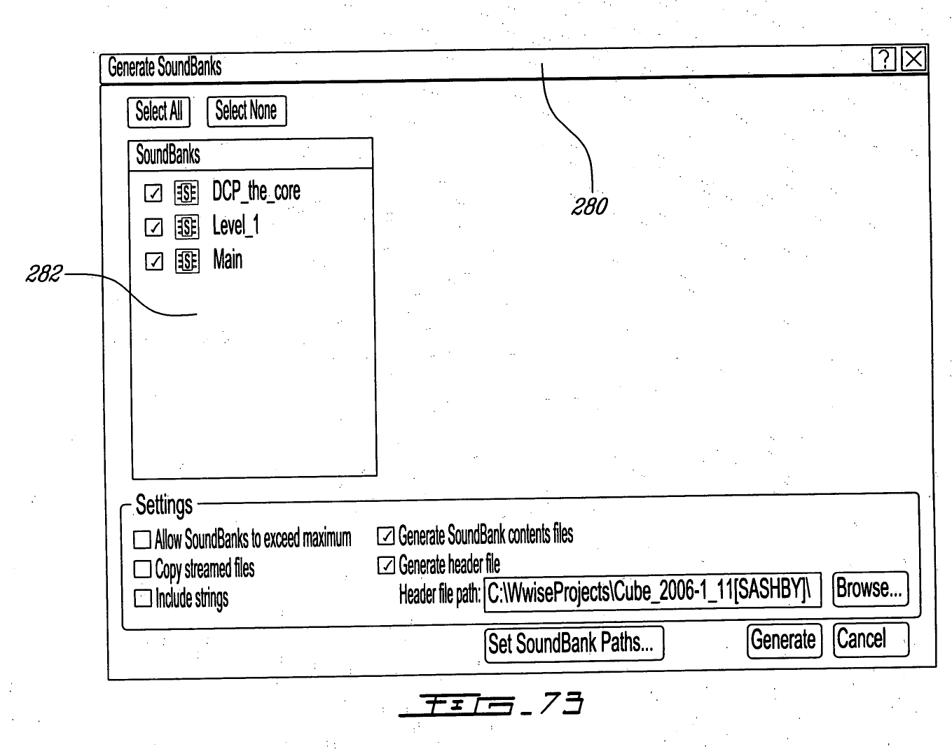

FIG. 73 illustrates an example of SoundBank Generator GUI panel 280 provided with the SoundBank Manager 274 to allow the user to generate SoundBanks and set options for their generation.

The SoundBank Generator 280 includes a list box 282 for listing and allowing selection of the SoundBanks to generate.

The SoundBank Generator 280 further includes check boxes for the following options:
“Allow SoundBanks to exceed maximum”: to generate SoundBanks even if they exceed the maximum size specified;
“Copy streamed files”: to copy all streamed files in the project to the location where the SoundBanks are saved;
“Include strings”: to allow the events within the SoundBanks to be called using their names instead of their ID numbers;
“Generate SoundBank contents files”: to create files that list the contents of each SoundBank. The contents files include information on events, busses, states, and switches, as well as a complete list of streamed and in memory audio files.

The SoundBank generation process further includes the step of assigning a location where the SoundBanks will be saved. The SoundBank Generator 280 includes GUI elements to designate the file location.

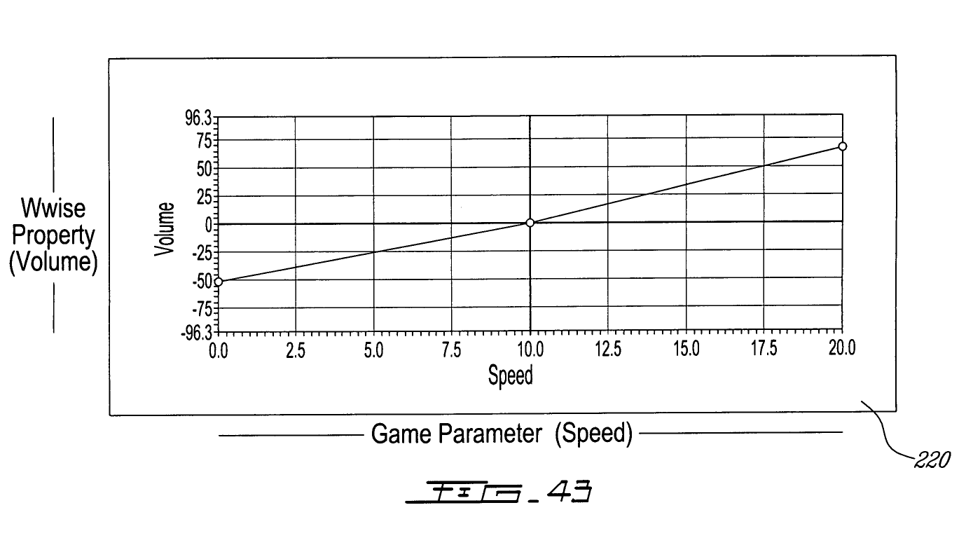

As illustrated in FIGS. 33 and 42 for example, the Project Explorer 128 includes a SoundBank tab 284 for displaying the SoundBanks created for the current project. Similarly to other tabs from the Project Explorer 128, the SoundBank tab 284 displays the SoundBanks alphabetically under its parent folder or work unit. The SoundBank tab GUI 284 further allows creating and organizing SoundBanks into folders and work units, cutting and pasting SoundBanks, etc. Since the SoundBank tab GUI share common functionalities with other tabs from the Project Explorer, it will not be described herein in further detail.

The relevant information resulting from the authoring process using the hierarchical structure to be used by the computer application can take other forms depending on the nature of the computer application and/or the media files for example. The forms of the project files are therefore not limited to SoundBanks as described with reference to the first illustrative embodiment.

For example, depending on the application, only the events can be stored in the project files, only the media objects, both, events with the hierarchy, etc.

It is to be noted that the steps from the method 100 can be performed in other orders than the one presented. For example, the Authoring tool allows adding sound files and therefore sound objects in a project hierarchy already created.

Additional characteristics and features of the method 100 and of the system 10 and more specifically of the Authoring tool will now be described.

Projects

As it has been described hereinabove, the information created by the Authoring tool are contained in a project, which is a logical and physical way to include sound assets, properties and behaviours associated to these assets, events, presets, logs, simulations and SoundBanks.

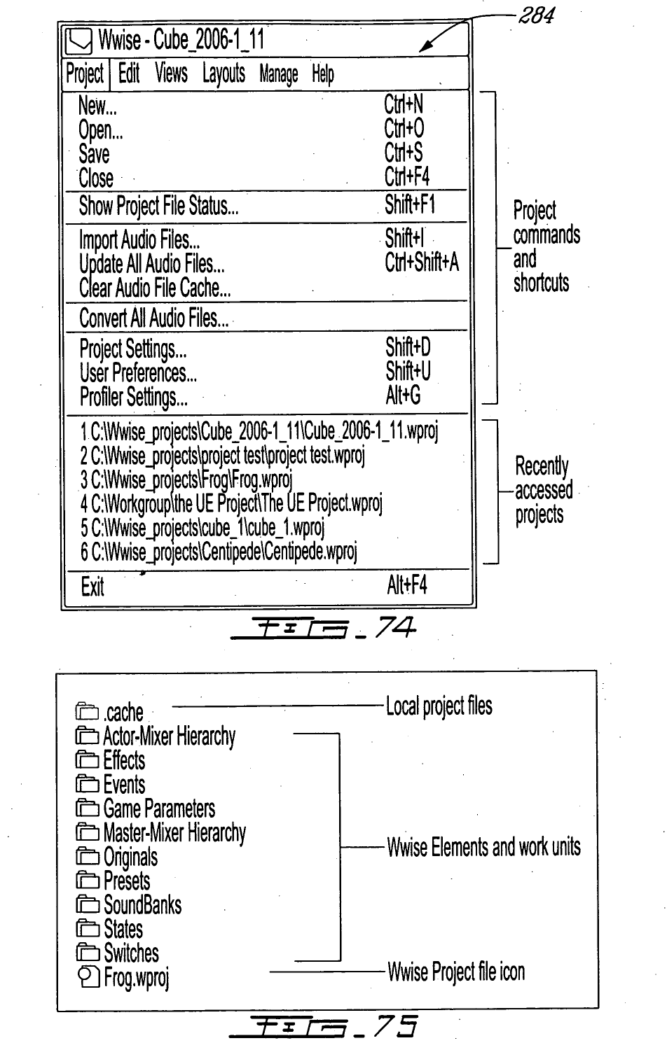

The Authoring tool includes a Project Launcher 284 for creating and opening an audio project. The Project Launcher 284, which is illustrated in FIG. 74, is in the form of a conventional menu including a series of commands for managing projects, including: creating a new project, opening, closing, saving an existing project, etc. Conventional GUI tools and functionalities are provided with the Project Launcher 284 for these purposes.

A created project is stored in a folder specified in the location chosen on the system 10 or on a network to which the system 10 is connected.

The project is stored for example in XML files in a project folder structure including various folders, each intended to receive specific project elements. The use of XML files has been found to facilitate the management of project versions and multiple users. Other types of files can alternatively be used. A typical project folder contains the following, as illustrated in FIG. 75:
Cache: this hidden folder is saved locally and contains all the imported audio files for the project and the converted files for the platform for which the project is being developed as described hereinabove;
Actor-Mixer Hierarchy: default work unit and user-created work units for the hierarchy;
Effects: default effects work unit for the project effects;
Events: the default event work unit and the user-created work units for the project events;
Game Parameters: default work units for game parameters;
Master-Mixer Hierarchy: default work unit for the project routing;
Originals: original versions of the SFX and Voices assets for the project as described hereinabove;
SoundBanks: default work unit for SoundBanks;
States: default work unit for States;
Switches: default work unit for Switches;
.wproj: the actual project file.

The concept of work units will be described hereinbelow in more detail.

The Project Launcher 284 includes a menu option to access a Project settings dialog box 286 for defining the project settings. These settings include default values for sound objects such as routing, volume, volume threshold, as well as the location for the project's original files, and the project obstruction and occlusion behaviour.

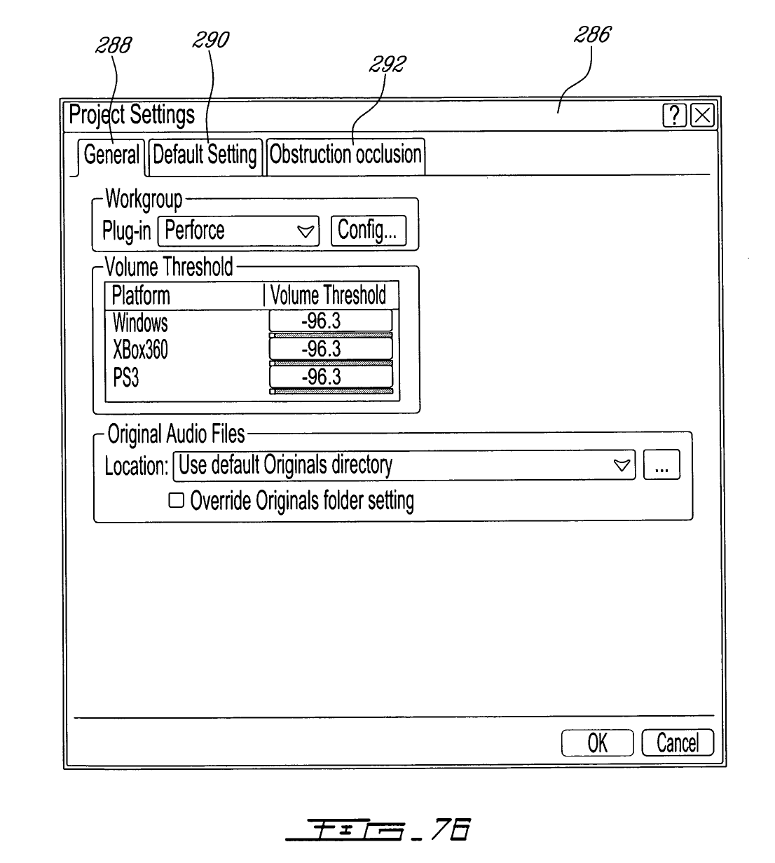

As illustrated in FIG. 76, the Project Settings dialog box 286 includes the following three tabs providing the corresponding functionalities:
General Tab 288: to define a source control system, the volume threshold for the project and the location for the Originals folder for the project assets;
Defaults Tab 290: to set the default properties for routing, and sound objects;
Obstruction/ Occlusion Tab 292: to define the volume and LPF curves for obstruction and occlusion in the project.

Of course, the overall functionalities provided by these tabs can alternatively be grouped differently and/or provided through a different GUI.

Schematic View

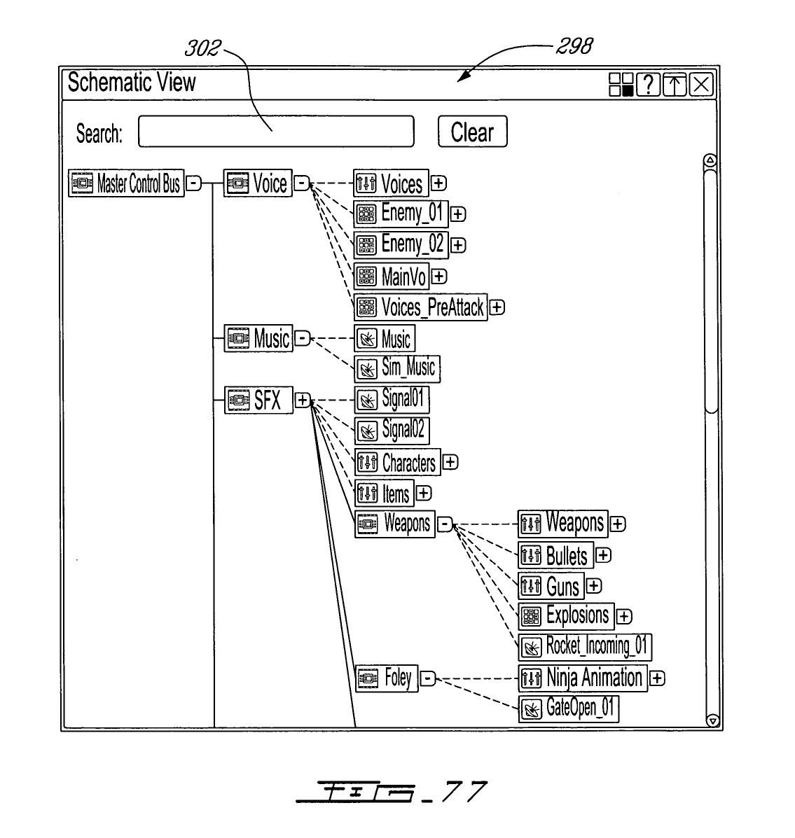

The Authoring tool includes a Schematic Viewer 298 to display Schematic View including a graphical representation of the project. As will now be described with reference to FIG. 77, in addition to provide an overview of a project, the Schematic Viewer 298 includes user interface tools to locate project objects, or analyze project structure one object at a time. The Schematic Viewer 298 includes icons representing project object, the object names, and lines and nodes representing their relationships. The Schematic Viewer is customizable as will now be described.

The Schematic Viewer 298 contains a visual representation of project objects, as well as tools to customize the Schematic View. It also features a search function to locate project objects.

The Schematic View includes icons representing project objects and connectors representing their relationship to one another. Connectors such as the ones shown in the following table are used between objects:

TABLE 8

| Icon | Name | Description |
|---|---|---|
| [symbol] | Solid line | For connecting parent and child project |
| | | objects. |
| [symbol] | Dashed | For connecting busses to child project objects |
| | line | to demonstrate routing. |
| [symbol] | Plus sign | For expanding the schema so as to show all |
| | (white) | children of the object. |
| [symbol] | Plus sign | For showing all children of the object, when |
| | (yellow) | not all children are currently displayed. |
| [symbol] | Minus sign | For hiding all children of the object. |

As illustrated in FIG. 78, a Schematic View settings dialog box 300 is provided to allow the user to customize the information shown about each project object in the schema. For example, the following properties can be selected: volume, pitch, low pass filter, and low frequency modulation.

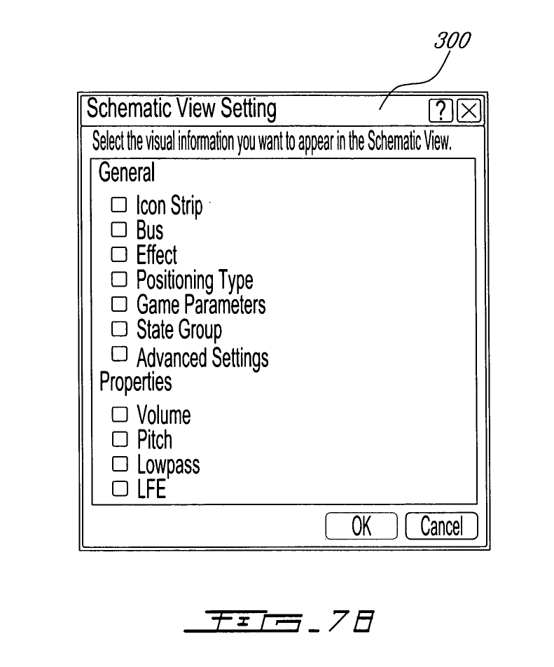

The Schematic Viewer then displays selected information for each project object (see FIG. 79).

The Schematic Viewer 298 includes multiple options for finding, examining, and working with the project objects displayed within it.

More specifically, the Schematic Viewer includes tools for:
searching for project objects;
finding project objects in the Project Explorer 128;
examining information about a project object;
authoring;
showing a project object; and
editing project objects.

These functionalities of the Schematic View are accessible through conventional GUI elements and/or are conventionally mapped to keyboard shortcuts.

For example, with reference to FIG. 77, the Schematic Viewer 298 includes a search field 302 to search for a project object in the Schematic view.

The Schematic Viewer 298 is further programmed with a finding tool to locate an object in the Project Explorer 128. The project object is then highlighted in the Project Explorer 128.

The Schematic Viewer 298 is also programmed with an object path examining tool (not shown) to display the directory path of the selected object. The directory path is displayed in a dedicated field of the Schematic view.

The Schematic Viewer 298 is configured with editing functionalities similar to the Property Editor 134. For that purpose, the controls selected and displayed with each objects in the Schematic View can be used (see FIG. 79).

The Property Editor 134 is also accessible from the Schematic View.

The Schematic Viewer 298 is programmed so that these tools are available by selecting the object in the view and by right-clicking thereon. These tools can be made available through different GUI means.

The Authoring tool includes a GUI tool for playing the media files. According to the first illustrative embodiment, the GUI tool is in the form of a tool for auditioning the object selected, for example, in the Property Editor 134.

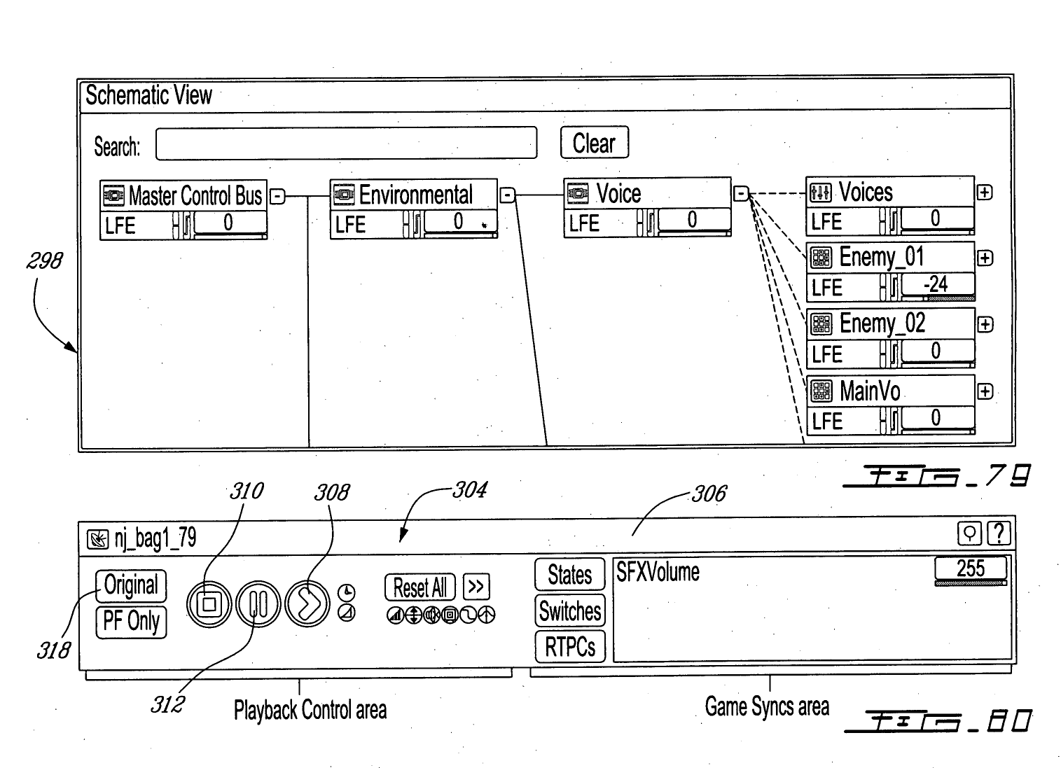

Such an auditioning tool, which will be referred to herein as Transport Control 304, will now be described with reference to FIG. 80.

The Authoring tool is configured so that a selected object, including a sound object, container, or event, is automatically loaded into the Transport Control 304 and the name of the object along with its associated icon are displayed in its title bar 306.

The Transport Control 304 includes two different areas: the Playback Control area and the Game Syncs area.

The Playback Control area will now be described in more detail with reference to FIG. 81.

The Playback Control area of the Transport Control 304 contains traditional control buttons associated with the playback of audio, such as play 308, stop 310, and pause buttons 312. It also includes Transport Control settings to set how objects will be played back. More specifically, these settings allow specifying for example whether the original or converted object is played.

The Playback Control area also contains a series of indicators that change appearance when certain properties or behaviours that have been previously applied to the object are playing. The following table lists the property and action parameter indicators in the Transport Control.

TABLE 9

| Icon | Name | Indicates |
|---|---|---|
| [symbol] | Delay | A delay has been applied to an object in an |
| | | event or a random-sequence container. |
| [symbol] | Fade | A fade has been applied to an object in an |
| | | event or a sequence container. |
| [symbol] | Set Volume | A set volume action has been applied to an |
| | | object in an event. |
| [symbol] | Set Pitch | A set pitch action has been applied to an |
| | | object in an event. |
| [symbol] | Mute | A mute action has been applied to an |
| | | object in an event. |
| [symbol] | Set LFE | A set LFE volume action has been applied |
| | | to an object in an event. |
| [symbol] | Set Low Pass | A set Low Pass Filter action has been |
| | Filter | applied to an object in an event. |
| [symbol] | Enable | An Enable Bypass action has been applied |
| | Bypass | to an object in an event. |

With reference to FIG. 81, in addition to the traditional playback controls, the Transport Control 306 includes a Game Syncs area that contains all the states, switches, and RTPCs (Game Parameters) associated with the currently selected object. The Transport Control 306 can therefore be used as a mini simulator to test sounds and simulate changes in the game. During playback, states and switches can then be changed, and the game parameters and their mapped values can be auditioned.

For example, the Transport Control 306 is configured so that when an object is loaded therein, a list of state groups and states to which the object is subscribed can be selectively displayed to simulate states and state changes that will occur in game during playback. The Transport Control 306 further allows auditioning the state properties while playing back objects, and state changes while switching between states.

Similarly, a list of switch groups and switches to which the object has been assigned can be selectively displayed to simulate switch changes that will occur in game during playback so that the switch containers that have subscribed to the selected switch group will play the sounds that correspond with the selected switch.

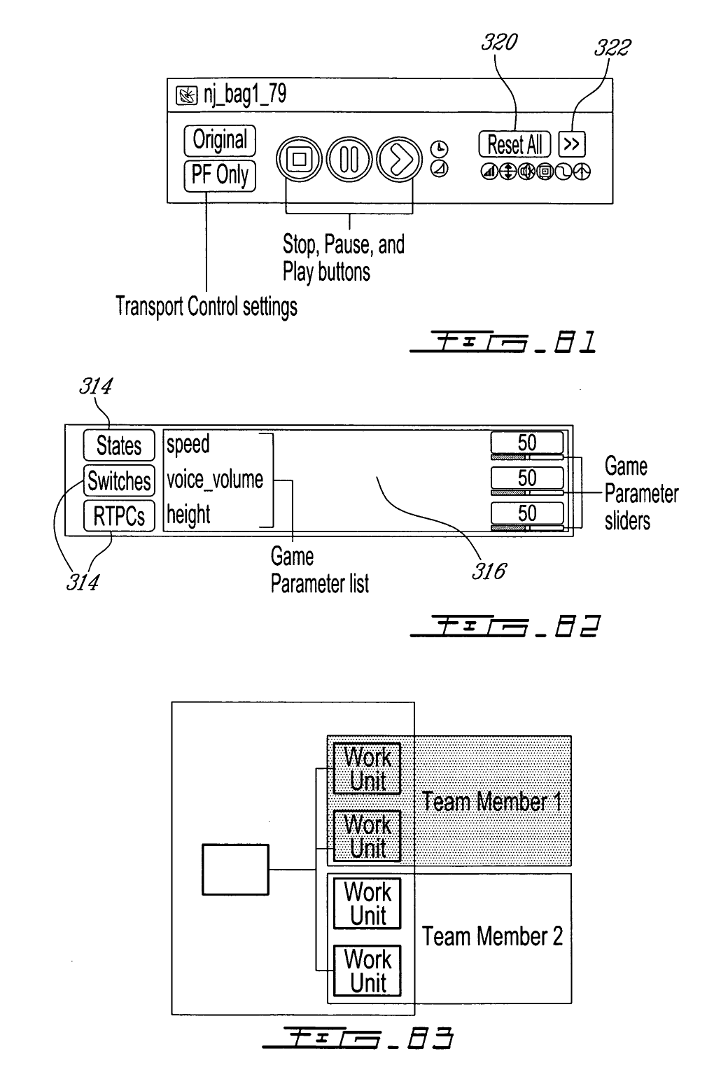

The Transport Control 306 is also configured so that RTPCs can be selectively displayed in the Games Syncs area. More specifically, as illustrated in FIG. 82, sliders are provided so that the game parameters can be changed during the object's playback. Since these values are already mapped to the corresponding property values, when the game parameter values are changed, the object property values are automatically changed. This therefore allows simulating what happens in game when the game parameters change and verifying how effectively property mappings will work in game.

The Game Syncs area further includes icon buttons 314 to allow selection between states, switches and RTPCs and a display area 316 is provided adjacent these icons buttons to display the list of selected syncs.

The Transport Control 298 is further configured to compare converted audio to the original files and make changes to the object properties on the fly and reset them to the default or original settings as will now be described briefly.

As it has been previously described, when the imported audio files are converted, the Authoring tool maintains an original version of the audio file that remains available for auditioning. The Transport Control 298 is configured to play the sounds that have been converted for platforms by default from the imported cache; however, as can be seen in FIG. 80, the Transport Control 198 includes a function button 318 to allow the user selecting the original pre-converted version for playback.

As described hereinabove, the Transport Control 298 provides access to properties, behaviours, and game syncs for the objects during playback. More specifically, the property indicators in the Transport Control 298 provide the user with feedback about which behaviours or actions are in effect during playback. This can be advantageous since when the Authoring tool is connected to the game, some game syncs, effects, and events may affect the default properties for objects. The Transport Control 298 further includes Reset buttons to return objects to their default settings. In addition to an icon button 320 intended to reset all objects to their default settings, the Transport Control includes a further icon button 322 to display a Reset menu allowing to perform one of the following:
resetting all objects to their original settings;
resuming playing a sequence container from the beginning of the playlist;
returning all game parameters to the original settings;
clearing all mute actions that have been triggered for the objects;
clearing all pitch actions that have been triggered for the objects;
clearing all volume actions that have been triggered for the objects;
clearing all LFE volume actions that have been triggered for the objects;
clearing all Low Pass Filter actions that have been triggered for the objects;
clearing all bypass actions that have been triggered for the objects;
returning the default state; and
returning to the default switch specified for the Switch Container.

The Authoring tool is so configured that the Transport Control 304 automatically loads the object currently in the Property Editor 134. It is also configured so that an object or event selected in the Project Explorer 128 will be automatically loaded into the Transport Control 306.

The Transport Control 304 is further provided with additional tools for example to edit object, find objects in the hierarchy, provide details on the selected object and display the object in the Schematic View. These options are made available, for example, through a shortcut menu.

Work Groups

As it already has been illustrated with reference for example to the hierarchy and to FIGS. 33, 42, 54 and 56, the Authoring tool allows dividing the project in work units.

In today's game environment, with the complexity of next-generation games and the pressure to get games to market, it is desirable for sound designers, audio integrators, and audio programmers to be able to work together on the same project. The Authoring tool includes Workgroups for that purpose.

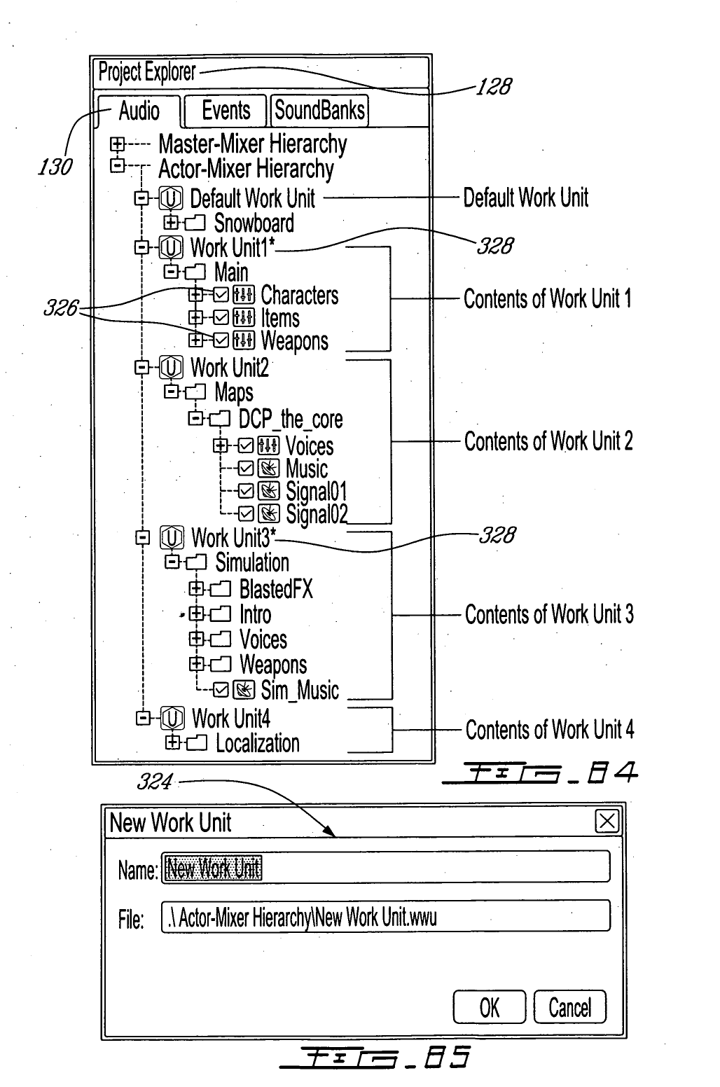

With reference to FIG. 83, dividing different parts of a project into segments, which will be referred to herein as work units, allows different people working on different parts of the project, thereby avoiding difficult and frequent merging issues.

Work units are in the form of distinct XML files that contain information related to a particular section or element within the project. These work units can be managed by an independent source control system to make it easier for different members of a team to work on the project simultaneously. It is to be noted that the Authoring tool is not restricted to work units being in the well-known XML format. Other format can also be used, such as binary and in a database.

Returning briefly to FIG. 75, when a project is created, the Authoring tool creates a default work unit for each of the following elements:
Actor-Mixer hierarchy;
Effects;
Events;
Game Parameters;
Master-Mixer hierarchy;
Presets;
SoundBanks;
States; and
Switches.

These default work units are stored in respective folders within a project directory. This directory can be located anywhere on the system 10 or on a network (not shown) accessible by the system 10. A unique name, such as “Default Work Unit.wwu”, is assigned to each work unit. All the information from the project related to the specific element for which they were created is stored in the default work units. For example, the default work unit file for events contains all the information related to events, and the default work unit file for states contains all the information related to states.

As a project grows and more people join the project team, certain parts of the project can be divided into new work units. New work units can be created for example for the following elements:
Objects and sound structures within the Actor-Mixer hierarchy;
Events;
SoundBanks.

FIG. 84 illustrates how four work units can be created to divide up the sound structures in the Actor-Mixer Hierarchy.

Of course, the contents of each work unit can be managed in the different tabs of the Project Explorer 128 for example.

It is reminded that the use of XML-based type file to store the project information, and more specifically each work unit information, allows including in the system 10 a source control application to manage the audio assets and other types of project files, including:
the project file;
work units, including the default work units; and
originals folder, i.e. the folder that contains the original sound files that were imported into the Authoring tool.

The Authoring tool is further provided with a Project File Status dialog box (not shown) to selectively display the status of the project file and work unit files throughout the development of the game.

Resolving Project Inconsistencies

Since it is possible that changes to specific files may result in project file errors or inconsistencies when several people are working on the same project, the Authoring tool performs the following project validations each time a project file is opened:
a validation for XML syntax and schema errors;
a validation for project inconsistencies.

It is to be noted that these validations are performed to minimize inconsistencies and project file errors. According to a further embodiment of the Authoring tool, only one of these validations or other validation can also be performed for that purpose.

Each of these two types of validations will now be described in further details.

XML Syntax and Schema Errors

The Authoring tool does not open invalid project file resulting from XML syntax or schema errors being created during the update. Verification is therefore done to that effect, and if an error is detected, a message box is displayed that describes the error and specifies the exact file and location of the error. More specifically, the XML syntax is examined for any syntax that does not respect the syntax rules for XM, using unsupported characters for example. Then the XML schema is examined to see if each element of the current project schema is identical to the version being opened.

Project Inconsistency Issues

If there are no XML syntax errors, the Authoring tool continues the validation process by verifying if there are any project inconsistencies or issues. More specifically, the contents of the project are verified, including all the elements of the project and all the relationships and associations between elements, such as new audio files added or files deleted, objects added or deleted; objects assigned to states or switches or rtpcs and the state switch or rtpc has been deleted. For example, a state may have been deleted in the States work unit, but is still being used by one of the objects in one of the sound structure work units. When the Authoring tool detects any project issues, information about each issue along with a description of how they can be fixed, if necessary are displayed.

When errors or inconsistencies are detected, the Authoring tool display a menu (not shown) prompting the user to accept proposed fixes as a group or to reject them and either revert to older versions of the project.

Since it has been found preferable that some global elements within a project, such as states and switches, remain in their default work unit, the Authoring tool prevents sub-dividing these elements into additional work units. The present Authoring tool is however not limited to such an embodiment.

After the work units are created, the work in a project can be divided-up by dragging the sound structures, events, and SoundBanks into respective work units.

More specifically, dividing a project into work units includes:
creating work units;
assigning work elements to work units; and
working with work units.

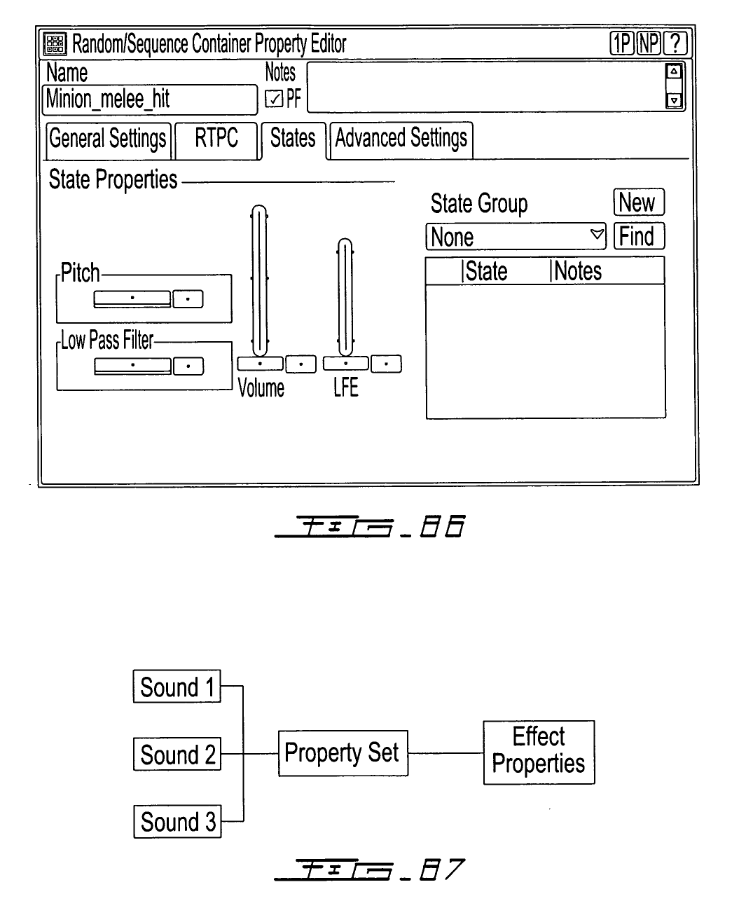

The Project Explorer 128 allows creating new work units by providing editing tools to create and edit the hierarchy. For example, by right-clicking on an existing work unit, a menu such as illustrated in FIG. 56 is displayed to the user allowing selecting “Work Unit” under “New Child”. A “New Work Unit” pop up menu 324, as illustrated in FIG. 85, is then prompted to the user allowing specifying the name and location, including the file path of the new work unit.

The Authoring tool originally assigned all the project elements, including sound structures, events, and SoundBanks, to their respective Default work units when a project is created. Then, after having created new work units as it has been described hereinabove, the project can be divided up by assigning the different elements thereof to the different work units. The drag and drop functionalities of the Project Explorer 128 can be used to assign a project element to a work unit by simply dragging it into a particular work unit.

In order to prevent project inconsistencies or integrity errors, the Authoring tool prevents directly renaming and deleting work units therefrom.

The Project File Status dialog box displays information about the work units in the project as well as the project file itself. In addition a Sources tab (not shown) displays information about each audio file source in the project.

Referring briefly to FIG. 84, the Authoring tool provides feedback to notify the user of which work unit has been modified or as been tagged as read-only. Such notification is for example in the form of a check mark 326 appearing in the corresponding column for that project file. Further feedback is also provided to notify the user of which work units have been modified directly in the Project Explorer. This unique notification is in the form of an asterisk (*) 328. The notification can of course take other forms.

Presets and Property Sets

As will now be described in more detail, the Authoring tool is configured to allow a user to create templates or property sets so that part of its work can be used on a plurality of property and effects values.

In a nutshell, templates include specific sets of property values related to an object or effect that are saved into a special file so that they can be re-used at a later time within the same project. Using templates prevents recreating particular property setups which are intended to be used across various objects in a project. The property values are set up once, the template is saved, and then applied to the other objects in the project. They can further be shared across a plurality of projects.

Property sets on the other hand include a set of effect properties that can be shared across several objects. Property sets are basically different versions of an effect. These versions can then be applied to many different objects within your project. Because the properties are shared, the effect's properties don't have to be modified for each object individually.

Presets

The Authoring tool allows saving templates for effects and for object properties at different level within the project hierarchy.

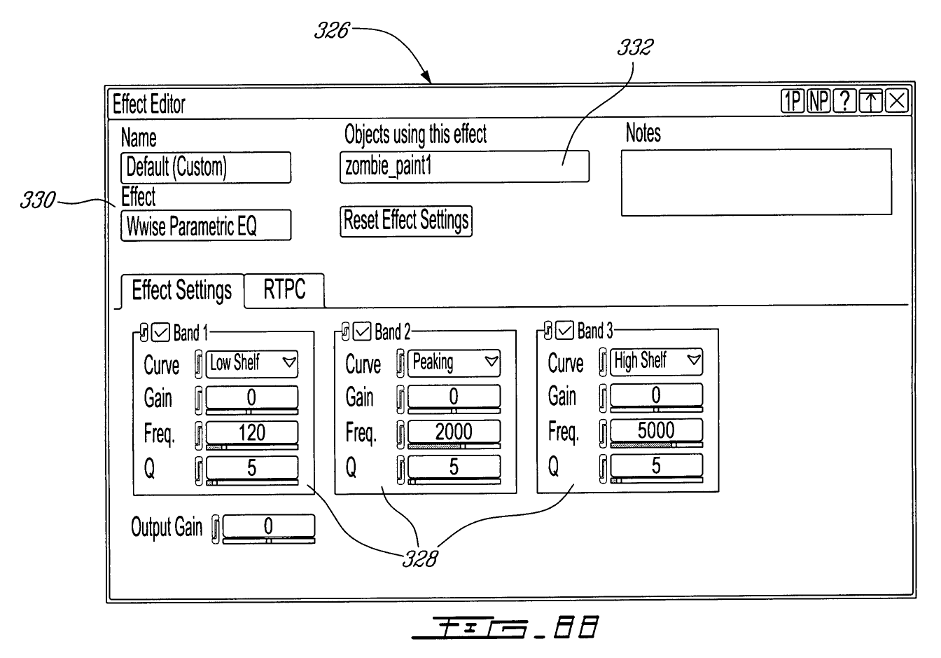

As illustrated in FIG. 86, the icon buttons shown in the following table are provided in the title bar of every related tab from which a template can be used:

TABLE 10

| Icon | Name |
|---|---|
| [symbol] | Load Template |
| [symbol] | Save Template |

To save a Template, the Authoring tool saves every value on every tab within the current on-screen view. Moreover, when a template is saved, it is grouped according to one of the following categories:
Actor-Mixer;
Random Container
Sequence Container;
Switch Container;
Sound SFX/Voice; and
Effects.

Similarly, when the Save Template dialog box is opened, the templates are filtered to show only the templates that are in the same category.

The Templates save different elements for different object properties at different levels within the project hierarchy. Examples of elements that are saved for different categories of Templates according to the first illustrative embodiment are shown in the following table. These examples are provided for illustrative purposes only. Templates saving other information can also be foreseen.

TABLE 11

| | Location in | |
|---|---|---|
| Template | Hierarchy | Contents |
| Object | Top-level | Property values on every tab |
| Properties | object | within the Property Editor |
| | | including the following: |
| | | Output settings |
| | | Bus effect send level |
| | | Inserted effect |
| | | Positioning |
| | | Playback priority |
| | Child object | Property values on every tab |
| | | within the Property Editor, |
| | | including the following |
| | | information: |
| | | Output settings |
| | | Bus effect send level |
| | | Inserted effect |
| | | Positioning |
| | | Playback priority |
| Effect | — | All property values of the effect. |

A template can similarly be loaded using the corresponding icon button described hereinabove.

The same dialog box used for saving and loading templates is provided for their deletion.

Property Sets

Property sets are provided to share effects properties on a plurality of objects and busses. FIG. 87 schematically illustrates the use of property sets to share effect properties on a plurality of sound objects.

It results that when a change is made to the effect properties of a property set, all objects subscribing to that set are affected.

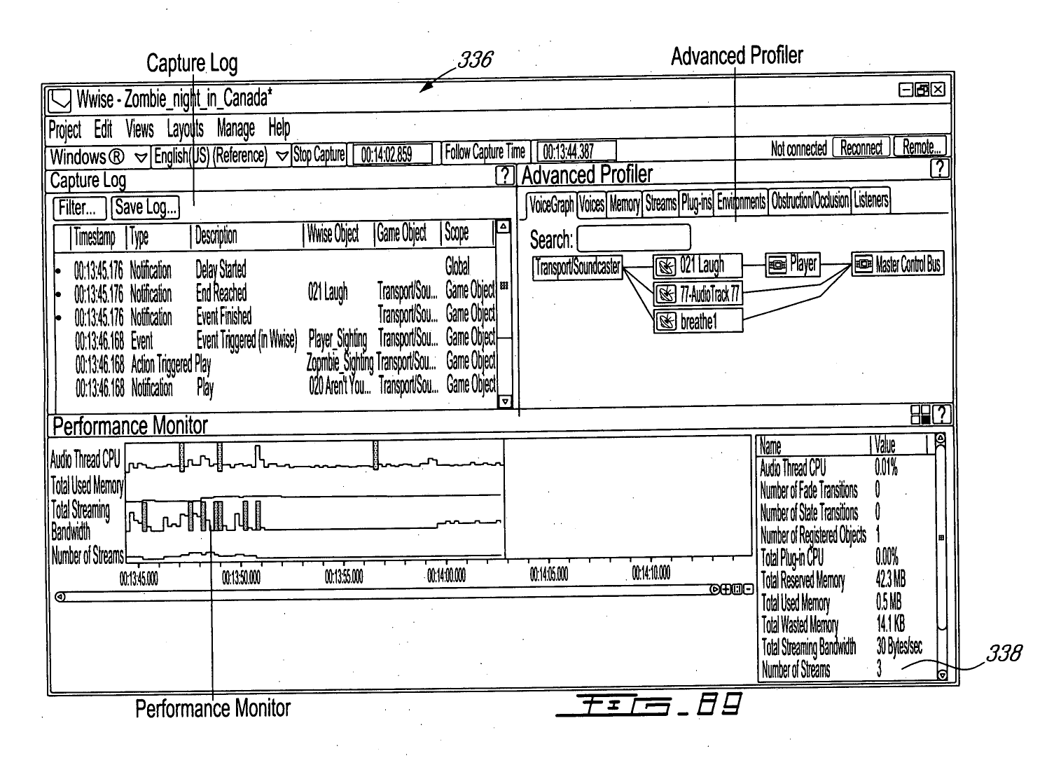

With reference to FIG. 88, the Authoring tool is provided with an Effect Editor 326 including first dialog boxes 328 for inputting and/or editing effect parameters, a second dialog box 330 to associate the selected effect to a property set and an input box 332 to associate the objects which will be using this property set. The first dialog boxes 328 for inputting and/or editing the effect parameters include sliders, check boxes, and input boxes. They can take also other form. Additional icon buttons 334 are provided to access conventional creation, deletion and renaming functionalities for the property sets.

The Effect Editor 326 contains a series of properties associated with the effect that is applied to the object or control bus. It is contextual; it displays different properties depending on the effect that has been applied.

Variations

According to a further aspect of the Authoring tools, variations on a set of property values and behaviours can be created and saved for any selected object. The Authoring tool includes a Variation Editor (not shown) to create and manage these variations. During playback, the user is then offered to select any of the variations. This functionality allows saving memory usage as well as saving authoring time.

For example, a sound object can be created to simulate the sound of a character walking. The set of properties for this object can be modified and saved as a Variation for the same object to simulate a character having a different weight for example.

A Variation can also be created on a container. For example, a Variation of a random container including a plurality of sword sounds for a fight can be created so as to exclude some of the sound therein, for example for some levels in the game.

Sharing

According to another aspect of the Authoring tool, sound objects can be shared in the hierarchical structure so that a modification applied to such sound object is automatically applied to all instances of this object through all the hierarchical structure. The Property Editor includes a user interface option (not shown) to allow the user defining a sound object as a shared one and then for selecting and copying such object in the hierarchical structure.

Profiler

The Authoring tool also includes a Game Profiler, including a corresponding Game Profiler GUI 336, to profile selected aspects of the game audio at any point in the production process. More specifically, the Profiler is connectable to a remote game console so as to capture profiling information directly from the sound engine. By monitoring the activities of the sound engine, specific problems related for example to memory, voices, streaming and effects can be detected and troubleshooted. Of course, since the Game Profiler of the Authoring tool is configured to be connected to the sound engine, it can be used to profile in game, or to profile prototypes before they have been integrated into a game.

As illustrated in FIG. 89, the Game Profiler GUI includes the following three profiling tools which can be accessed via a respective GUI:
Log Recorder: to capture and record information coming from the sound engine;
Performance Monitor: to graphically represent the performance from the CPU, memory, and the bandwidth, for activities performed by the sound engine. The information is displayed in real time as it is captured from the sound engine;
Advanced Profiler: a set of sound engine metrics to monitor performance and troubleshoot problems.

The Game Profiler displays the three respective GUI in an integrated single view which contributes helping locating problem areas, determining which events, actions, or objects are causing the problems, determining how the sound engine is handling the different elements, and also fixing the problem quickly and efficiently.

Connecting to a Remote Game Console

To simulate different sounds in game or to profile and troubleshoot different aspects of the game on a particular game console, the Authoring tool is first connected to the game console. More specifically, the Game Profiler is connectable to any game console or game simulator that is running and which is connectively available to the Authoring tool. To be connectively available, the game console or game simulator is located on a same network, such as for example on a same local area network (LAN).

The Authoring tool includes a Remote Connector including a Remote Connector GUI panel (both not shown) for searching for available consoles on selected path of the network and for establishing the connection with a selected console from a list of available consoles. The Remote Connector can be configured, for example, to automatically search for all the game consoles that are currently on the same subnet than the system 10 of the network. The Remote Connector GUI panel further includes an input box for receiving the IP address of a console, which may be located, for example, outside the subnet.

The Remote Connector is configured to maintain a history of all the consoles to which the system 10, and more specifically, the Authoring tool, has successfully connected to in the past. This allows easy retrieval of connection info and therefore of connection to a console.

The Remote Connector displays on the Remote Connector GUI panel the status of the console for which a connection is attempted. Indeed, the remote console can be a) ready to accept a connection, b) already connected to a machine and c) no longer connected to the network.

After connection to a remote console has been established using the Remote Connector, the Profiler can be used to capture data directly from the sound engine.

The Log Recorder module captures the information coming from the sound engine. It includes a Capture Log GUI panel (see FIG. 89) to display this information. An entry is recorded in the Log Recorder for the following types of information: notifications as whether event action has occurred and when it is completed, Switches-related information, Events-related information, SoundBanks-related information, Events actions, errors encountered by the sound engine, changes made to properties, various messages, and States changes. Of course, the Log Recorder can be modified to capture and display other type of information.

The Performance Monitor and Advanced Profiler are in the form of GUI views which can be customized to display these entries. These views contain detailed information about memory, voice, and effect usage, streaming, plug-ins, and so on.

These views make use of icon indicators and color code to help categorize and identify the entries that appears in the Capture Log panel.

The Profiler can be customized to limit the type of information that will be captured by the Log Recorder module, in view of preventing or limiting the performance drop. The Profiler includes a Profiler Settings dialog box (not shown) to allow the user to select the type of information that will be captured.

The Profiler Settings dialog box includes GUI elements, in the form of menu item with corresponding check boxes, to allow the selection of one or more of the following information types:
information related to the various plug-ins;
information related to the memory pools registered in the sound engine's Memory Manager;
information related to the streams managed by the sound engine;
information related to each of the voices managed by the sound engine;
information related to the environmental effects affecting game objects;
information related to each of the listeners managed by the sound engine; and
information related to the obstruction and occlusion affecting game objects.

The Profiler Setting dialog box further includes an input box for defining the maximum amount of memory to be used for making the Capture log.

The Profiler module is also configured to selectively keep the Capture Log and Performance Monitor in sync with the capture time. A “Follow Capture Time” icon button is provided on the toolbar of the Profiler view to trigger that option. In operation, this will cause the automatic scrolling of the entries as the data are being captured, and the synchronization of a time cursor, provided with the Performance Monitor view with the game time cursor.

The Profiler is further customizable by including a log filter accessible via a Capture Log Filter dialog box (not shown), which allows selecting specific information to display, such as a particular game object, or only event related information or state related information.

The Profiler includes further tools to manage the log entries, including sorting and selected or all entries. Since such managing tools are believed to be well-known in the art, and for concision purposes, they will not be described herein in more detail.

The Performance Monitor creates performance graphs as the Profiler module captures information related to the activities of the sound engine. The Performance Monitor includes a Performance Data pane 338 to simultaneously display the actual numbers and percentages related to the graphs.

The different graphs of the graph view of the Performance Monitor can be used to locate areas in a game where the audio is surpassing the limits of the platform. Using a combination of the Performance Monitor, Capture Log, and Advanced Profiler, allows troubleshooting many issues that may arise.

The Performance Monitor is customizable. Any performance indicators or counters displayed from a list can be selected by the user for monitoring. Example of indicators include: audio thread CPU, number of Fade Transitions, number of State Transitions, total Plug-in CPU, total reserved memory, total used memory, total wasted memory, total streaming bandwidth, number of streams and number of voices.

The Performance Monitor, Advance Profiler and Capture Log panel are synchronized. For example, scrolling through the graph view automatically updates the position of the entry in the Capture Log panel and the information in the Performance Data pane.

The Profiler is linked to the other module of the Authoring tool so as to allow access of the corresponding Event and/or Property Editors by selecting an entry in the Capture Log panel. The corresponding event or object then opens in the Event Editor or Property Editor where any modifications that are necessary can be made.

The Authoring tool is configured so that its different audio editing and/or managing tools, such as the Project Explorer, Property Editor, Event Viewer, Contents Editor and Transport Control are all displayed simultaneously in different panes. Of course, the Authoring tool can be modified or made customizable so that different tools can be viewed simultaneously or a single tool can be viewed at once. The different panes are then available to the user via any conventional menu selection tools.

Also, the functionalities of the above-described Authoring tool can be made available through different combinations of GUIs.

A system for authoring media content according to the present system and method has been described with reference to illustrative embodiments including examples of user interfaces allowing a user to interact with the system 10. These GUIs have been described for illustrative purposive and should not be use to limit the scope of the present system and method in any way. They can be modified in many ways within the scope and functionalities of the present system and tools. For example, shortcut menus, text boxes, display tabs, etc, can be used interchangeably provided. Also, the expression GUI (Graphical User Interface) should be construed so as to include any type of user interface, including text-only user interfaces.

Even though, according to the first illustrative embodiment, the control buses are provided with some functionalities which are not provided for the actor-mixers, it is believed to be within the reach of a person skilled in the art to modify the present Authoring tool to conceive an Authoring tool making use of a multi-level hierarchical structure including containers, second-level containers to receive second-level containers, containers and media objects and third-level containers for receiving third-level containers, second-level containers, containers and objects and where all the container-type objects are provided with the same functionalities.

It has been found that a two-level hierarchical structure, where a lower-level hierarchy is provided to organize sound assets and a higher-level hierarchy is provided to allow re-grouping the different sound structures within the lower-level hierarchy and preparing them for output, is particularly suitable for authoring audio content.

Other multi-level hierarchical structures can however be provided. For example a three-level hierarchy including objects, containers, and meta-containers for receiving containers and objects in a parent-child relationship similarly to the structures that have been described herein can also be provided.

Even though the system and method for authoring audio for a video game according to the first illustrative embodiment includes events to drive in game the audio objects created from the audio files, a system and method for authoring media files for a computer application according to another embodiment may not require such events to drive the media objects.

It is believed to be within the reach of a person skilled in the art to use the present teaching to modify the Authoring tool for authoring other media objects for other different computer application than a computer game.

For example, such a modified Authoring tool can be used in image or video processing.

In the case of video processing, the hierarchical structure as described herein can be used to simultaneously assign properties to a sequence of image stored as image objects in a container. Similarly to what have been described herein with reference to audio, many effects can easily be achieved with such a video processing tool.

The present method and system for authoring media content can be used in many other applications such as, without limitations, the production of artificial intelligence graph, video processing, etc.

Although the present has been described hereinabove by way of illustrated embodiments thereof, it can be modified, without departing from the spirit and nature of the subject system and method as defined in the appended claims.

What is claimed is:

1. A method in a computer system for authoring media content for a computer application, the method comprising:
providing digital media;
for each one of the digital media, creating a media object which shares content characteristics therewith;
providing a hierarchical structure, including the media objects, and at least one container, to assign at least one selected modifier among at least one of at least one property and at least one behaviour to at least one of the media objects; the at least one container being for including at least one selected object from the media objects so that when the at least one selected modifier is assigned to the at least one container, the at least one selected modifier is shared to the at least one selected object; and
storing information related to the hierarchical structure in at least one project file to be used by the computer application.

2. A method as recited in claim 1, further providing at least one event including at least one action to drive at least one of the media objects and the at least one container in the computer application.

3. A method as recited in claim 2, wherein the at least one of the media objects and the at least one container is assigned to the at least one event so as to be driven thereby according to the at least one action.

4. A method as recited in claim 2, wherein the at least one action includes a plurality of actions or another event.

5. A method as recited in claim 2, wherein the at least one action is selected from the group consisting of play, stop, pause and resume.

6. A method as recited in claim 2, wherein the information related to the hierarchical structure stored in the at least one project file includes the at least one event.

7. A method as recited in claim 1, further comprising:
providing at least one event;
adding actions to the at least one event to drive the media objects and the at least one container in the computer application;
assigning a second selected object among the at least one of the media objects and the at least one container to a selected action among the actions; and
driving the second selected object in the computer application using the selected action.

8. A method as recited in claim 1, wherein the at least one selected modifier is assigned to at least one of the media objects in response to a variation in the computer application.

9. A method as recited in claim 1, further comprising:
providing at least one state characterized by at least one state modifier selected among the at least one modifier; the at least one state being responsive to a variation in the computer application;
associating at least one of the media objects to the at least one state; and
assigning the at least one state modifier to the at least one media objects in response to the variation in the computer application.

10. A method as recited in claim 9, wherein said providing at least one state includes providing at least two states each characterized by at least one state modifier selected among the at least one modifier; each one of the at least two states being responsive to a variation in the computer application.

11. A method as recited in claim 10, further comprising providing a transition between the at least two state.

12. A method as recited in claim 1, wherein the at least one container includes a plurality of containers; each one of the plurality of containers further allowing to group other selected containers from the plurality of containers therein so that when the at least one selected modifier is assigned to the one of the plurality of containers, the at least one selected modifier is shared with the other selected containers grouped therein.

13. A method as recited in claim 12, wherein the at least one selected modifier includes a plurality of properties and behaviours.

14. A method as recited in claim 13, wherein the digital media files includes at least one of audio and image contents.

15. A method as recited on claim 14, wherein the plurality of properties includes at least one of volume, low-pass filter, low frequency effect and pitch.

16. A method as recited in claim 14, wherein at least one of the plurality of containers is a random container further allowing to play back second selected objects grouped therein in a random order.

17. A method as recited in claim 16, wherein the second selected objects grouped in the random container are playable in a step mode wherein only one of the second selected objects grouped in the random container is played.

18. A method as recited in claim 16, wherein the second selected objects grouped in the random container are playable in a continuous mode wherein all the selected objects grouped therein are played.

19. A method as recited in claim 16, wherein the second selected objects grouped in the random container are playable in a shuffle mode, whereby a pool of playable objects including the selected objects grouped in the random container is created;
in operation, the random container plays the playable objects within the pool so that after one of the payable objects is played, it is removed from the pool.

20. A method as recited in claim 12, wherein at least one of the plurality of containers is a sequence container further allowing to playback second selected objects grouped therein according to a playlist.

21. A method as recited in claim 20, wherein the second selected objects grouped in the sequence container are playable in a step mode wherein only one of the second selected objects grouped in the random container is played.

22. A method as recited in claim 20, wherein the second selected objects grouped in the sequence container are playable in a continuous mode wherein all the second selected objects grouped in the random container are played.

23. A method as recited in claim 12, wherein at least one of the plurality of containers is a switch container further allowing to playback second selected objects grouped therein according to at least one change in the computer application.

24. A method as recited in claim 23, wherein the at least one change in the computer application is handled by an element from the computer application selected from the group consisting of at least one state, at least one switch and at least one real-time parameter controls (RTPC).

25. A method as recited in claim 24, further comprising grouping the at least one switch in at least one switch group; assigning one of the at least one switch to each of the second selected objects grouped in the switch container;
whereby, in operation, the switch container plays media objects from the media objects grouped in the switch container having a switch assigned thereto corresponding to the at least one change in the computer application.

26. A method as recited in claim 1, wherein the digital media are in the form of audio files, resulting in the media objects being sound objects; the hierarchical structure further comprising a master mixer including at least one control bus container for including at least one selected second level object from the at least one container and sound objects not grouped therein and for outputting sounds associated to the at least one selected second level object therethrough.

27. A method as recited in claim 26, wherein at least one master modifier selected from the group consisting of a control bus property, a control bus behaviour and an effect is applied to the at least one control bus container causing the master modifier to be applied to the at least one selected second level object included therein.

28. A method as recited in claim 27, wherein the computer application is a game; the effect being an environmental effect responsive to a condition of the at least one selected second level object within the game.

29. A method as recited in claim 27, wherein the control bus property is selected from the group consisting of volume, low frequency effects, pitch and low pass filter.

30. A method as recited in claim 27, wherein the control bus container allows ducking the at least one selected second level object.

31. A method as recited in claim 26, further comprising limiting the number of sound instances which pass through the at least one bus container simultaneously.

32. A method as recited in claim 26, wherein the at least one sound associated to the at least one selected second level object includes a plurality of sounds outputted according to a predetermined importance associated to the at least one selected second level object.

33. A method as recited in claim 32, further comprising limiting the number of sound instances which pass through the at least one bus container simultaneously.

34. A method as recited in claim 26, further storing at least one link to the at least one bus in the at least one project file.

35. A method as recited in claim 1, wherein the at least one property is characterized by property values; the method further comprising:
providing at least one computer application parameter; the at least one computer application parameter being characterized by dynamic parameter values;
mapping the property values to parameter values; and
playing the media objects as modified by the property value which is dynamically mapped by the parameter.

36. A method as recited in claim 1, further comprising:
assigning at least one of the media objects and the at least one container to at least one switch;
providing at least one computer application parameter; the at least one computer application parameter being characterized by dynamic parameter values;
mapping the dynamic parameter values to the at least one switch;
playing the at least one of the media objects and the at least one container as triggered by the at least one switch which is dynamically mapped by the parameter.

37. A method as recited in claim 1, wherein the at least one property includes a relative property which is characterized by characterizing values; when the at least one selected object is assigned the relative property so as to be modified by a first one of its characterizing values and when the at least one container is assigned the relative property so as to be modified by a second one of its characterizing values, then the at least one selected object is modified by a resulting value being the sum of the first and second characterizing values.

38. A method as recited in claim 1, wherein the at least one behaviour defines how the at least one of the media objects to which it is assigned is used by the computer application.

39. A method as recited in claim 1, wherein the hierarchical structure includes a plurality of work unit hierarchical substructures.

40. A method as recited in claim 1, wherein the information related to the hierarchical structure includes at least one i) the at least one container, ii) at least one of the media objects, iii) at least one of the digital media and iv) links to one of i), ii) or iii).

41. A method as recited in claim 1, wherein the at least one project file includes a plurality of project files.

42. A method as recited in claim 1, wherein the hierarchical structure further includes at least one folder element to group at least one of the media objects and the at least one container therein.

43. A method as recited in claim 1, wherein each one of the media objects is linked to the digital media with which it shares content characteristic.

44. A method as recited in claim 1, wherein a source is further created for each of the digital media; the source being linked to both each of the digital media and to the media object which shares content characteristic therewith.

45. A method as recited in claim 44, wherein the computer application is dedicated to a selected platform; the method further comprising converting the source for the selected platform.

46. A method as recited in claim 44, further comprising storing the digital media in a first folder and the sources in a second folder.

47. A method as recited in claim 44, further comprising storing in the at least one project file links between each of the media objects and the corresponding media.

48. A method as recited in claim 1, wherein said creating a media object which shares content characteristics therewith includes creating a media object that links to said one of the digital media.

49. A method as recited in claim 48, further comprising creating a source file which is a work copy of said one of the digital media and which is linked to both the media object and to said one of the digital media.

50. A method as recited in claim 1, wherein the media files include audio content.

51. A method as recited in claim 50, wherein the media files are in the form selected from the group consisting of WAV, Musical Instrument Digital Interface (MIDI) and MPEG-1 Layer 3 (MP3) files.

52. A method as recited in claim 1, wherein the computer application is a videogame.

53. An authoring tool for authoring media content for a computer application comprising:
a media file importer component that receives digital media and that creates for each of the digital media a corresponding media object;
a hierarchical structure editor component, to provide at least one container, to assign at least one selected modifier selected among at least one property and at least one behaviour to at least one of the media objects; the at least one container being for including at least one first selected object among the media objects so that when the at least one selected modifier is assigned to the at least one container, the at least one selected modifier is shared with the at least one first selected object; and
a project file generator component that stores information related to at least one of the media objects and the at least one container in a project file to be used by the computer application.

54. An authoring tool as recited in claim 53, wherein the hierarchical structure editor component allows creating the at least one container.

55. An authoring tool as recited in claim 53, wherein the hierarchical structure editor component includes a tree view to manage the at least one container and the media objects.

56. An authoring tool as recited in claim 53, further including an event editor that provides at least one event and to assign at least one action thereto to drive at least one of the media objects or the at least one container in the computer application.

57. An authoring tool as recited in claim 56, wherein the event editor allows assigning at least one of the at least one of the media objects and the at least one container to the at least one event so as to be driven thereby according to the at least one action.

58. An authoring tool as recited in claim 56, wherein the at least one action includes a plurality of actions or another event.

59. An authoring tool as recited in claim 56, wherein the event editor is further for managing the at least one event and the at least one action.

60. An authoring tool as recited in claim 53, wherein the at least one container includes a plurality of containers; each one container of the plurality of containers being further for grouping other selected containers from the plurality of containers therein so that when the at least one selected modifier is assigned to the one container, the at least one selected modifier is assigned to the other selected containers grouped therein.

61. An authoring tool as recited in claim 60, wherein the digital media files include at least one of audio and image content.

62. An authoring tool as recited in claim 61, wherein at least one of the plurality of containers is a random container further allowing to playback second selected objects selected among the media objects and the selected containers grouped therein in a random order.

63. An authoring tool as recited in claim 62, further comprising a property editor to selectively set a transition between at least two of the second selected objects.

64. An authoring tool as recited in claim 61, wherein at least one of the plurality of containers is a sequence container further allowing to play back second selected objects grouped therein according to a playlist; the second selected objects being selected among the media objects and the selected containers.

65. An authoring tool as recited in claim 64, further comprising a property editor to selectively set a transition between at least two of the second selected objects.

66. An authoring tool as recited in claim 61, wherein at least one of the plurality of containers is a switch container further allowing to play back second selected objects grouped therein according to at least one change in the computer application.

67. An authoring tool as recited in claim 66, wherein the change in the computer application is handled by at least one of at least one state, at least one switch and at least one real-time parameter control (RTPC).

68. An authoring tool as recited in claim 67, further comprising a switch group manager to group the at least one switch in at least one switch group, and to assign one of the at least one switch to each of the second selected objects;
whereby, in operation, the switch container plays media objects, from the second selected objects, having a switch assigned thereto corresponding to the at least one change in the computer application.

69. An authoring tool as recited in claim 67, further comprising a property editor to base the switch container on state or on switch.

70. An authoring tool as recited in claim 61, further comprising a playing tool component for playing a second selected object from the at least one container and the media objects.

71. An authoring tool as recited in claim 70, wherein the playing tool component includes playback control buttons.

72. An authoring tool as recited in claim 70, wherein the playing tool component further allows to selectively play the digital media.

73. An authoring tool as recited in claim 53, wherein the digital media are in the form of audio files; the media objects being sound objects; the hierarchical structure editor component further providing a master mixer element including at least one control bus container for grouping at least one second selected object among the at least one container and sound objects not included in the at least one container.

74. An authoring tool as recited in claim 73, wherein the hierarchical structure editor component being further to apply to the at least one control bus container at least one bus modifier selected from the group consisting of a control bus property, a control bus behaviour and an effect causing the bus modifier to be further applied to the at least one container and sound objects not grouped therein.

75. An authoring tool as recited in claim 73, further comprising a remote connector for connecting to the computer application for at least one of auditioning and modifying audio as it plays back in the computer application.

76. An authoring tool as recited in claim 73, wherein the at least one selected modifier includes a plurality of first level properties; the at least one bus modifier including a plurality of bus modifiers; the authoring tool further comprising a multi editor for simultaneously applying at least one of i) a first selection of the first level properties to a second selection of the at least one container and the media objects and ii) a third selection of the plurality of bus modifiers to a fourth selection of the at least one control bus container.

77. An authoring tool as recited in claim 76, wherein the multi editor displays first selection of the first level properties and the third selection of the plurality of modifiers contextually.

78. An authoring tool as recited in claim 53, wherein the at least one property is characterized by property values; the authoring tool further comprising a property editor i) to manage at least one computer application parameter; the at least one computer application parameter being characterized by dynamic parameter values and ii) to map the property values to the dynamic parameter values; the authoring tool playing the media objects as modified by the at least one property which is dynamically mapped by the at least one computer application parameter.

79. An authoring tool as recited in claim 78, further comprising a RTPC manager to create and edit the at least one computer application parameter.

80. An authoring tool as recited in claim 78, further comprising a graph view for mapping the property values to the dynamic parameter values.

81. An authoring tool as recited in claim 78, wherein the computer application is a video game; the at least one computer application parameter including game parameters.

82. An authoring tool as recited in claim 53, further comprising a switch group property editor i) to assign at least one of the media objects and the at least one container to at least one switch, ii) to provide at least one computer application parameter characterized by dynamic parameter values, and iii) to map the dynamic parameter values to the at least one switch; the authoring tool playing the at least one of the media objects the at least one container as triggered by the at least one switch which is dynamically mapped by the parameter.

83. An authoring tool as recited in claim 53, wherein the digital media include audio content; the hierarchical structure editor component further providing a master mixer element including at least one control bus container for grouping the at least one container and the media objects; wherein the at least one selected modifier is further assignable to the at least one control bus container and to the master-mixer element, causing the at least one selected modifier to be shared to the containers and media objects grouped therein.

84. An authoring tool as recited in claim 53, further comprising a property editor to selectively characterize the at least one property as a relative property characterized by characterizing values, wherein, when the at least one first selected object is assigned the relative property so as to be modified by a first one of the characterizing values thereof and when the at least one container is assigned the relative property so as to be modified by a second characterizing values thereof, then the at least one selected object is modified by a resulting value being the sum of the first and second characterizing values.

85. An authoring tool as recited in claim 84, wherein the property editor further allows to override the property shared to the at least one first selected object by allowing to assign a further characterizing value thereto.

86. An authoring tool as recited in claim 53, further comprising a randomizer to randomly assign a characterizing value to the at least one property.

87. An authoring tool as recited in claim 53, further including a contents editor that contextually displays and allows editing one of a) a selected one of the media objects and b) the at least one first selected object.

88. An authoring tool as recited in claim 87, wherein the contents editor further displays the at least one selected modifier assigned to said one of a) a selected one of the media objects and b) the at least one first selected object.

89. An authoring tool as recited in claim 88, wherein the contents editor further allows managing the at least one first selected object.

90. An authoring tool as recited in claim 87, wherein the contents editor further allows adding a new media object in the at least one of the container.

91. An authoring tool as recited in claim 53, the media file importer component further links each of the media objects to the corresponding digital media.

92. An authoring tool as recited in claim 53, wherein the media file importer component further creates for each of the digital media a source which is linked thereto and to the corresponding media object.

93. An authoring tool as recited in claim 92, wherein the media file importer component further allows creating source plug-ins.

94. An authoring tool as recited in claim 53, wherein the media file importer component includes a media file importer user interface that displays information relating to the digital media.

95. An authoring tool as recited in claim 94, wherein the media file importer user interface further includes at least one of an import destination selection element and an import context defining element.

96. An authoring tool as recited in claim 53, further comprising a schematic viewer to schematically display the at least one container and at least one of the media objects and relationships therebetween.

97. An authoring tool as recited in claim 96, wherein the schematic viewer includes a search tool to locate a second selected object among the at least one container, the at least one of the media objects and the property.

98. An authoring tool as recited in claim 53, further comprising a profiler for connecting the authoring tool to the computer application so as to capture profiling information therefrom.

99. An authoring tool as recited in claim 98, wherein the profiler includes a performance monitor to graphically represent performance of the computer application.

100. An authoring tool as recited in claim 53, wherein the at least one selected modifier includes a plurality of properties; the authoring tool further comprising a multi editor for simultaneously modifying the plurality of properties.

101. An authoring tool as recited in claim 53, wherein the information related to at least one of the media objects and the at least one container includes at least one i) the at least one container, ii) at least one of the media objects, iii) at least one of the digital media and iv) links to one of i), ii) or iii).

102. An authoring tool as recited in claim 53, wherein the at least one project file includes a plurality of project files.

103. An authoring tool as recited in claim 53, wherein the computer application is a videogame.

104. An authoring tool for authoring audio content for a computer application comprising:
a lower-level hierarchy for grouping and organizing audio assets in a project using audio objects as working copies of the audio assets; and
a higher-level hierarchy for defining the routing and output of the audio objects using one or more control busses.

105. A computer-readable medium containing instructions for controlling a computer system to generate an application for authoring media content for a computer application, comprising:
a media file importer component that receives digital media and that creates for each of the digital media a corresponding media object;
a hierarchical structure editor component, to provide at least one container, to assign at least one selected modifier selected between at least one property and at least one behaviour to at least one of the media objects; the at least one container being for including at least one first selected object among the media objects so that when the at least one selected modifier is assigned to the at least one container, the at least one selected modifier is shared with the at least one first selected object; and
a project file generator component that stores information related to at least one of the media objects and the at least one container in a project file to be used by the computer application.

106. A system for authoring media content comprising:
a computer programmed with instructions for generating an application for authoring media content for a computer application including:
a digital media importer that receives digital media and that creates for each of the digital media a corresponding media object;
a hierarchical structure editor, to create a hierarchical structure including at least one container, to assign at least one selected modifier selected among at least one of at least one property and at least one behaviour to at least one of the media objects; the at least one container being for including at least one selected object among the media objects so that when the at least one selected modifier is assigned to the at least one container, the at least one selected modifier is shared to the at least one selected object; and
a project file generator that stores in a project file to be used by the computer application information related to the hierarchical structure.

107. A system as recited in claim 106, wherein the media file importer includes a digital media importer user interface; the hierarchical structure editor including a hierarchical structure editor user interface and the project file generator including a project file generator user interface; the system further comprising a display for displaying the digital media importer, hierarchical structure editor and the project file generator user interfaces.

108. A system as recited in claim 106 which is configured for network connectivity.

109. A method in a computer system for displaying media object in an authoring process by a computer system, the method comprising:
displaying a digital media importer user interface to allow receiving digital media and for each of the digital media, to allow creating a corresponding media object;
displaying a hierarchical structure editor user interface to allow creating a hierarchical structure including the media objects and containers and assigning at least one of properties and behaviours to the media objects; and
displaying a project file generator user interface to allow storing information related to the hierarchical structure.
